(19) United States
(12) Patent Application Publication
(10) Pub. No.: US 2019/0333078 A1
(43) Pub. Date: Oct. 31, 2019

(54) METHODS OF ASSESSING LONG-TERM INDICATORS OF SENTIMENT

(71) Applicant: TRUVALUE LABS, INC., San Francisco, CA (US)

(72) Inventors: Gregory Bala, Morgan Hill, CA (US); Hendrick Bartel, San Francisco, CA (US); Sebastian Brinkmann, San Francisco, CA (US); Philip Kim, San Francisco, CA (US); James P. Hawley, Oakland, CA (US); Stephen M. Malinak, Ph.D, Napa, CA (US); Yang Ruan, Oakland, CA (US); Eli Reisman, Berkeley, CA (US); Mark Strehlow, San Francisco, CA (US); Faithlyn Tulloch, San Francisco, CA (US)

(21) Appl. No.: 16/470,212

(22) PCT Filed: Jan. 16, 2018
(86) PCT No.: PCT/US18/13906

§ 371 Date: Jun. 15, 2019

Related U.S. Application Data
(60) Provisional application No. 62/446,312, filed on Jan. 13, 2017.

(51) Int. Cl. G06Q 30/02; G06N 20/00

(52) U.S. Cl. CPC G06Q 30/0201; G06N 20/00

(57) ABSTRACT

Methods and systems of assessing aggregate sentiment over a plurality of time increments of a time period are provided. A maximum aggregation factor that is associated with a particular time period is assigned. A plurality of time increments over the time period are received. For each time increment, the BISV is subtracted from the ISV to form a BISV/ISV difference value. The BISV/ISV difference value is normalized by dividing by the maximum possible difference, thereby determining a modulator. For each time increment, a value is assigned to a recency of the particular time increment to a most recent incremental sentiment value update event, thereby determining a decay factor. The maximum aggregation factor associated with a particular time period is modulated by multiplying a determined modulator and a determined decay factor associated with each time increment within the evaluated time interval. The modulated maximum aggregation factor is applied to aggregated sentiment values, thereby determining an aggregate sentiment value for each time increment over the time period.

### CROSS-REFERENCE

This application is a national stage entry of PCT/US2018/013906, entitled METHODS OF ASSESSING LONG-TERM INDICATORS OF SENTIMENT, and filed on Jan. 16, 2018, which claims priority to and the benefit of U.S. Provisional Application No. 62/446,312, filed Jan. 13, 2017, each of which is incorporated herein by reference in its entirety for any purpose.

### BACKGROUND OF THE INVENTION

Conventional methods for ascribing numerical indices characterizing particular areas of interest, such as the financial performance of a publicly traded company, are usually self-generated by the area of interest and reflect only a narrow, standardized set of internal metrics. These narrow, standardized sets of internal metrics often do not capture the true value of an entity within an area of interest, such as a company, as regarded by the set of all stakeholders or interested parties at large, usually external to the area of interest.

### SUMMARY OF THE INVENTION

Methods and systems are provided for assessing and providing long-term indicators of sentiment. While it is beneficial to provide a technique whereby a numerical index, or plurality of indices, are generated to precisely reflect the aggregate sentiment of interested parties, stakeholders, experts and the like in regard to a particular area of interest and observation, additional benefit may be provided when assessing these aggregate sentiments in the context of similar areas of interest and/or over stretches of time. It is further apparent that there is a benefit to present informative items, related to an area of interest, in ways that provide context and long-term indicators of sentiment.

This invention relates to a method and system for the generation of a long-term numerical index that provides an enhanced metric reflecting sentiment associated with rapidly changing indications of sentiment. The numerical index may be indicative of a value of an entity in the area of interest. This invention is applicable in areas of interest such as evaluating the characteristics of corporate behavior and performance as traditionally and conventionally only characterized heretofore by standardized financial data and metrics. Furthermore, this invention is applicable in areas of interest that can be attributed by news articles consumable by an observant public, and where members of that public have varying degrees of expertise. The invention can be applicable to other areas of interest for polling audiences on certain characteristics, such as (but not limited to), of a product, sports team, individual athlete, celebrity, company, news, or other areas.

In an aspect of the invention, a method of assessing aggregate sentiment over a plurality of time increments of a time period is provided. The method comprises assigning a maximum aggregation factor that is associated with a particular time period. The method also comprises receiving a plurality of time increments over the time period, wherein each time increment has a characteristic baseline incremental sentiment value (BISV) and incremental sentiment value (ISV). Additionally, the method comprises for each time increment, subtracting the BISV from the ISV to form a BISV/ISV difference value. The method also comprises normalizing the BISV/ISV difference value by dividing by the maximum possible difference, thereby determining a modulator. The method also comprises for each time increment, assigning a value to a recency of the particular time increment to a most recent incremental sentiment value update event, thereby determining a decay factor. The method comprises modulating the maximum aggregation factor associated with a particular time period by multiplying a determined modulator and a determined decay factor associated with each time increment within the evaluated time interval. The method also comprises applying the modulated maximum aggregation factor to aggregated sentiment values, thereby determining an aggregate sentiment value for each time increment over the time period.

In another aspect of the invention, a method of assessing a momentum indicator of a time period is provided. The method comprises receiving a plurality of aggregate sentiment values, wherein each aggregate sentiment value of the plurality of aggregate sentiment values is associated with a time increment within the time period. The method also comprises calculating a curve that models a function of the plurality of aggregate sentiment values across the time period. Additionally, the method comprises determining a momentum indicator based upon characteristics of the curve that models a function of the plurality of aggregate sentiment values across the period of time.

In another aspect of the invention, a method of assessing composite sentiment over a plurality of time increments of a time period is provided. The method comprises assigning a half life parameter. The method also comprises obtaining a diminishing rate from the half life parameter. Additionally, the method comprises assigning a seasoning period. The method also comprises obtaining a first reported general sentiment score. The method also comprises obtaining a general sentiment score over a plurality of time increments over a time period. Further, the method comprises identifying, for each general sentiment score, a number of time periods that the general sentiment score remains unchanged. Additionally, the method comprises assigning a neutral general sentiment score. The method also comprises assigning an information decay factor. The method further comprises calculating a fade-adjusted general sentiment score at a given time based on (a) a general sentiment score at the given time, (b) a number of time periods that the general sentiment score has remained unchanged, (c) the assigned neutral general sentiment score, and (d) the assigned information decay factor. The method also comprises obtaining a seed long-term score by combining the plurality of fade-adjusted general sentiment scores present within the seasoning period. Additionally, the method comprises calculating a present long-term score by iteratively updating long-term scores associated with a time period between the time associated with the seed long-term score and the time associated with the most current long-term score, wherein said long-term scores are updated based on factors selected from the group consisting of a fade-adjusted general sentiment score, diminishing rate, a seed value of the long-term score, and the most recent previous long-term score.

In a further aspect of the invention, a method for assessing a volume-modulated composite sentiment over a plurality of time increments of a time period is provided. The method comprises assigning a half life parameter. The method also comprises obtaining a diminishing rate from the half life parameter. Additionally, the method comprises assigning a seasoning period. The method also comprises obtaining a first reported general sentiment score. The method also comprises obtaining a general sentiment score over a plurality of time increments over a time period. Further, the method comprises identifying, for each general sentiment score, a number of time periods that the general sentiment score remains unchanged. Additionally, the method comprises assigning a neutral general sentiment score. The method also comprises assigning an information decay factor. The method further comprises calculating a fade-adjusted general sentiment score at a given time based on (a) a general sentiment score at the given time, (b) a number of time periods that the general sentiment score has remained unchanged, (c) the assigned neutral general sentiment score, and (d) the assigned information decay factor. The method also comprises obtaining a seed long-term score by combining the plurality of fade-adjusted general sentiment scores present within the seasoning period. Additionally, the method comprises calculating a present long-term score by iteratively updating long-term scores associated with a time period between the time associated with the seed long-term score and the time associated with the most current long-term score, wherein said long-term scores are updated based on factors selected from the group consisting of a fade-adjusted general sentiment score, diminishing rate, a seed value of the long-term score, and the most recent previous long-term score. The method also comprises counting a volume of news events associated with a particular time increment. Additionally, the method comprises calculating an average per-time-increment volume associated with each time increment across a plurality of time increments within a time period. The method further comprises determining that a particular time increment within the plurality of time increments is associated with a relative volume spike in comparison to other time increments within the time period. Further, the method comprises calculating a maximum volume spike within the time period. Additionally, the method comprises assigning an attenuation factor that is configured to amplify a particular long-term score. The method also comprises modulating the calculated present long-term score based on the assigned attenuation factor.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 is a schematic illustration of an embodiment of a method and system allowing a sentiment analytics engine to operate upon flows from a plurality of informative item source, a plurality of areas of interest, and a plurality of observers and contributors.

FIG. 2 is a flow diagram depicting the computation of temporally contiguous sentiment indices exhaustively over all areas of interest. In a preferable embodiment, the computation is carried out on standard computing devices known in the art.

FIG. 3a and FIG. 3b show examples of user interfaces through which an observer may select an option to provide sentiment feedback relating to an entity.

FIG. 4a and FIG. 4b show examples of user interfaces through which an observer may provide feedback in response to one or more questions.

FIG. 5a and FIG. 5b show examples of user interfaces showing a score indicative of the value of the entity.

FIG. 6 shows a display providing information about an entity's overall value score as well as scores for specific categories.

FIG. 7 shows a system for providing crowd-based sentiment indices in accordance with an embodiment of the invention.

FIG. 8 shows an example of a computing device in accordance with an embodiment of the invention.

FIG. 9 shows an example of a browser extension tool that may be used to collect user feedback about a web site.

FIG. 10 shows an example of a feedback region implemented using a browser extension tool.

FIG. 11 shows an example of a browser extension tool providing a link to a website of a system for providing crowd-based sentiment indices.

FIG. 12 shows an example of a user interface that displays live updates.

FIG. 13 shows an example of a voting widget.

FIG. 14 shows another view of a voting widget in accordance with an embodiment of the invention.

FIG. 15 provides an example of a ticker figure.

FIG. 16 provides a technical architecture overview in accordance with embodiments of the invention.

FIGS. 17A-170 illustrate charts that depict successive levels of summary performance information in accordance with embodiments of the invention.

FIG. 18 illustrates a chart exemplifying the output of the General Sentiment Score generation process producing an indicator as a function of time.

FIG. 19 illustrates a set of exemplifying charts and numbers illustrating the process for combining individual category scores into a custom blend.

FIG. 20 illustrates a chart exemplifying the output of the Long Term Score generation process producing an indicator as a function of time related to the underlying General Sentiment Score.

FIG. 21 illustrates a chart exemplifying the output of the Volume-Modulated Long Term Score generation process producing an indicator as a function of time related to the underlying General Sentiment Score, Volume of sentiment rating news events, and Long Term Score.

FIG. 22 is an illustration of a favorable Relative Trend Score generated from the Long Term Score movement shown in the accompanying chart, relative to its generating General Sentiment Score. The rendering of the Relative Trend Score shows the output of the Relative Trend Score compass visualization generation, with the needle oriented upward indicating favorability.

FIG. 23 is an illustration of an unfavorable Relative Trend Score generated from the Long Term Score movement shown in the accompanying chart, relative to its generating General Sentiment Score. The rendering of the Relative Trend Score shows the output of the Relative Trend Score compass visualization generation, with the needle oriented downward indicating unfavorability.

FIG. 24 illustrates a set of exemplifying charts and numbers illustrating the process for combining particular category scores for a set of areas of interest into an aggregate score over that combination of areas of interest.

FIG. 25 illustrates a chart exemplifying the output of the Aggregate General Sentiment Score generation process producing an indicator as a function of time representing combined indications across a collection of areas of interest in a particular category.

FIG. 26 illustrates a set of exemplifying charts and numbers illustrating the process for combining custom category scores for a set of areas of interest into an aggregate score over that combination of areas of interest.

FIG. 27 shows a computer control system that is programmed or otherwise configured to implement methods provided herein.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for assessing and providing long-term indicators of sentiment. Various aspects of the invention described herein may be applied to any of the particular applications set forth below. The invention may be applied as a standalone device, or as part of an integrated online valuation system. It shall be understood that different aspects of the invention can be appreciated individually, collectively, or in combination with each other.

Long-term indicators of sentiment may be generated by assessing a numerical sentiment index, or a plurality of sentiment indices, representing the aggregate sentiment of a collection of contributing observers. The contributing observers may retain a range of expertise or influence in an area of interest, and may review informative items relating to said area of interest arising from a source, or plurality of sources. Examples of sources may include newsfeeds, company filings, agency studies, government data, and analyst reports.

In various embodiments, sentiment that is generated may provide observers with feedback of the values of the sentiment index or indices associated with the area of interest, enabling further sentiment input by additional observers. The feedback provided to an observer may incorporate or aggregate values of the sentiment index or indices from other observers. This feedback looping process can then continue indefinitely and with updates at high temporal frequency.

Furthermore, in various embodiments, sentiment that is generated may provide observers with a flow of the latest informative items, most recently available from their sources, which can be contemplated for additional sentiment input. In some examples, sentiment that is generated may be designed to provide observers with precise numerical representations of the most current possible sentiment associated with an area of interest, in addition to a temporal history of such a numerical representation over arbitrary, selectable ranges of time.

Once sentiment has been generated, methods and systems described herein may be used to assess and provide long-term indicators of sentiment. The various functions and methods described herein are preferably embodied within software modules executed by one or more devices possessing general purpose computing capabilities, including, but not limited to, general purpose computers, mobile “smart” phones, tablet computers, or any device possessing a Von Neumann computer architecture. A preferable embodiment also includes computing devices presenting output on visual display units, with a further preference being those with input touch capabilities. In certain preferable cases, some of the various functions and methods described herein can be embodied within hardware, firmware, or a combination or sub-combination of software, hardware, and firmware. Further examples of device or hardware characteristics are described elsewhere herein.

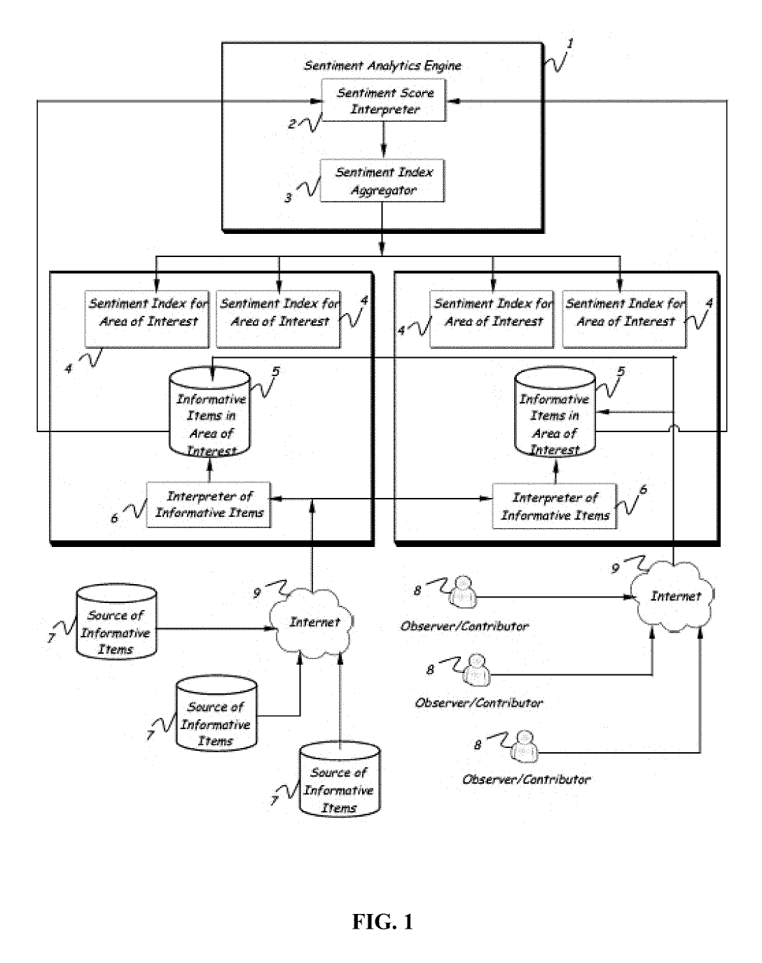

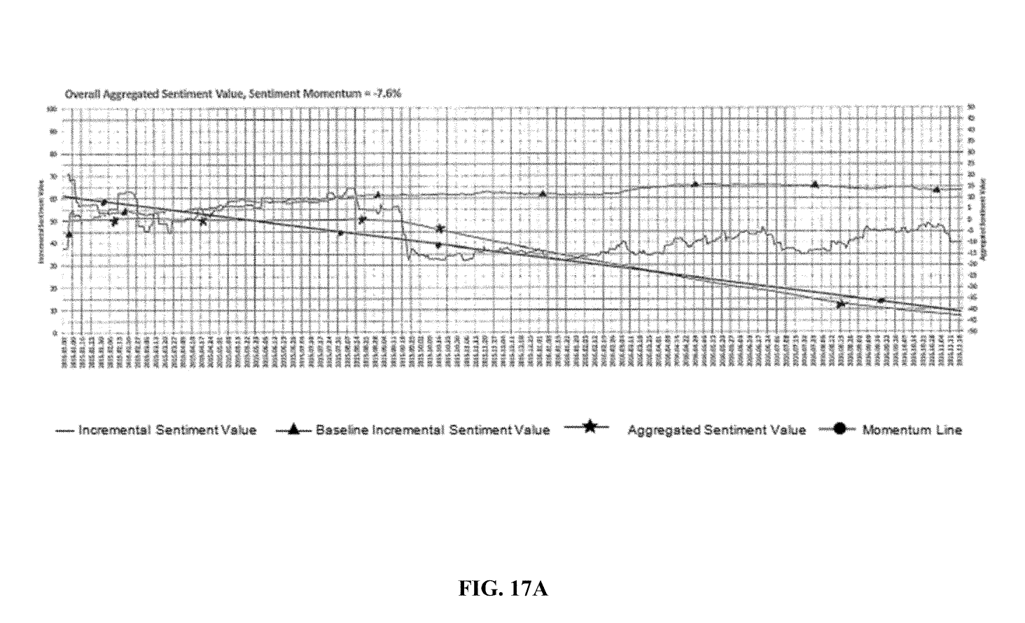

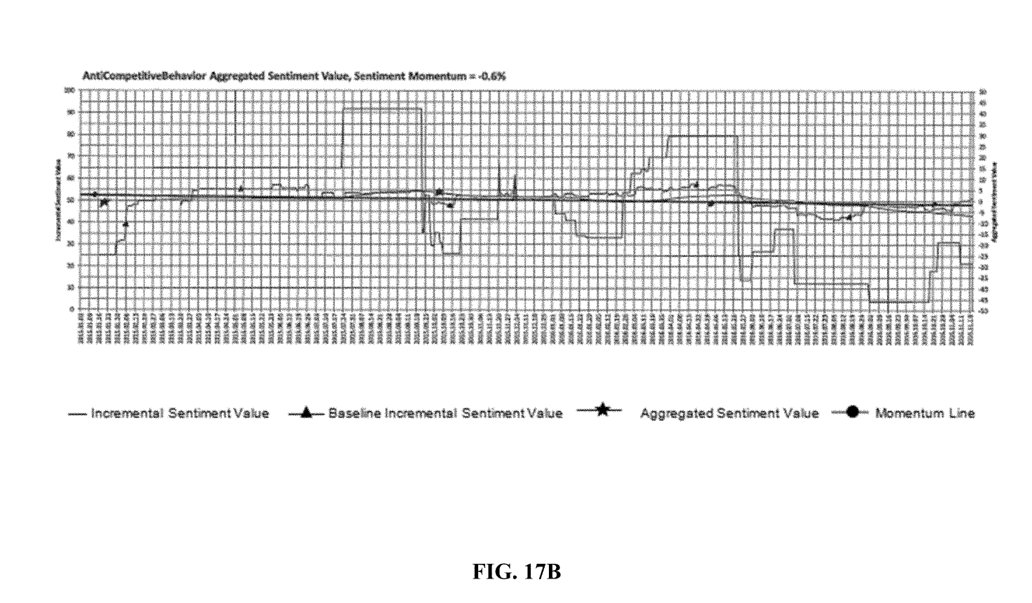

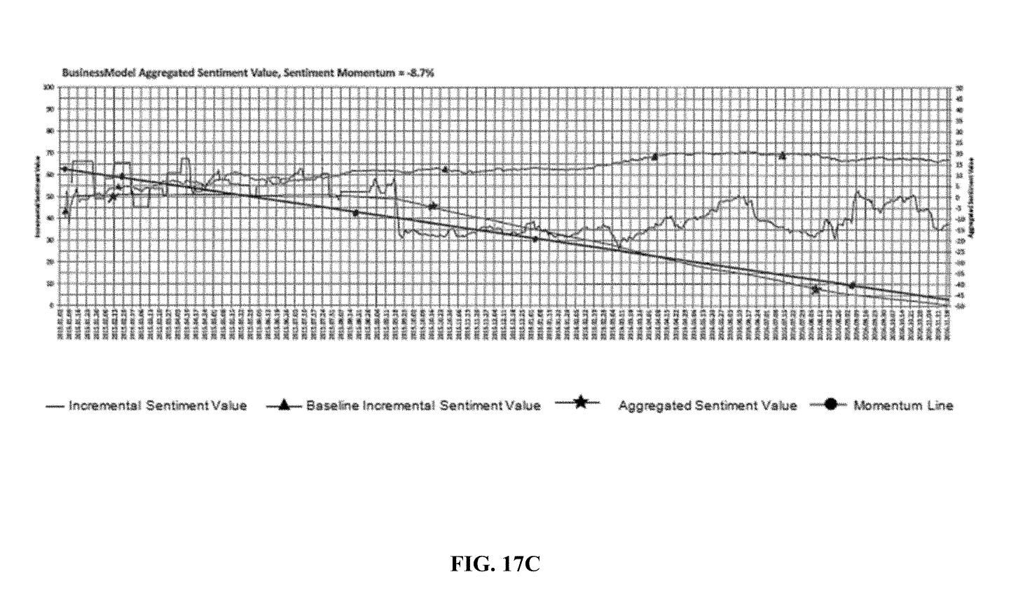

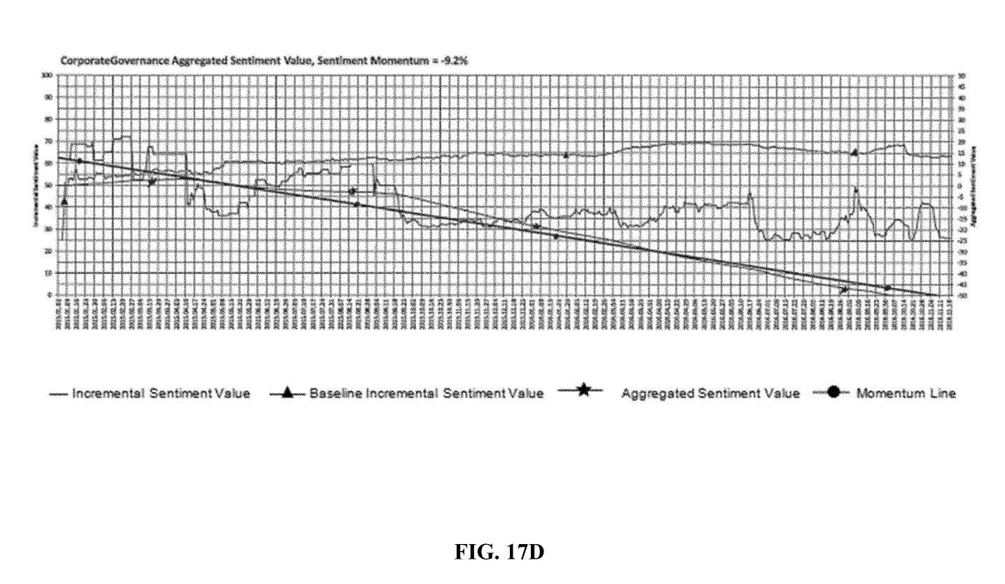

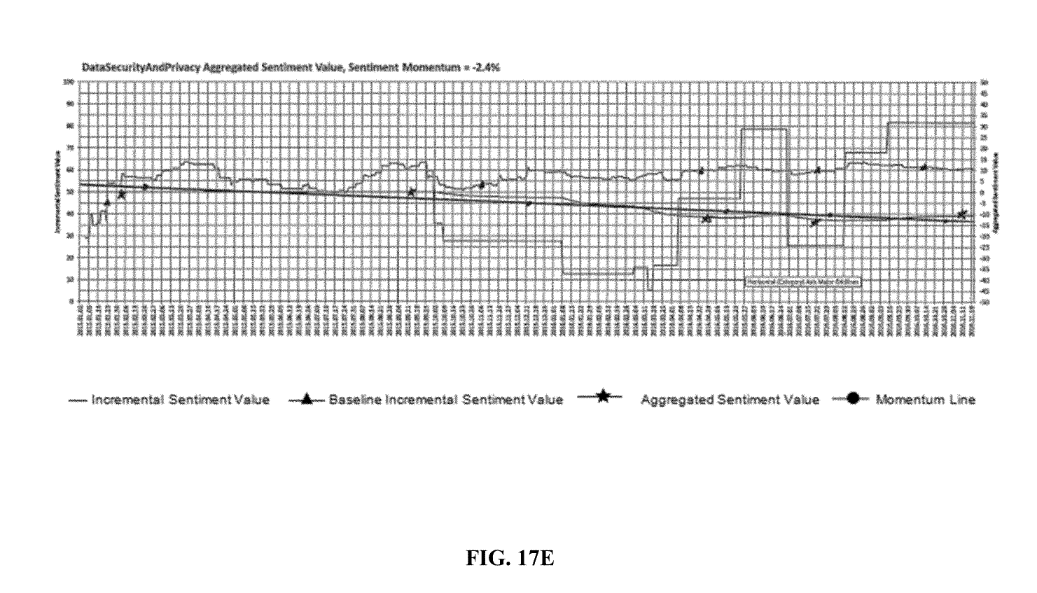

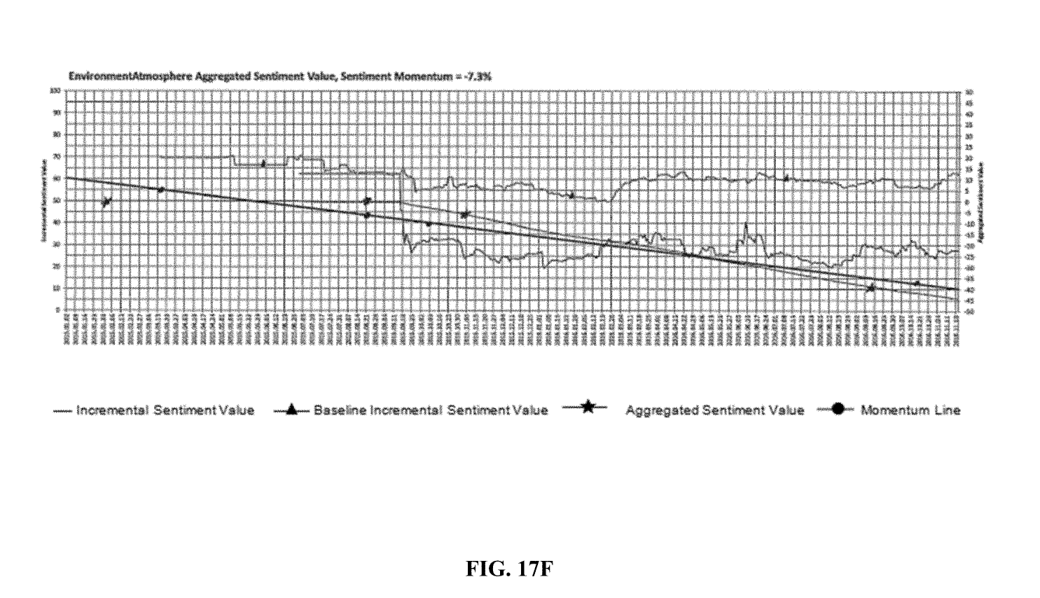

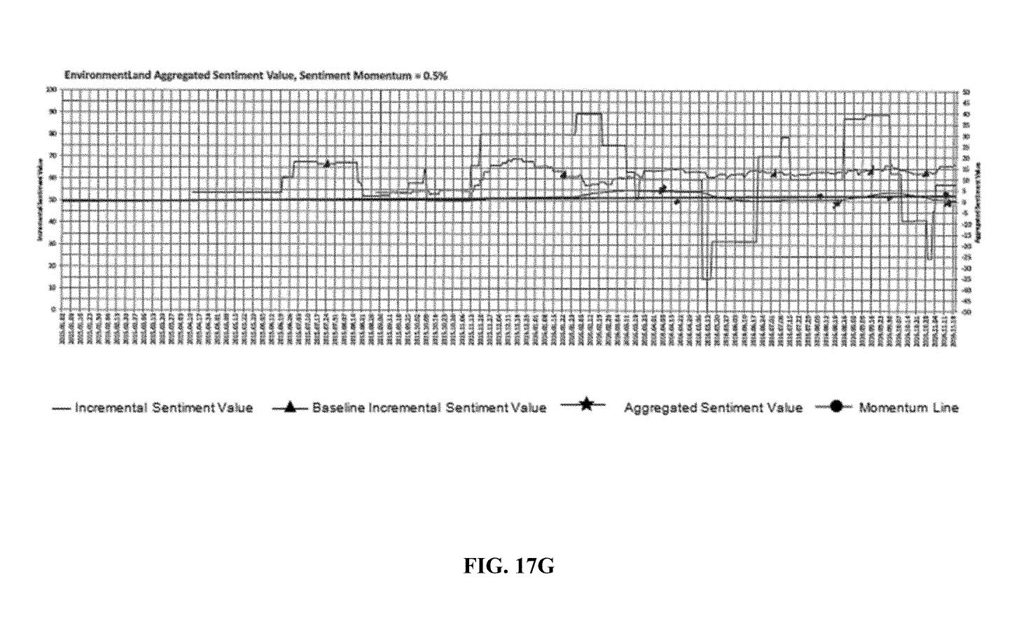

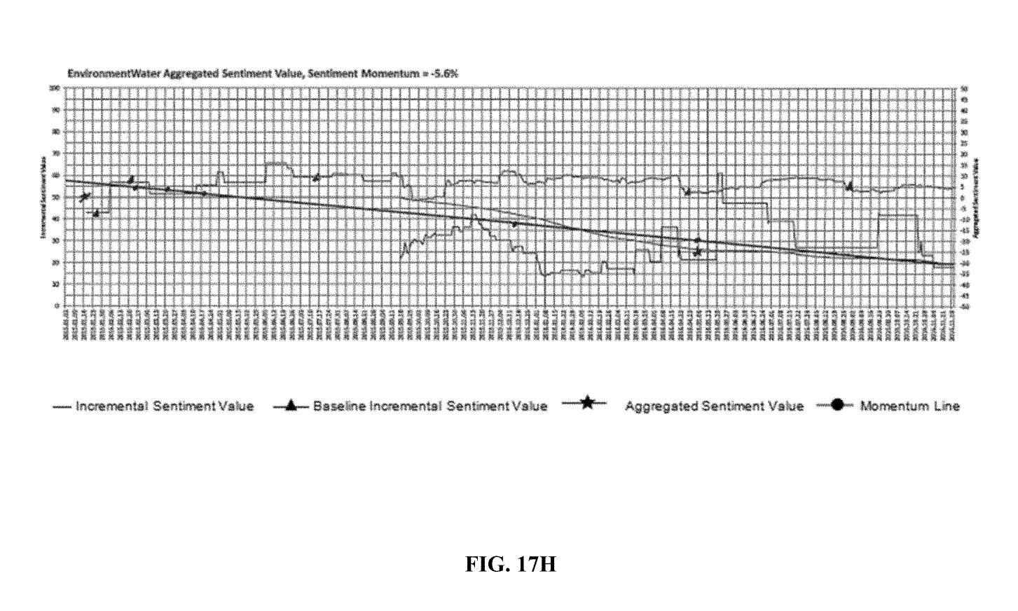

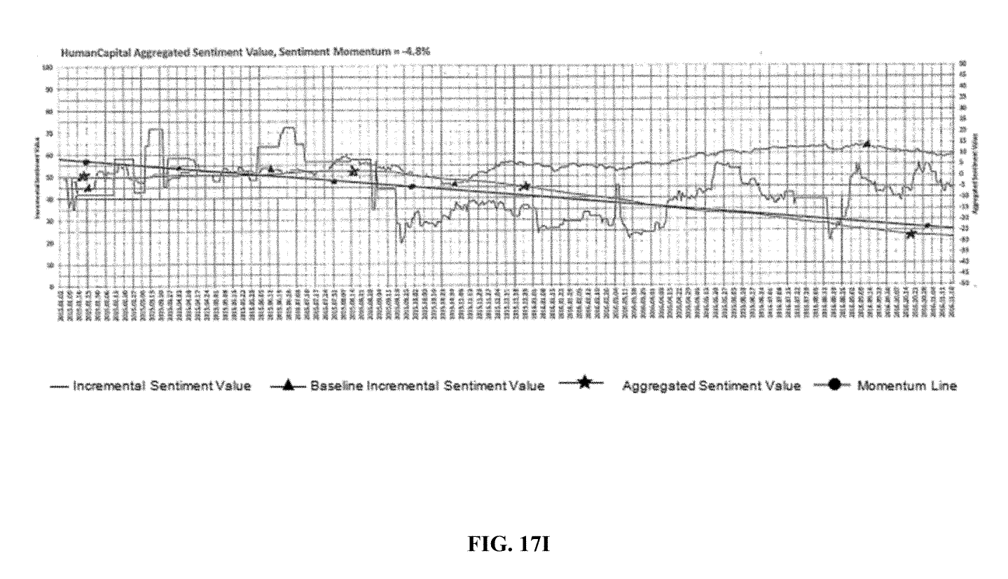

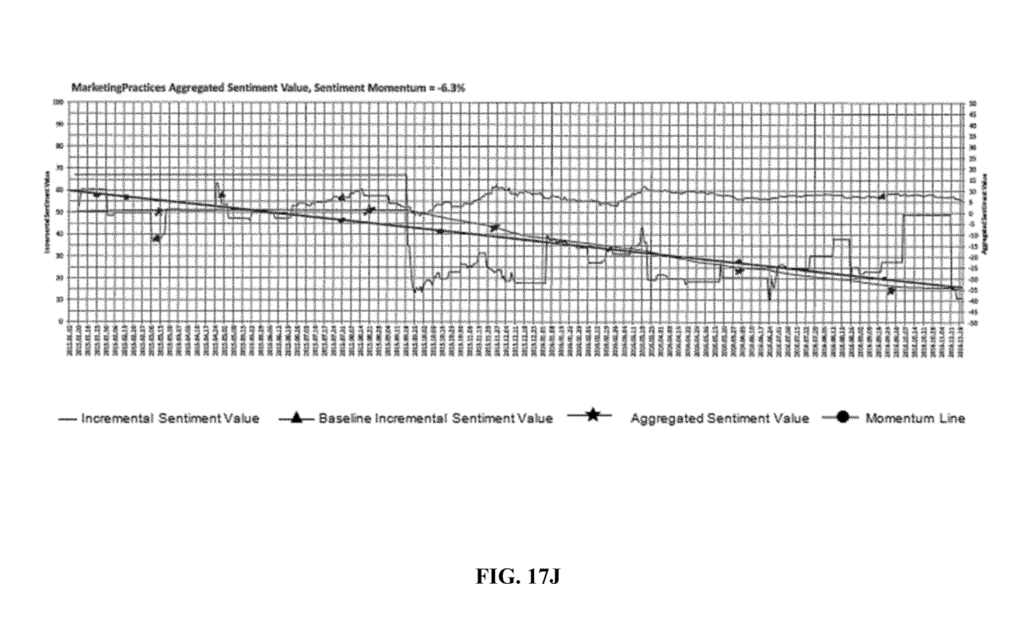

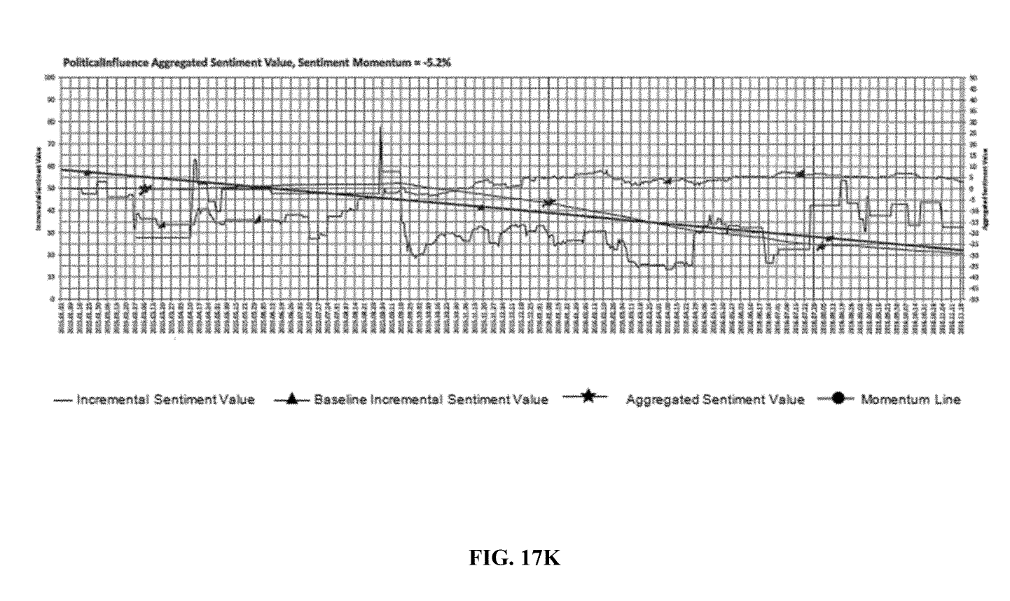

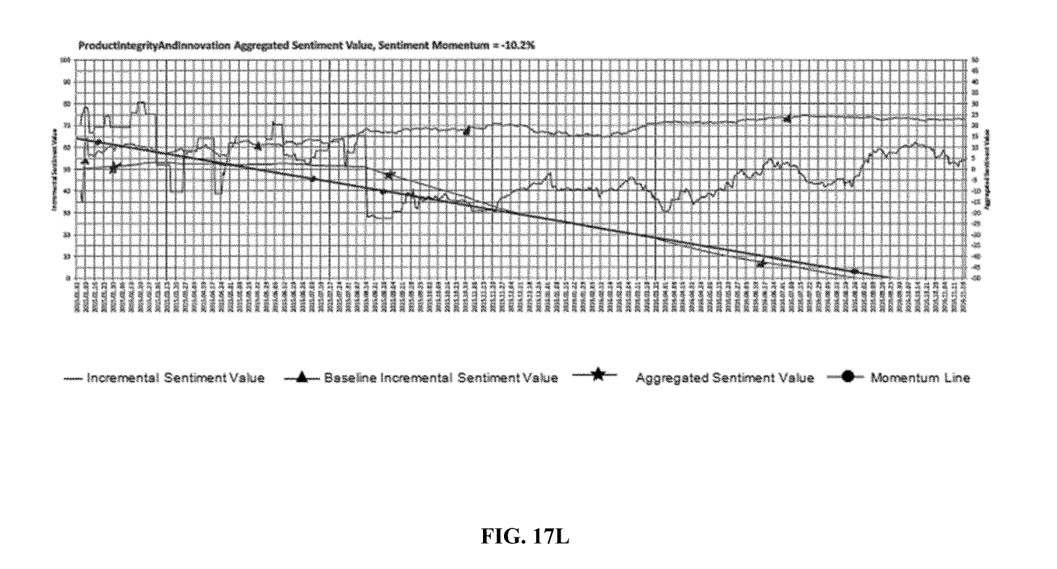

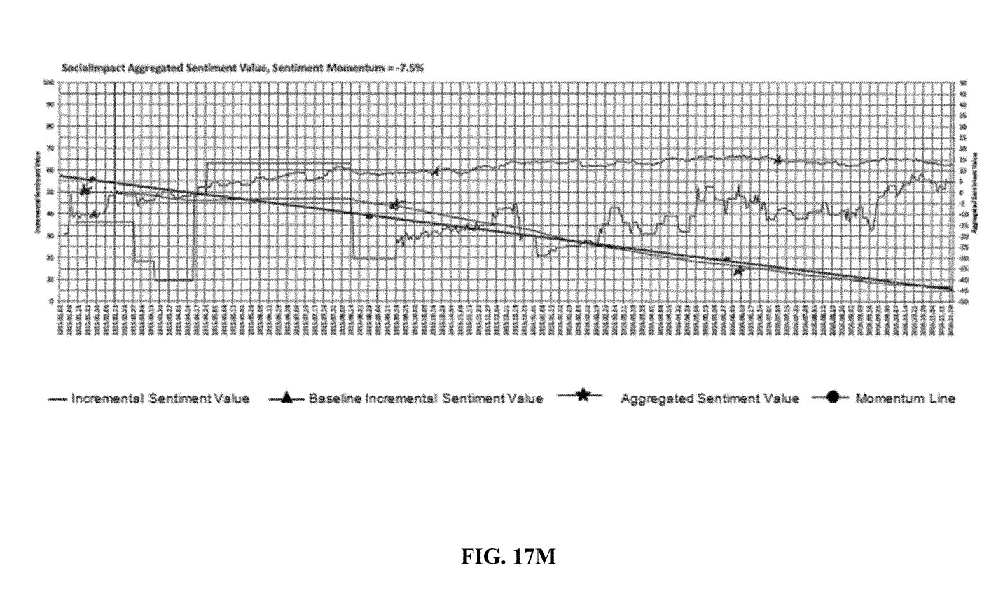

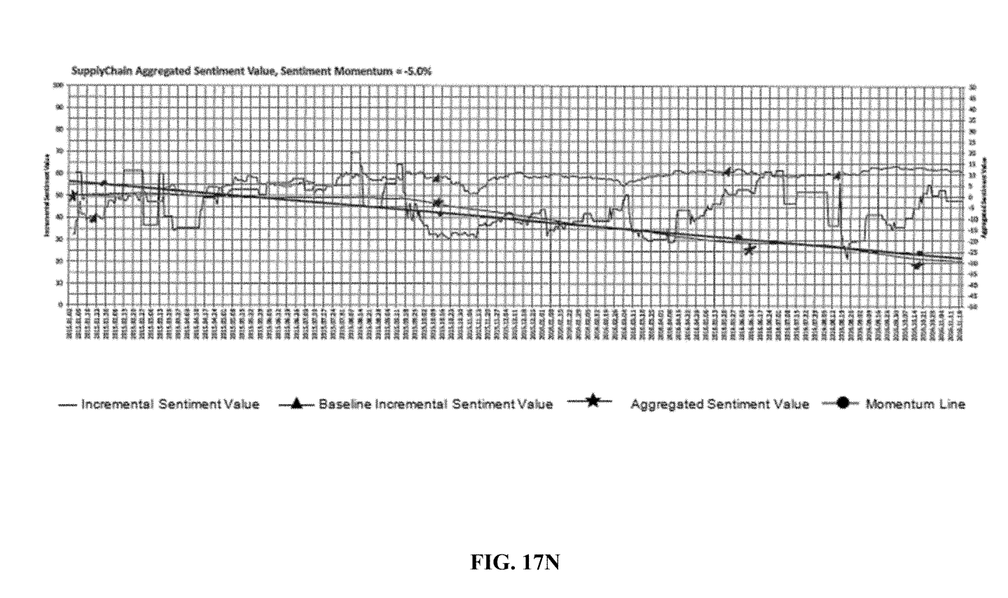

As provided below, FIGS. 1-16, 18, and 19 describe methods and systems of generating sentiment. Sentiment generated using methods as described in FIGS. 1-16, 18, and 19 may be assessed to provide long-term indicators of sentiment. Additionally, FIGS. 17 and 20-27 describe methods and systems of assessing and providing long-term indicators of sentiment.

FIG. 1 illustrates a preferable embodiment of the invention comprising a sentiment analytic engine 1, which comprises a sentiment score interpreter 2 that gathers, quantifies, and measures sentiment feedback information corresponding to an informative item in an area of interest 5. The sentiment analytic engine 1 may further comprise a sentiment index aggregator 3 that distributes, for each area of interest, a sentiment index, or plurality of sentiment indices 4. The sentiment index or indices may be mathematically or algorithmically derived from sentiment score information quantified and measured by the sentiment score interpreter 2 for each area of interest. The sentiment score information may be associated with an informative item, being within a plurality of such informative items 5, each associated with sentiment input contributed by an observer, or plurality of observers 8. In some embodiments, the areas of interest may relate to different categories or metrics relating to an entity. The areas of interest may relate to different ways of measuring value, finances, performance, image, publicity, responsibility, or activity of an entity. The areas of interest may be of interest to an investor who may want to invest in an entity, purchase or acquire products and services from the entity, or provide products and services to the entity. The areas of interest may be known as an ESG framework and may typically measure Environmental, Social and Corporate Governance aspects of a company.

FIG. 1 further illustrates a preferable embodiment of the invention additionally comprising an interpreter of informative items 6, which collects, through search techniques known in the art, informative items from available sources 7 relating to a given area of interest. Examples of sources 7 may include structured data. Examples of sources 7 may include unstructured data. Examples of sources 7 may include dynamic web feeds; external structured datasets (e.g., Trucost, EDGAR), NGO sources (e.g., CDP, Echo), and/or company data (e.g., NYSE, NASD, MSCI ACWI). In a preferable embodiment of the invention, the interpreter of informative items algorithmically summarizes the informative items, using summarization algorithms known in the art, to produce compact representations of the original informative items sufficient for ease of consumption by observers and contributors 8. The interpreter of informative items 6 preferably has an additional capability to generate a conventional sentiment score using sentiment computation algorithms known in the art. An available source of informative items 7 may be, for example, a standard known news or analysis source available to the public as a service, providing information items as digital data through the Internet 9 to consumers of such informative items.

In addition to employing summarization algorithms known in the art, to produce compact representations of the original informative items sufficient for ease of consumption by observers and contributors, an algorithm carrying out any or all the steps below can be alternatively employed to produce a compact representation:
Content parsing. In particular, the algorithm may obtain source text and parse into separate collections of words and sentences.
Construct an additional separate collection of “commonly used” words to not be included as substantively significant. This collection can include parts of speech such as direct and indirect articles, non-nouns, and other preset words identified as not significant to the area of interest.
Construct an additional separation collection of words pertinent to the area of interest. (As an example, if the area of interest is a company, the name of the company would be included in the collection.) For each word in the collection, assign a relative numerical weight.
Traverse the source text and count the occurrences of all words not in the “commonly used” collection.
Traverse the collection of sentences and ascribe a weight to each as an increasing function of:
   The sum of the counts of occurrences of non “common use” words in the sentence within the overall source text.
   The sum of the weights of words pertinent to the area of interest.
Sort the weighted sentences by weight, highest to lowest.
Display to consumers the sentences from the sorted list do any desirable depth (For example, first five sentences), and interpret this result as a summarization of the source material.

The method of providing compact representations of the original information may be used by way of example only and is not limiting.

Sentiment Acquisition Methods

A preferable embodiment of the invention provides capabilities for each observer or contributor 8 to efficiently inspect multiple informative items in an area of interest 5. A preferable mode of presenting a plurality of information items 5 may include augmenting conventional methods of presenting multiple information items simultaneously known in the art, such as computer display “windows”, “tiles”, and the like, with movement and content selection algorithms enabling rapid consumption and feedback acquisition. The multiple informational items simultaneously displayed may relate to a single entity or multiple entities.

A preferable embodiment of such algorithms driving the presentation of information items include controlling the duration of time an item is presented proportional to the amount of sentiment feedback upon it, relative to that of other information items being presented.

Similarly, a preferable embodiment of algorithms driving the presentation of information items include controlling the proportion of display area occupied by the information items with a positively correlated proportion of sentiment feedback relative to that of other information items being presented.

Another preferable embodiment of a display control algorithm enables information item display duration and display proportion to be controlled by the incident reference counts upon each information item by other information items.

A further preferable embodiment of the information item display control algorithm displays information items in visual clusters as they relate to particular areas of interest.

An additional preferable embodiment of a display control algorithm combines the above techniques with preset weights of influence.

An additional preferable embodiment of the invention to acquire sentiment measurements may utilize sentiment values published and/or updated periodically with applicability over known durations of time. These values may then be mapped and scaled to be made mathematically comparable with the observer-driven sentiment metric ranges and further associated with timestamps distributed in a density over the same duration of time proportionate to the significance or relevance of the values in determining sentiment. The resulting sentiment output of this process can then be likened to equivalent observer-driven sentiment input metrics, suitable for processing identical to that for observer-driven sentiment input metrics. The timestamps may be reflective of when data is received (e.g., feedback from one or more users) or when data is calculated (e.g., calculation of a sentiment score or index). The timestamps may be collected with aid of a clock of a device or system.

In some examples, humans may but used to evaluate sentiment of content received from sources. In some examples, machines and/or processors may be used to evaluate sentiment of content received from sources. In some examples, machines and/or processors may be used to evaluate sentiment of content and humans may also be used to evaluate sentiment of content.

An additional preferable embodiment of the invention to acquire sentiment measurements employs natural language processing (NLP) algorithms known presently in the art which detect superlative (positive or negative) sentiment related to attributes of entities described in natural language, textual or audio. The algorithm may be steered, as known in the art, with keywords relating to the particular areas of interest. Ontological connections for different terms may be made. The sentiment output is then made mathematically comparable with the observer-driven sentiment metrics through known mathematical normalization and scaling techniques.

In examples, training the artificial intelligence (AI), associated with NLP, to detect sentiment in programmable categories may be an iterative process of successive refinement based upon setting inputs, observing results, and repeating until a satisfactory level of accuracy is accomplished. In some examples, the scope of a category may be defined, identifying subtopics it covers. Additionally, a calibration test set of article text may be built up. Text relevant to each subtopic that are representative of the target universe of text may be included in the calibration set. Each subtopic may have a few straightforward examples along with more oblique references. A reference might be oblique if it is only a brief mention or it uses less common vocabulary. Additionally, examples for edge cases may be collected, where the subtopic may be distinguished from similar but irrelevant subtopics.

Lexicons, collections of pertinent terms related to, or describing, topics or subtopics, may be defined that correspond to each subtopic. Tests may be run on the text examples, comprising the observation of the accuracy in automatically extracting a topic from raw text given a trial lexicon, and the performance of each lexicon may be evaluated. If the results are acceptable, then thresholds may be set to where relevant oblique references are counted but irrelevant references do not count. When the performance is ambiguous, an evaluation may be performed as to whether the error is consistent. Then either the subtopic may be split, or a problematic edge case may become its own subtopic. The subtopics may then be redefined, more examples may be collected to address the new subtopics, and lexicons may be edited. If the subtopics are already well-defined with enough examples, then some lexicons may be used as filters for other lexicons. Filters may use lexicons to implement boolean logic operations such as “AND” or “NOT.”

For example, a topic such as “worker treatment and rights” may include fair pay, occupational safety, and non-abusive treatment of employees. After an initial round of trying to detect all these topics with one signal, it may be found that the signal regularly misses slave labor and worker abuse. As a result, the signal may be split it into two signals, “worker treatment” and “worker abuse.” From testing, a couple of problematic edge cases may also be identified. In some examples, events involving the employees of suppliers may not be included. Additionally, senior management may be excluded from the definition of “worker.” The way that the workers are referred to may not differ much whether it's the workers of suppliers or a company's own workers. So it may not be easy to narrow the signals themselves to exclude suppliers. It may be easier to detect whether the article is primarily about the supply chain or suppliers in general, and if it is, to disregard worker signals. This is an examples of a “NOT” filter on “worker treatment” and “worker abuse.” The final formula on the signals in this example is as follows.

(“worker treatment” OR “worker abuse”) NOT “supply chain”

Score Interpretation Methods

In reference to FIG. 1, a preferable embodiment of the sentiment score interpreter 2, delivers capabilities to tabulate, in preparation for use by the sentiment index aggregator 3, numerical sentiment score values associated with a particular informative item in a particular area of interest 5, provided by a particular contributor 8.

An additional preferable embodiment of the sentiment score interpreter 2, delivers capabilities to algorithmically generate, in preparation for use by the sentiment index aggregator 3, additional numerical sentiment scores correlated with the known sentiment of the author of an information item being examined by any or all observers and contributors.

An additional preferable embodiment of the sentiment score interpreter 2, delivers capabilities to algorithmically generate, in preparation for use by the sentiment index aggregator 3, additional numerical sentiment scores generated by applying known automated sentiment scoring algorithms to textual feedback items, such as “blog comments”, associated with each informative item being examined by any or all observers and contributors.

An additional preferable embodiment of the sentiment score interpreter 2, delivers capabilities to algorithmically generate, in preparation for use by the sentiment index aggregator 3, additional numerical sentiment scores generated by applying known automated sentiment scoring algorithms to “social media” content relative to the area of interest associated with each informative item being examined by any or all observers and contributors. A skilled artisan can appreciate the use of “social media” to obtain sentiment information.

Sentiment Index Generation Methods

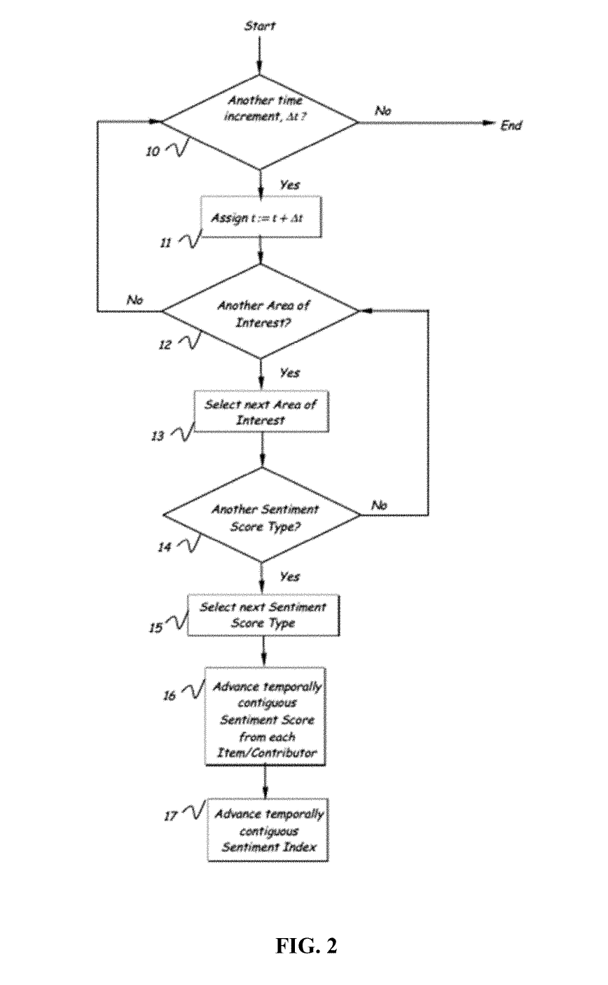

With reference to FIG. 1, a preferable embodiment of the sentiment index aggregator 3, delivers capabilities to algorithmically generate, as described below, a sentiment index, or plurality of sentiment indices, associated with each area of interest 4, upon gathering input from the sentiment score interpreter 2. With reference to FIG. 2, a preferable method generates sentiment indices for each area of interest at regular, irregular, or arbitrary time increments 10, as desired by the consumer of the sentiment index, or plurality thereof. A skilled artisan can appreciate that a mark of time derived by arithmetically summing a prior mark of time with the new increment can be contemplated as an update time mark 11 for the sentiment index, or plurality of sentiment indices to be derived.

In a preferable embodiment, all areas of interest can be represented and maintained as a collection of computational data resident in the storage subsystems of a computing device known in the art. A skilled artisan can then appreciate the process of computationally examining each area of interest sequentially 13 and the capability to repeat the examination of the sequence an arbitrary number of times 12, preferably indefinite. A preferable embodiment further allows for the insertion or deletion of unique areas of interest into the collection.

In a preferable embodiment, all sentiment score types related to an area of interest can be represented and maintained as a collection of computational data resident in the storage subsystems of a computing device known in the art. A skilled artisan can then appreciate the process of computationally examining each sentiment score type sequentially 15 and the capability to repeat the examination of the sequence an arbitrary number of times 14. In some instances, the examination may be repeated until a pre-condition is met. In some instances, the examination may be repeated indefinitely. A preferable embodiment may further allow for the insertion or deletion of unique sentiment score types into the collection, corresponding to a given area of interest.

In a preferable embodiment of the invention, for a sentiment score type under examination, as determined by the sentiment score type examination selection process 15, within an area of interest under examination, as determined by the area of interest examination selection process 13, the current numerical value for the sentiment score is acquired from the sentiment score interpreter 2, in reference back to FIG. 1, for a particular informative item 5 scored by a particular contributor 8. Preferably, the sentiment score numerical value is associated with the current time mark determined in the time mark incrementing process 11. A skilled artisan can appreciate the preferable recording of the association of the numerical sentiment score value with the current time mark in the digital storage media of a computing device, as a preferable method for such recording. A preferable method for then generating the temporally contiguous sentiment index, yielding a numerical sentiment index value at an arbitrary time mark, at present or at a past time, aggregated across all informative items associated with a particular area of interest, with associated sentiment scores provided by a contributor, or plurality of contributors, carried out by the sentiment index aggregator process 3 is as follows. In one embodiment, this step of advancing the temporally contiguous sentiment index 17, for current or future access by consumers of the value yielded, is generated according to the following method. However, skilled artisans will understand from the teachings herein that other methods for computing such a temporally contiguous numerical sequence of values can be used.

A particular contributing observer 8 that provides a sentiment score can be labeled u for this preferable method description. Similarly, a particular informative item in an area of interest 5 can be labeled i for this preferable method description. Additionally, the time mark generated in step 11 can be labeled tᵤᵢ for this preferable method description. For this preferable method description, the sentiment score value provided by the contributor u, through the sentiment score interpreter 2, associated with a particular informative item i, at a particular time t can be labeled R(t)(u)(i). For the purposes of this preferable method description, it will apply to a particular sentiment score type in a particular area of interest, as the skilled artisan can appreciate that it can be applied to each sentiment score type within each area of interest with no change to the method itself. R(t)(u)(i) can be considered as a function of three variables, contiguous in time t, and discrete in both u and i. R may be a sentiment score given by an observer (e.g., may be one of a plurality of dimension values). A skilled artisan can appreciate these mathematical interpretations. The value of the function at any time t is the sentiment score, provided by observer u on informative item i is defined, in the mathematical terminology know in the art as a “step” function, and with the value of the sentiment score set at the most recently updated time tᵤᵢ. This value persists until the next update time tᵤᵢ. For all time prior to the first update time tᵤᵢ the function is not defined mathematically. For this preferable method description, the sentiment index value can be labeled S(t), which is the objective of step 17. In this preferable embodiment, S(t) is computed by ranging over all u and all i, multiplying each value of R(t)(u)(i) found by a weight associated with the particular observer u and particular information item i, summing these products together and then dividing the completed sum by the sum of all the weights. The skilled artisan can appreciate that the weights can be pre-recorded in digital storage media associated with a computing device and extracted for this calculation. In a preferable embodiment of this invention, the weights can be pre-correlated with the significance of the observer and the significance of the information item.

A further preferable embodiment generates a summary sentiment index by mathematically combining a plurality of sentiment indices related to an area of interest 4 applying a mathematical function that maps multiple scalar values into a single scalar value. A preferable embodiment of such a function is an arithmetic mean. A further preferable embodiment of such a function is a weighted arithmetic mean, with weights set correlated to the significance of a particular contributing sentiment index to the overall summary thusly computed. A preferable embodiment in selecting the plurality of sentiment indices related to an area of interest for summarization would be those indices corresponding to areas of interest subordinate to a particular major area of interest. Examples of this arrangement include scenarios where the major area of interest represents a publicly traded corporation and the subordinate areas of interest represent facets of corporate governance and behavior, such as leadership, employee relations, innovation, supplier or “ecosystem” relations, environmental stewardship, and customer relations.

An alternative embodiment for generating sentiment indices that unifies and weighs the various inputs is described below:

Given:
v(u_{i,g},dₙ,c_{j,k},s,tₘ) ≡ vote value from the i^{th} observer u_{i,g} of the g^{th} classification group,
in the n^{th} category dimension dₙ,
for the j^{th} area of interest c_{j,k} of the k^{th} area of interest group,
observing the s^{th} information source,
at the m^{th} past time stamp tₘ (measured in whole and fractional days),
∀i,g,n,j,k,m
I_{g} ≡ number of observers in the g^{th} observer classification group
I_{g} ≡ (dₙ,c_{j,k}) ≡ number of observers in the g^{th} observer classification group
who have ever cast a vote value
in the n^{th} category dimension dₙ,
for the j^{th} area of interest c_{j,k} of the k^{th} area of interest group
G ≡ number of observer classification groups
N ≡ number of category dimensions
Jₖ ≡ number of areas of interest in the k^{th} area of interest group
K ≡ number of area of interest groups
M ≡ number of timestamp events
v₀ ≡ vote value considered neutral − below which is considered negative, above which
positive
w_{g} ≡ weight of g^{th} observer classification group, ∀g
y_{n,k} ≡ within n^{th} category dimension, weight of k^{th} industry, ∀n,k
zₛ ≡ normalized weight of s^{th} information source, ∀s
r ≡ average daily rate of information decay
Dₐ ≡ a^{th} day within a contiguous sequence of days spanning all tₘ at which any vote was
made, measured on scale common with the tₘ
T(Dₐ,dₙ,c_{j,k}) ≡ set of all tₘ at which votes in the n^{th} category dimension dₙ,
for the j^{th} company c_{j,k} of the k^{th} industry,
contained within day Dₐ
|T(Dₐ,dₙ,c_{j,k})| ≡ size of set T(Dₐ,dₙ,c_{j,k})
≡ daily vote volume in the n^{th} category dimension dₙ,
for the j^{th} area of interest c_{j,k} of the k^{th} area of interest group
Dₐ(tₘ) ≡ day Dₐ containing tₘ
Vₙ(c_{j,k},tₘ) ≡ |T(Dₐ(tₘ),dₙ,c_{j,k})| ≡ daily vote volume in the n^{th} category dimension dₙ,
for the j^{th} area of interest c_{j,k} of the k^{th} area of interest group,
on day containing tₘ
f(t,tₘ) ≡ (1 − r)^{t-t}^{ₘ} ≡ freshness factor of time tₘ relative to time t ≥ tₘ
f(t,Dₐ) ≡ (1 − r)^{t-D}^{ₐ} ≡ freshness factor of day Dₐ relative to time t ≥ Dₐ
Compute:
TS_{i,g,n} (c_{j,k},t) ≡ sentiment score from the i^{th} observer
u_{i,g} of the g^{th} classification group,
in n^{th} category dimension for the j^{th} area of interest c_{j,k} of the k^{th} area of interest group at time t
$≡ {\sum }_{m = 1}^{M} [ ( f ( t , {D}_{a} ( {t}_{m} ) ) {V}_{n} ( {c}_{j , k} , {t}_{m} ) ) f ( t , {t}_{m} ) {z}_{s} ( v ( {u}_{i , g} , {d}_{n} , {c}_{j , k} , s , {t}_{m} ) - {v}_{0} ) ] \text{/} ∀ i , g , n , j , k$
${\sum }_{m = 1}^{M} [ ( f ( t , {D}_{a} ( {t}_{m} ) ) {V}_{n} ( {c}_{j , k} , {t}_{m} ) ) f ( t , {t}_{m} ) ]$
≡ average of i^{th} observer vote values, relative to the neutrality origin v₀
in n^{th} category dimension for area of interest c_{j,k},
weighted by freshness, accompanying companion voting volume,
and information source weight,
TS_{g,n}(c_{j,k},t) ≡ sentiment score from the g^{th} observer classification group,
in n^{th} category dimension for the j^{th} area of interest c_{j,k} of the k^{th} area of interest group at time t
$≡ {\sum }_{i = 1}^{I} [ {TS}_{i , g , n} ( {c}_{j , k} , t ) ] \text{/} ∀ g , n , j , k$
I_{g}(dₙ,c_{j,k})
≡ average in the g^{th} observer classification group of individual observer sentiment scores
in n^{th} category dimension for area of interest c_{j,k}
TSₙ(c_{j,k},t) ≡ sentiment score in n^{th} category dimension
for the j^{th} area of interest c_{j,k} of the k^{th} area of interest group at time t
$≡ {\sum }_{g = 1}^{G} [ {w}_{g} {TS}_{g , n} ( {c}_{j , k} , t ) ] \text{/} ∀ n , j , k$
${\sum }_{g = 1}^{G} [ {w}_{g} ]$
≡ average sentiment scores over all observer classification groups,
weighted per each such group
TV_{i,g}(c_{j,k},t) ≡ overall sentiment value from the i^{th} observer
u_{i,g} of the g^{th} classification group,
for the j^{th} area of inteterst c_{j,k} of the k^{th} area of interest group at time t
$≡ {\sum }_{n = 1}^{N} [ {y}_{n , k} {TS}_{i , g , n} ( {c}_{j , k} , t ) ] \text{/} ∀ i , g , j , k$
${\sum }_{n = 1}^{N} [ {y}_{n , k} ]$
= average individual sentiment scores over all category dimensions,
weighted per category and area of interest group
TV_{g}(c_{j,k},t) ≡ overall sentiment value from the g^{th} observer classification group,
for the j^{th} area of interest c_{j,k} of the k^{th} area of interest group at time t
$≡ {\sum }_{n = 1}^{N} [ {y}_{n , k} {TS}_{g , n} ( {c}_{j , k} , t ) ] \text{/} ∀ g , j , k$
${\sum }_{n = 1}^{N} [ {y}_{n , k} ]$
= average observer category group sentiment scores over all category dimensions,
weighted per category and area of interest group
TV(c_{j,k},t) ≡ overall sentiment value
for the j^{th} area of interest c_{j,k} of the k^{th} area of interest group at time t
$≡ {\sum }_{n = 1}^{N} [ {y}_{n , k} {TS}_{n} ( {c}_{j , k} , t ) ] \text{/} ∀ j , k$
${\sum }_{n = 1}^{N} [ {y}_{n , k} ]$
= average sentiment scores over all category dimensions,
weighted per category and area of interest group

### General Sentiment Score

As an additional preferred embodiment, the general sentiment score for an area of interest, categorical or overall, is intended to reflect a continuous quantitative sentiment index, updated frequently, reflecting behavior in the areas of interest, categorical or overall. The objective of the index is to provide an indication of the movement of the sentiment over time regarding the categorical or overall area of interest, with more emphasis on the present. In addition, when creating an index of combined categories, the resultant index should be influenced more greatly by categories having more input, versus equal influence of each respective category index.

Input to the process of determining and updating the General Sentiment Score are raw sentiment rating values (referred above as vote values) in the categorical areas, derived from assessing textual news content items, as they appear in time, using technology such as Natural Language Processing (NLP) or via human votes or ratings. This phase of the process, occurring prior to the scoring methods described herein contemplates applying natural language analysis upon news content item to assess that the subject matter relates to the area of interest, categories of interest and quantifies the intensity and polarity (positive or negative) of the sentiment. These quantifications are then used as input to the scoring methods described herein.

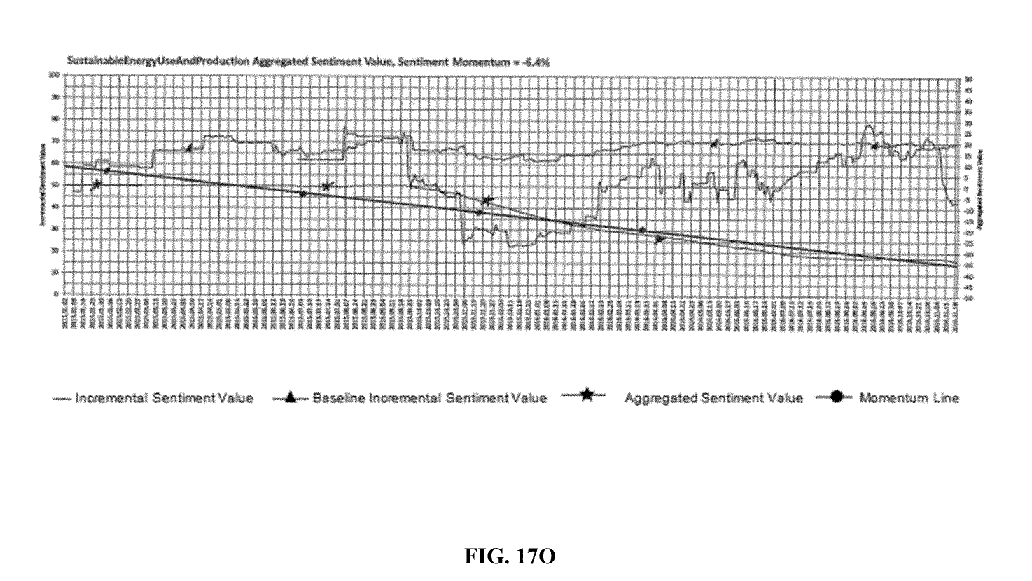

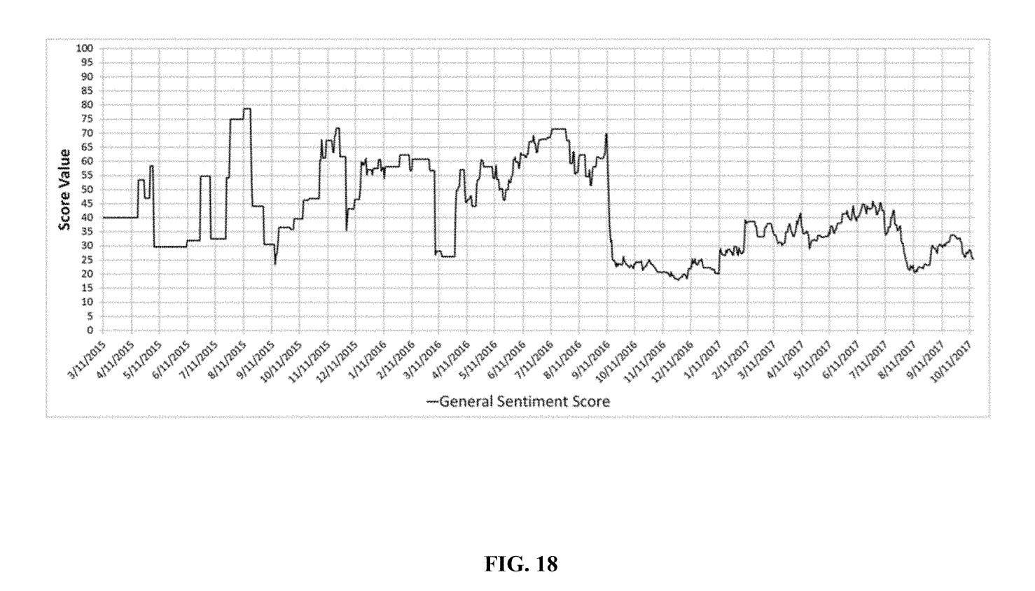

A visualization of this resulting from its implementation is shown in FIG. 18. In particular, FIG. 18 illustrates a chart exemplifying the output of the General Sentiment Score generation process producing an indicator as a function of time.

For a particular category (or overall), the General Sentiment Score is produced by applying a running sum average formulation to a continual time stream of sentiment ratings related to the category (or any category, in the case of overall), weighted by a freshness factor that varies over time within the running sum averaging technique employed. Freshness allows for more recent news to be weighted more significantly. The value of the freshness parameter, and the formulation of its mathematical application, are chosen to reflect the ephemeral nature of news events, fading in importance over time. For rating data in the past, the formula can be applied retrospectively over all data points and then prospectively applied going forward in an incremental fashion. The mathematical formulation is detailed below, with rationale for the formulating structural and parametric choices made, along with descriptive introductions to each mathematical line of text.

### Given Inputs as Described Below:

First, the ratings are sifted to the resolution of category to obtain refined input related to the category:

v(m, n)≡sentiment rating value in the n^{th} category
at the m^{th} time stamp tₘ (measured in whole and fractional days),
for a particular area of interest (such as a company) ∀ m, n

The above equation assigns a symbol to the sentiment rating and labels it for the category and time. This is the core set of sentiment values to be used in deriving the scores. These sentiment values are produced by natural language processing, upstream of this phase.
N≡number of categories

The above equation assigns a symbol to the number of categories, to be used in subsequent computation. The “freshness” effect is accomplished by applying a function that diminishes the numerical significance of the sentiment rating as it enters into the numerical summarizing (averaging) process. A preferred choice for the decay rate is two weeks, while the model is sufficiently general to select another choice for that setting, should it be determined that the significance of news has a different time constant in a different context:
f(t)≡e^{A(T-t)}≡freshness factor at time t

The above equation assigns a symbol and the exponentially functional computation to the factor used to capture the freshness of the content input assessed for sentiment. The settings below describe the parameters used in this construct:
T≡reference date selected as an arbitrary constant in the past or future

As the factors grow, this reference date T can be pushed into the future to uniformly rescale.

$$λ ≡ information currency half \text{-} life [ default 14 days ]$$

$$A ≡ information decay factor with default to a 14 \text{-} day half - life ⇒ = \frac{ln ( \frac{1}{2} )}{λ} = \frac{ln ( \frac{1}{2} )}{14 days} ≅ - 0.05 / day$$

These equations below establish the symbology used in assimilating the freshness factor into the averaging process by defining a weight when a rating value exists to which to apply the freshness factor:

$$q ( m , n ) ≡ \{ \begin{matrix}1 if a rating in the {n}^{th} category dimension exists at time {t}_{m} \\ 0 if no rating in the {n}^{th} category dimension exists at time {t}_{m}\end{matrix} \\ w ( m , n ) ≡ q ( m , n ) f ( {t}_{m} ) ≡ freshness and presence weight for the {n}^{th} category dimension at time {t}_{m}$$

The computation is then carried out as a running sum average, which has the added implicit effect of naturally adjusting for the volume of inputs entering the summary (averaging) computation over time:

Partial Running Sums (incrementally updateable as new rating events occur):

The computation is carried out at the categorical level, and to support the running sum averaging process, a numerator and a denominator are first generated:

S_{m,n}≡Σₖ₌₁^{m} w(m, n)v(m, n)≡numerator sum for the n^{th} category for scoring at time tₘ

The above equation computes the numerator used in the averaging process as a weighted sum, using the weight factors w(m, n) described above applied to the sentiment rating values v(m, n) introduced above.

W_{m,n}≡Σₖ₌₁^{m} w(m, n) denominator sum for the n^{th} category for scoring at time tₘ

The above equation computes the denominator used in the averaging process as a sum of the weight factors w(m, n) described above.

Similarly, the computation of numerator and denominator is carried out at the overall aggregated level:

Sₘ≡Σₙ₌₁^{N}Σₖ₌₁^{m} w(m, n) v(m, n)≡numerator for aggregate scoring at time tₘ

Wₘ≡Σₙ₌₁^{N}Σₖ₌₁^{m} w(m, n)≡denominator for aggregate scoring at time tₘ

General Sentiment Score Calculation:

The corresponding scores are then computed as the ratios of the numerators to denominators generated above:

P_{m,n}(t)=S_{m,n}/W_{m,n}≡General Sentiment Score for the n^{th} category at any time tₘ₊₁>t≥tₘ

Pₘ(t)≡Sₘ/Wₘ≡General Sentiment Score at any time tₘ₊₁>t≥tₘ

The above equations then compute the respective weighted sum averages at arbitrary points in time by dividing the denominators into the numerators, as defined above.

Computation of the General Sentiment Score begins with the first appearing sentiment value in the category for the area of interest, such as a company, at time t₁, with that first nontrivial sentiment value being v(1, n), corresponding to the first scoreable (rate-able) news event in the category for the area of interest, such as a company. For all computations, however, the very first entry into the running sum process is v(0, n) is a neutral value, typically 50 in a 0 to 100 score range scale, entered into the sum contemporaneous with the first nontrivial sentiment value, the neutrality origin of all scores. Put another way, all scoring calculations are seeded with the neutral value, at the same time the first nontrivial sentiment value arrives. This enables an initial damping effect that keeps the scoring system from “jumping to an initial conclusion” given just a single initial sentiment value.

The partial summing can be done in bulk or incrementally, as the above numerators and denominators can be held separately and updated as new information (sentiment ratings) occur over time. The incremental updates themselves can also be performed at any time after the new events are collected, not necessarily immediately, allowing for “bucketing” of events and semi-batch processing and updates of the numerators, denominators, and resultant General Sentiment Scores. Examples of this process would be to “bucket” scoreable event inputs for the course of an hour and then update the running sums (numerators and denominators for each category and overall) at the end of the hour.

### Combined Category Scoring

The consumer of any of the scores can be afforded the ability to combine, in a custom manner, various categories to produce a combined custom sentiment score and presentation. As discussed above, the overall score, which is an implicit combination of all category scores, is computed, for the General Sentiment Score, by performing the running sum average over all input sentiment rating values, by maintaining a separate numerator and denominator, independent of category. In this way, a natural volume weighting occurs as when more sentiment inputs arrive for one category versus another, then the category with greater arrivals has more influence in the overall General Sentiment Score. In the case of custom combined categories, the same effect is desired, yet it is impractical to maintain separate running sum numerators and denominators for all possible combinations of categories. Instead, then, the denominators used in calculating the General Sentiment Score, as explained above, of the categories being combined can be employed to provide a similar volume-weighted effect. In particular, the denominators used in the running sum averaging of the categories selected for the combination can be applied as weights in a weighted average of any of the score types, not necessarily limited to General Sentiment Score, across selected categories on an area of interest to arrive at the custom combined category rendition of the score.

Below is the description in mathematical terms, along with descriptive introductions to each mathematical line of text:

$${IS}_{j , c} ( t ) ≡ \frac{{\sum }_{k = 1}^{C} {W}_{j , k} ( t ) {IS}_{j , k} ( t )}{{\sum }_{k = 1}^{C} {W}_{j , k} ( t )} ≡ Custom Category Score at time t for the subset C of categories selected for the {j}^{th} area of interest , such as a company .$$

The above equation defines the technique for computing the General Sentiment Score corresponding to an arbitrarily combined set of categories. It is a weighted average (weighted sum divided by sum of weights) using the per-category denominators W_{j,k}(t), as defined above, and using the parameters symbolically defined in the equations below:

C≡number of categories selected

IS_{i,k}(t)≡Score known at time t for the j^{th} company in the k^{th} category within the subset C of categories selected

W_{j,k}(t)≡running sum General Sentiment Score denominator known at time t for the j^{th} company in the k^{th} category within the subset C of categories selected

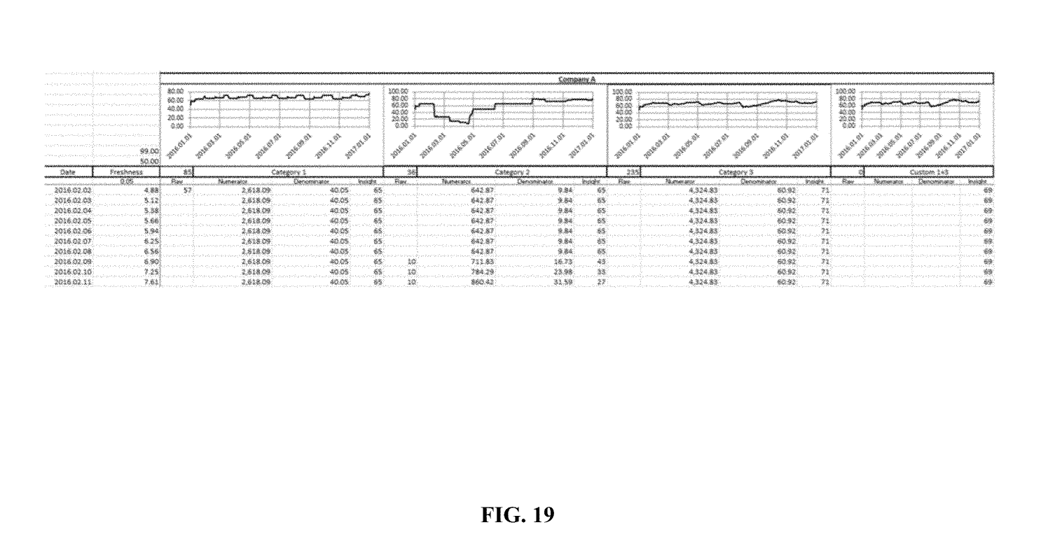

FIG. 19 illustrates a set of exemplifying charts and numbers illustrating the process for combining individual category scores into a custom blend. In the model shown in FIG. 19, the custom score category combination of Category 1 and Category 3 leans more toward the score values of Category 3, as it has a higher relative Denominator. For example, in the top row, the custom score is computed as: (40.05×65+60.92×71)/(40.05+60.92)=69.

### Sentiment Index Correlation Methods

A preferable embodiment of the invention enables the consumer of sentiment indices, generated within the capabilities of the invention, to additionally consume information characterizing the correlation of the generated sentiment indices with known, published indices in the area of interest. A skilled artisan can appreciate the use of known mathematical correlation techniques for determining correlation metrics between the sentiment indices generated by embodiments of the invention and known indices characterizing the area of interest.

A further preferable embodiment of the invention teaches the correlation of sentiment indices, in areas of interest relating to corporate behavior, with rapidly changing conventional financial indicators including, but not limited to, stock price, related derivative indicators, and other rapidly changing known financial indicators.

### Aggregate and Constituent Peer Comparative Metrics

A preferable embodiment of the invention enables the consumer of sentiment indices, generated within the capabilities of the invention, to additionally consume information articulating the collective behavior of, and relationships among, the constituents within groups of areas of interest. Information collected to various groups may be compared and/or differentiated. In some embodiments, information may be displayed relating the comparison of data relating to sentiment indices gathered from different groups.

### Aggregate Statistics

To indicate aggregate behavior of the indices corresponding to constituents of a collection of areas of interest, a preferable embodiment of the invention enables the consumer to view a display of, and/or obtain a report of, statistics computed across the collection, including, but not limited to, mean, median, and standard deviation. Such statistics may be individualized for different groups or areas or interest.

### Constituent Peer Comparisons

To indicate behavior of the indices corresponding to constituents of a collection of areas of interest, relative to other constituents within the same collection, a preferable embodiment of the invention enables the consumer to view a display of, and/or obtain a report of, comparative metrics of the index corresponding to each constituent relative to those of other constituents, selected groups of constituents, or relative to aggregate statistics across the collection.

A preferable embodiment of the invention computes comparative metrics among indices of constituents of a collection of areas of interest, relative to other constituents within the same collection, by applying the technique known in the art as “Data Envelopment Analysis” or “DEA.” Such techniques may be applied such that the “outputs” in the known DEA technique are the sentiment indices and the “inputs” can be any quantitative indicators known or hypothesized to have a causal relationship with the sentiment indices of the areas of interest within the collection. The consumer can then view, or obtain reports containing, the standard statistics generated by the DEA technique to assess the behavior of the indices of the peer constituents within the collection relative to one another.

In some specific applications of the invention, the areas of interest may be economic entities such as corporations and the sentiment indices may relate to measures in domains including, yet not limited to, anti-competitive behavior; business model; data security & privacy; leadership/governance; product innovation/integrity; environmental responsibility that includes environmental atmosphere, environmental land, and environmental water; human capital topics such as employee responsibility/workplace; marketing practices; political influence; product integrity & innovation; social responsibility/impact; supply chain; sustainable energy use & production; and/or custom categories such as economic sustainability.

Anti-competitive behavior may focus on firms' use of anti-competitive practices to prevent or restrict competition. This may include, but is not limited to, predatory pricing, transfer pricing, price fixing, geographic monopolies and dividing territories, dumping, exclusive dealing, and bid rigging. Business model may focus on firms' development of strategies to create and deliver value in the short-term and/or the long-term, minimize or mitigate systemic risks and negative externalities as relevant, and avoid controversial business practices. Data security & privacy may focus on firms' data security practices and policies, as well as on its privacy policies and practices related to customer data.

Environmental atmosphere may focus on all environmental impacts on the atmosphere at the local and/or global levels, such as greenhouse gases, climate change, mercury, and/or other emissions. Environmental land may focus on environmental impacts on land, such as biodiversity, deforestation, solid waste disposal, soil pollution, land degradation, and rehabilitation. Environmental water may focus on environmental impacts of water resources, such as waste water, water pollution, aqua bio-diversity, and water efficiency.

Governance may focus on a firm's relation of top management and the board to its stockowners and key stakeholders. Considerations may include ownership structure, voting and proxy processes, board structure and tenure, ethical business practices, and executive compensation arrangements. Governance may exclude dividend reporting. Human capital may focus on the treatment of both unionized and non-union employees according to generally accepted international fair labor standards. Relevant issues may include employee retention, education and training, health and safety, compensation and benefits, as well as diversity and mentoring programs. Marketing practices may focus on information accuracy and completeness, transparent labeling, appropriate marketing channels, and the incorporation of social and environmental considerations as appropriate.

Political influence may focus on firms' lobbying practices and attempts at regulatory capture, as well as undue influence to the degree that these activities may undermine the ability of the political structure and governmental agencies to serve the public interest. Product integrity & innovation may focus on the quality and innovativeness of products and service, as well as the research and development of products in the pipeline. Product integrity & innovation may also include the management of packaging and disposal over the product's life cycle. Social impact may focus on recognized international human rights standards, impact on relationships with relevant communities and key stakeholders as well as philanthropy and charity.

Supply chain may focus on firms' logistical organization and coordination with its suppliers, including social and environmental conditions and impacts. Supply chain may also include adherence to supply chain labor standards, sourcing controversial raw materials, and adherence to or development of industry best practices. Sustainable energy use & production may focus on firms' use and production of sustainable energy forms, including those that minimize negative externalities, such as wind and solar power. It may also include how efficiently firms use energy inputs. Custom categories may be used to create data categories and weighting systems according to user specifications.

In such application, comparative metrics may be computed among indices of constituents of a collection of areas of interest, relative to other constituents within the same collection, by applying the DEA sets the “outputs” technique as the sentiment indices and the “inputs” can be any quantitative indicators known or hypothesized to have a causal relationship with the sentiment indices of the areas of interest within the collection, including, but not limited to, standard economic and financial metrics related to the economic entity, such as return on assets (ROA), return on investment (ROI), and EVA (economic valued added). The consumer can then view, or obtain reports containing, the standard statistics generated by the DEA technique to assess the level of “efficiency” with which economic inputs were deployed to achieve the sentiment levels corresponding to the sentiment domains described above.

### Temporal Metrics and Instrumentation

A preferable embodiment of the invention enables the consumer of sentiment indices, generated within the capabilities of the invention, to additionally consume information articulating the behavior of the indices over time as described below.

### Moving Averages

To depict aggregate temporal behavior of the index over selectable windows of time, a preferable embodiment of the invention enables the consumer to view a curve representing the moving average of the index over time. A skilled artisan can appreciate the use of known mathematical techniques for computing the simple moving average, the cumulative moving average, the weighted moving average, and the exponential moving average. Any or all these are applicable in displaying moving average behavior of a sentiment index to a consumer in conjunction with the temporal behavior of the sentiment index itself.

### Aggregate Statistics and Constituent Peer Comparisons Over Time

To depict temporal behavior of collections of indices over selectable windows of time, a preferable embodiment of the invention enables the consumer to view curves representing any or all aggregate statistics and constituent peer comparisons as functions of time. Graphical representations may show peer-to-peer comparisons, peer-to-groups of peer comparisons, groups of peers-to-groups of peers comparisons, peer-to-entire aggregation comparisons, or groups of peers-to-entire aggregation comparisons.

### Trends

To further depict aggregate temporal behavior of the index over selectable windows of time, a preferable embodiment of the invention enables the consumer to view a curve representing a mathematically fit trend. A skilled artisan can appreciate the use of known mathematical techniques for computing polynomial fit curves of selectable degree, periodic fit curves, and exponential fit curves. Any or all these are applicable in displaying trending behavior of a sentiment index to a consumer in conjunction with the temporal behavior of the sentiment index itself.

### Alerts

To further inform temporal behavior of the index, or any derivative function of time of an index or indices, over selectable windows of time, a preferable embodiment of the invention enables the consumer to view, or receive remotely, alerts indicating index changes within fixed, moving, or dynamically expandable windows of time triggered by fixed, moving, or dynamically expandable thresholds, keyed from the start of the time window, by most recent time the threshold is exceeded, or any combination thereof. Such alerts may be delivered to the consumer by any known route (e.g. email, text message, pop-up, phone call, or through a mobile application. The consumer may define how they consumer wishes to receive the alert. The consumer may define which alerts the consumer wishes to receive, and/or thresholds for providing alerts. The consumer may define the time window, such as a start and/or end time for the time window.

### Trend Confidence Metric

For a given trend as described above, to provide an indication that the trend will continue into the future with its current parameters, enabling predictability, an embodiment of the invention enables the consumer to obtain a figure of merit indicating the confidence that the trend will continue. Such an indicator may make use of metrics known in the art as goodness of fit. A confidence figure can be computed as follows:
The root mean square error (RMSE) over a time range of interest between the actual sentiment index time series data and a trend curve may be computed.
The resultant RMSE can then be embedded within other formulae to represent it in a desired scale and amplification suitable for graphical display in conjunction with the sentiment index itself. This computation can then be computed over the entire range of interest to trace a curve of confidence to be displayed in conjunction with the sentiment index itself. An example of such a formula is as follows:
   Trend Confidence=A×(B−C×RMSE/100-D)
   where A=10
   where B=1
   where C=10
   where D=0.9

In alternate implementations, other numerical values may be provided for A, B, C, and/or D.

In a further refinement of this metric, within an alternative embodiment of the invention, a predictive period of time, dt, may be selected by the consumer, in addition to a prior fit period of time T. A trend calculation can then be performed as described above for a selected fit type to generate the fit parameters that can then extend the curve beyond the fit period T by the selected predictive period dt. Error calculations may then be performed between the predicted curve and the actual data over the interval dt and the confidence figure may be computed for that range, rather than the fit range as described above.

### Sentiment Index Correlation and Trend Applicability to Forecasting

To provide the ability to forecast an index characterizing the area of interest, a correlation calculation between the sentiment index and the index characterizing the area of interest can be performed and extrapolated to estimate a forecasted value of the index characterizing the area of interest. A skilled artisan can appreciate the use of known mathematical techniques for computing correlated trends that are extrapolatable into the future to obtain estimates of future values, at chosen durations into the future, of one or all of the correlated variables. A preferable embodiment of conducting such a calculation is the use of neural networking algorithms, using time sequences of multiple indices to train the network and then applying the trained network to forecast future values of the indices.

A further preferable embodiment of the invention teaches the forecasting temporal correlation of sentiment indices. In some examples, real-time sustainability data may be of a comparable nature to stock price performance. Additionally, real-time sustainability data may be an ideal leading indicator of associated stock price performances or other frequent financial measures due to the high-frequency nature of the real-time sustainability data. In some examples, the forecasting temporal correlation of sentiment indices may be used in areas of interest relating to corporate behavior, with rapidly changing conventional financial indicators including, but not limited to, stock price, related derivative indicators, index volatility, company volatility, and other rapidly changing known financial indicators.

### Observer Concentration Metric

To provide an assessment of the crowd strength data quality of a particular sentiment index, an embodiment of the invention enables the consumer to query a metric indicating the concentration of observers of various observer classes convolved with the recentness or “freshness” of the observer sentiment. One or more of the following steps may be implemented to compute such a metric:
Receive the start and stop date/times for the range of interest as input from the consumer.
Retrieve weighting factors to be applied to each class of observer from an internal database. There may be a one-to-one mapping between weights and observer classes.
Retrieve the freshness decay rate from the database. This may be a number that will exponentially decay the shelf life of a particular observation over time using a formula below, similar to that of compounded interest (but in reverse). Thus, a more recent observation may be accorded greater weight.
Retrieve the freshness de-compounding period from persistent data storage. In embodiments of the invention where observable informative items are news items, an exemplary decompounding period would be one day, as that is the nominal news cycle that would suggest a canonical refresh period. Any other time periods may be provided for decompounding periods, such as 1 year, 1 quarter, 1 month, several weeks, 1 week, several days, 1 day, several hours, 1 hour, 30 minutes, or 10 minutes.
From the start date/time to the stop date/time, compute a weighted sum of all counts of observations, within each de-compounding period distributed between the start date/time and the stop date/time, over all observer classes, each with its associated weight. The result of this step may be a partial sum of weighted components for each de-compounding period subdividing the time range between the start date/time and the stop date/time.
Apply to each of those partial sums an additional freshness factor weight. The freshness factor is computed as f=(1−r)\hat{ }n, where r may be the freshness decay rate and n may be the number of freshness de-compounding periods within the time interval between the time of the observation and the stop date/time. The result of this step will be partial sums multiplied by their appropriate freshness factor.
Sum all such partial sums to obtain the current sum value for entity of interest.
Retrieve the global maximum of this same sum (obtained by applying this same weighted sum method on all entities and storing the maximum value found).
Divide the sum by the global maximum to obtain the normalized Observer Concentration Metric and express as a percentage.
Compute this quantity for points in time between the start date/time and the stop date/time at a desired time resolution and plot as a curve accompanying the sentiment index itself.

To refine the value of the freshness decay rate, an algorithm may be employed that may sample the pool of observation data to characterize a canonical rate of change as follows:
At a sampling rate equal to the freshness de-compounding period, sample all observations determine the average percent change of sentiment value between each sample and the next consecutive one in the time series.
Set this average value as the freshness decay rate.

### Long Term Sentiment Value Accumulation Metric

To reflect the cumulative effects of sentiment over time, a consumer may query a metric indicating the sustainability of the sentiment level over extended periods of time. A preferable embodiment of the invention may implement the following to compute such a metric:
The metric for an entity can increase its value in a period of time, T, by some fixed metric maximum for that period of time, M, if it maintains a constant maximum sentiment value, m, for each sampling period, dt, over the period of time. If the sentiment value, v, varies below this maximum for intervals within the period of time, then the accumulated metric will be lower at the close of the period. In addition, if the sentiment value varies below a set minimum, l, then the contribution to the metric at that sampling point will be negative. The contribution to the metric for a sampling period k may be computed as: c(k)=1+M*dt/T*(v−1)/(m−1). The metric L(k+1) for sample k+1 may then be computed recursively as L(k+1)=c(k)*L(k). Over time, value can accumulate in a compounded way as it would in a financial asset.

### Trend Alerts

To provide an indication that a trend may be changing, or if a trend is deviating from a trend of another index associated with an entity, a consumer may obtain alerts when these triggers are detected. A preferable embodiment of calculating the conditions for such triggers is as follows:
Parameters and Variables:
   T=time window for examining possible trend change
   dV=change slope of a sentiment index linear segment fit
   dS=change slope of a comparable index linear segment fit
   VdS=AbsoluteValue (dV−dS)
   adV=threshold of dTV above which an alert will be signaled
   aVdS=threshold of TVdS above which an alert will be signaled
For the sentiment index curve, a “tail fit” may be applied per the subfunction below to obtain dV
If (dV>=adV)=>an alert may be issued suggesting the sentiment index may be breaking into a new trend
For the comparable index curve, a “tail fit” may be applied per the subfunction below to obtain dS
Compute VdS
If (VdS>=aVdS)=>an alert may be issued suggesting the sentiment index may be leading the comparable index in a new direction, up or down
   Subfunction for computing “tail fit” to a curve:
Given time window T, collect all points on the curve from present time—T to present time
Conduct a linear regression fit of those points (polynomial of degree 1 or just a linear fit—either one works)
Produce the linear parameters of the fit, including the slope

### Volatility Metrics

To provide an assessment of the time series volatility of a particular sentiment index, an embodiment of the invention enables the consumer to query a metric indicating a relative magnitude of index variability over time. An embodiment of the invention can include one or more of the following steps to compute a volatility metric:
Collect a time-ordered series of nodes consisting of value pairs consisting of a time stamp measured to any precision and a corresponding value, which can be a sentiment index. The range of time can be arbitrary (e.g. within one week, one month, one year, etc.)
Apply a fractal dimension determination algorithm known in the art to a time-ordered series of time value pair nodes.
Scale to a preferable or predetermined magnitude range a fractal dimension value measured upon a time-ordered series of time-value pair nodes.
Interpret a scaled fractal dimension value measured upon a time-ordered series of time-value pair nodes as a volatility index for the values in the nodes, which can be sentiment index values.

Another embodiment of the invention can include one or more of the following steps to compute a volatility metric:
Collect a time-ordered series nodes consisting of value pairs consisting of a time stamp measured to any precision and a corresponding value, which can be a sentiment index.
Measure a length metric of the polygon or curve traced out by a time-ordered series of time value pair nodes.
Compute the two-dimensional bounding box, known in the art, of a time-ordered series of time value pair nodes.
Compute the diagonal of a two-dimensional bounding box, known in the art, of a time-ordered series of time value pair nodes.
Divide the a length metric of the polygon or curve traced out by a time-ordered series of time value pair nodes by the diagonal of a two-dimensional bounding box, of a time-ordered series of time value pair node.
Scale to a preferable or predetermined magnitude range the quotient obtained by dividing the a length metric of the polygon or curve traced out by a time-ordered series of time value pair nodes by the diagonal of a two-dimensional bounding box, known in the art, of a time-ordered series of time value pair nodes and interpret as a volatility index for the values in the nodes, which can be sentiment index values.

A third embodiment of the invention can include one or more of the following steps to compute a volatility metric:
Collect a time-ordered series nodes consisting of value pairs consisting of a time stamp measured to any precision and a corresponding value, which can be a sentiment index.
Compute the standard deviation of the value coordinates in the above collection.
Compute the mean of the value coordinates in the above collection.
Divide the above computed standard deviation by the above computed mean and set the result as the measurement of volatility.

### Volatility Metric Correlations

To provide an assessment of the relationship of a time series volatility of a particular sentiment index and a published time series indicating volatility obtained by means outside the scope of this invention, yet of additional interest to observers, an embodiment of the invention may enable the consumer to query correlation metrics indicating a strength of relationships between the volatility metrics computed by the invention and external indices of interest. Correlations of this kind can be obtained using statistical correlation methods known in the art and providing the results of such analyses to the consumer. An embodiment of the invention can correlate stock price action beta metrics with volatility indices computed by the invention.

### Machine Interfaces

A machine interface may be provided through which sentiment feedback information including indices, metrics, statistics, instrumentation, and/or alerts regarding an entity may be consumed through programmable machine interfaces through standard computer/machine communication media, connections, and/or networks. The entity may be a company, corporation, partnership, venture, individual, organization, or business. In a preferable embodiment, the machine interface can further modify the mathematical presentation of the sentiment feedback information, including, but not limited to applying filters and/or numerical weights related to entity information sources, entity categories, aggregate collections of entities.

In an additional preferred embodiment, a machine interface may be provided through which areas of interest, entities, categories, and/or entity information items and sources can be specified from which sentiment feedback information and all derivative outputs described within this invention can be produced.

### User Interface

A user interface may be provided through which observer feedback may be solicited regarding an entity. The observer may also be able to view a score indicative of the value of the entity. The entity may be a company, corporation, partnership, venture, individual, organization, or business. In one example, the entity may be a publicly traded company. Alternatively, the entity may be a private company. The score may be a numerical value representative of the value of the company. Value may refer to crowd-based sentiment, performance, financial value, or any other index.

In some implementations, entity articles may be displayed on a user interface subject to observer preferences, the significance of the article, or related entity. The entity articles may be provided by the entity, or may be about the entity.

Presentation variations on a user interface may relate to the speed/cycle of an update, size of display area dedicated to the information (e.g., tile size), highlighting, and/or other visual cues.

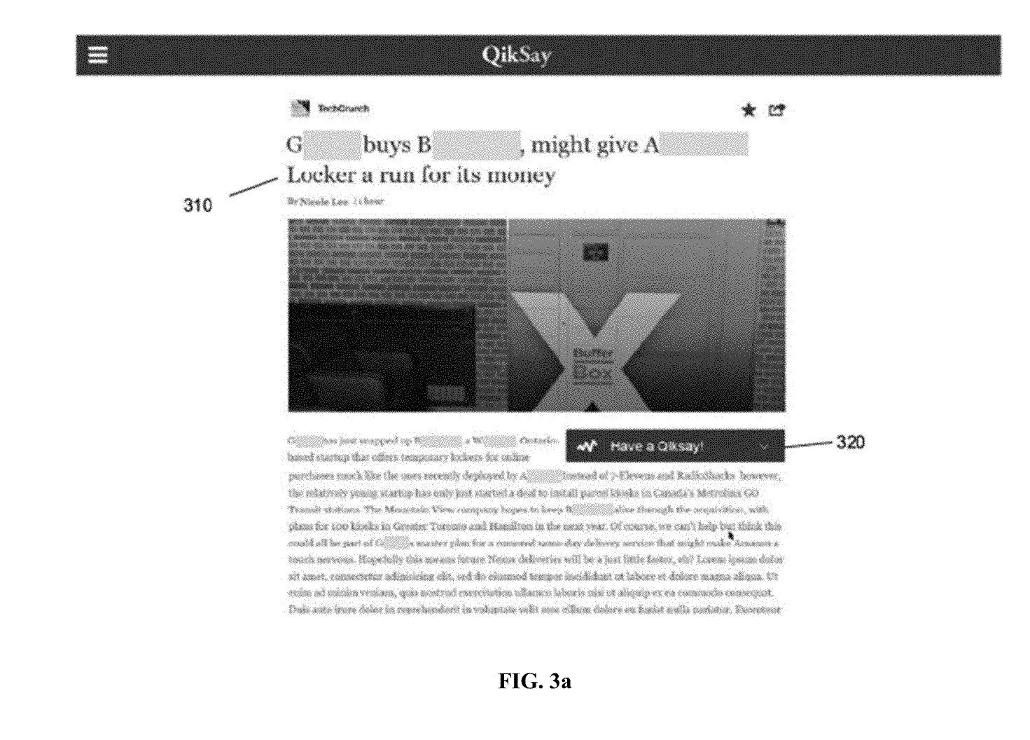

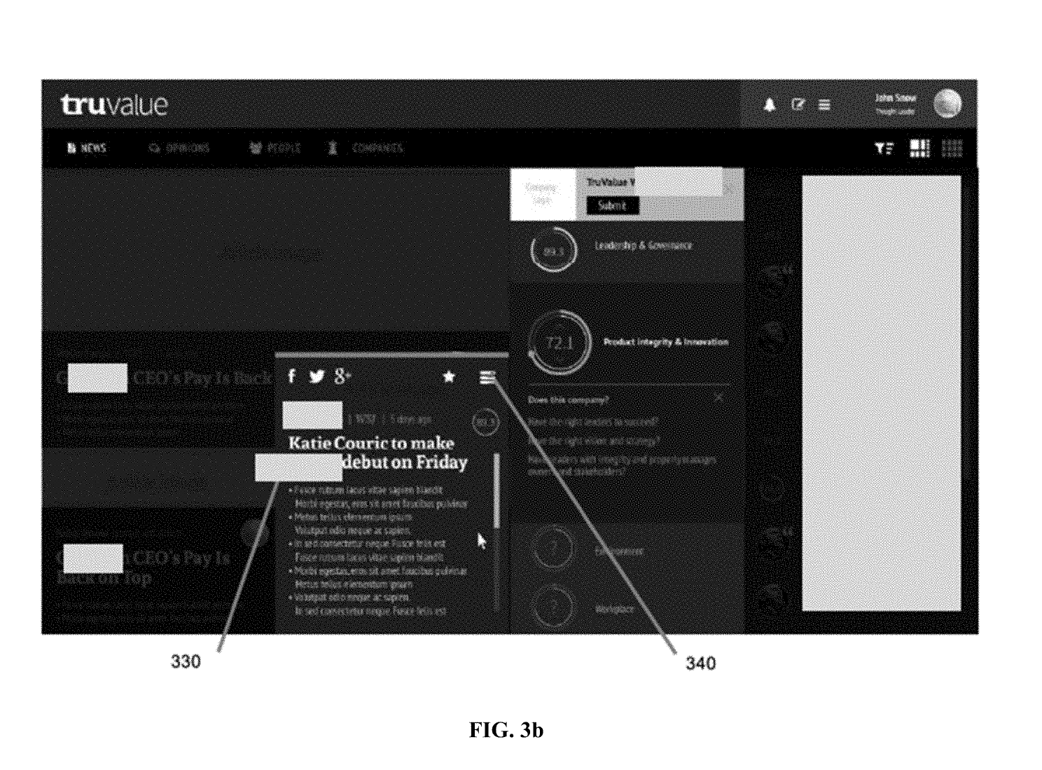

FIG. 3a and FIG. 3b show examples of user interfaces through which an observer may select an option to provide sentiment feedback relating to an entity, in accordance with an embodiment of the invention. In some embodiments, the user interface may show information 310, 330 about the entity. For example, the information may be an article, news, financial tracker, tweet, posting, blog, or any other information relating to the entity.

In some embodiments, the user interface may also include a region 320, 340 through which the observer may select the option to provide feedback. The feedback region may be implemented as a widget, may be displayed on a browser or application, or may be implemented in any other fashion. In some instances, the feedback region may be presented as a button, pop-up, drop-down menu, pane, or any other user interactive region.

Information about the entity 310, 330 and the region through which the observer may provide feedback 320, 340 may be simultaneously displayed. The user may provide feedback about the displayed entity via the region.

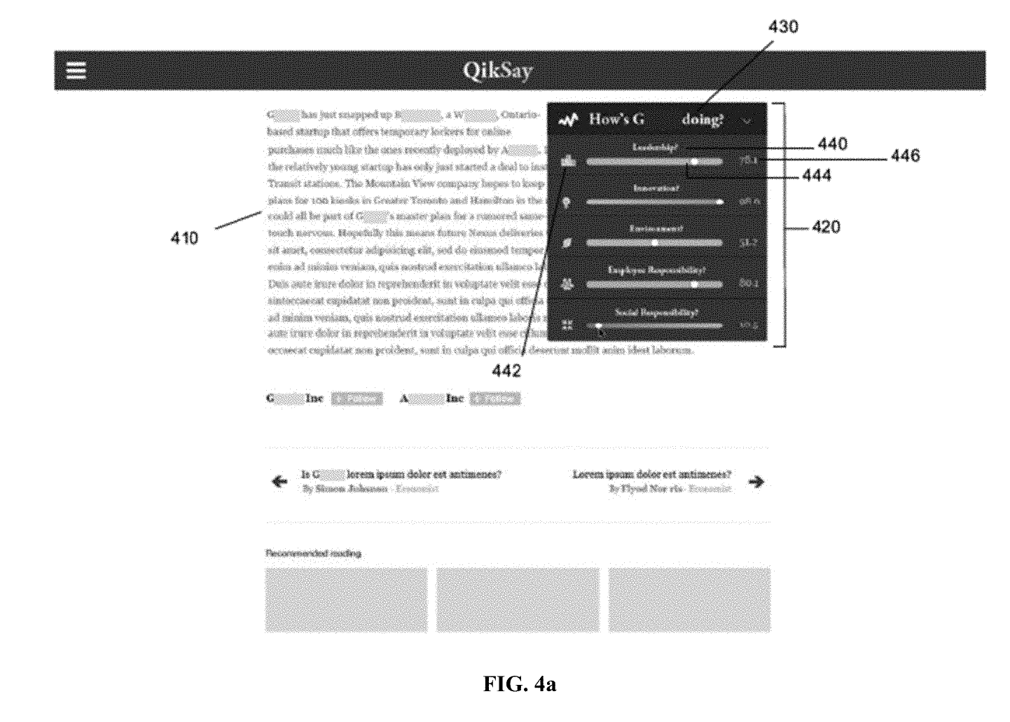

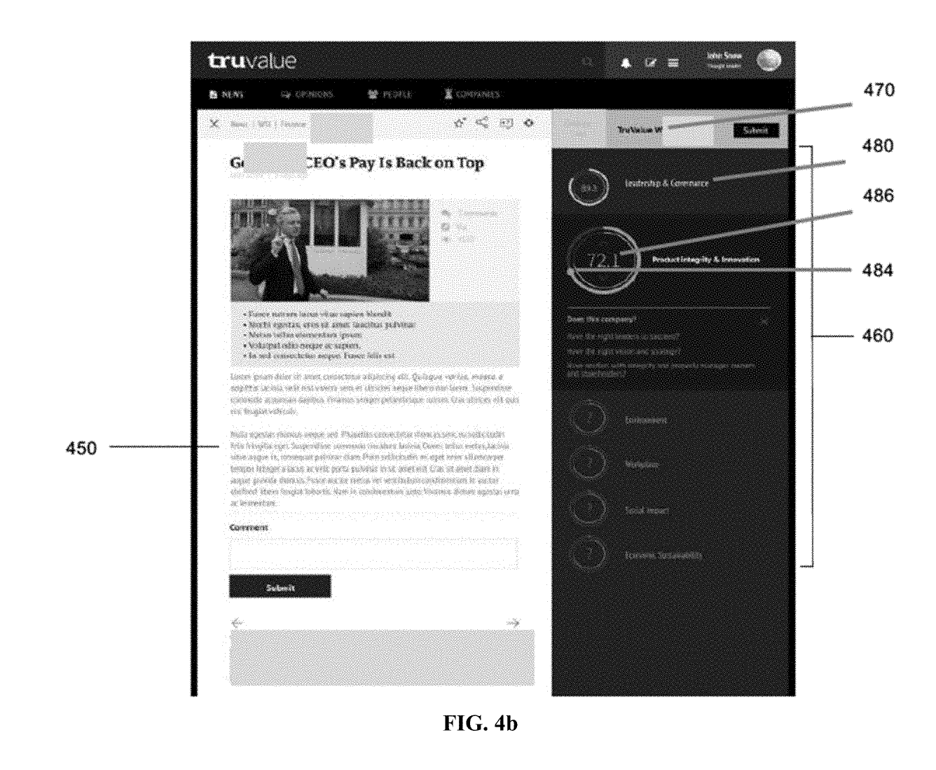

FIG. 4a and FIG. 4b shows examples of user interfaces through which an observer may provide feedback in response to one or more questions. Information 410, 450 about the entity may be displayed. A feedback region 420, 460 may be displayed through which the observer may provide feedback.

The feedback region 420, 460 may include a general query 430, 470. The general query may relate to the value of the entity. For example, the general query may ask how the entity is performing overall. Entity performance can be determined according to different categories or metrics. One or more specific queries 440, 480 may also be displayed. The specific queries may relate to one or more different categories or metrics relating to the general query. For example, if the general query asks how an entity is performing, the specific queries may relate to different areas or categories of how the entity is doing. For example, the specific categories may include, yet may not be limited to, leadership/governance, product innovation/integrity, environmental responsibility, employee responsibility/workplace, social responsibility/impact, and/or economic sustainability. In some instances, five distinct categories may be provided. In alternative embodiments, one, two, three, four, five, six, seven, eight, nine, ten, or more categories may be provided in order to assess entity value or performance.

In some instances, the feedback region 420, 460 may include a visual representation 442 of each category for the specific queries 440, 480. For example, the visual representation may be an icon or picture (or tool tip or helper text) representative of categories, such as leadership, innovation, environmental responsibility, employee responsibility, social responsibility and/or economic sustainability. Such visual representation may create a broader idea of specific category.

One or more interactive tool may be provided through which the observer may provide feedback. For example, as shown in FIG. 4a, a linear slider bar 444 may be provided through which the observer may select where the entity falls in the spectrum from each category. For example, the observer may select where along the spectrum of leadership, innovation, environment, employee responsibility, and/or social responsibility the entity falls, and may adjust the placement of the slider bar accordingly. In another example, as shown in FIG. 4b a circular slider bar 484 may be provided that may function in a similar manner to the linear slider bar. The circular loop may permit an observer to select where the entity falls in the spectrum from each category. The observer may select a position along the circumference of the loop correlating to where the entity falls within each category. The selected position may slide about the circumference of the loop. The slider bar (e.g., the linear slider bar, the circular slider bar) may be an example of a gradient feedback tool.

The interactive tool may permit the observer to easily and simply provide feedback. For example, the observer may provide feedback without having to type in any letters, words, or numbers. The observer may drag a visual indicator into a desired position, or click or touch a desired option. In an alternative to a slider bar, one or more options may be provided that the user may select. Such tools may make it easier to quickly allow an individual to express his or her opinion. An individual may express an opinion with a single click, touch, or drag.

In some instances, category values 446, 486 may be displayed in the feedback region. For example, each category may have a category value reflecting a numerical value for each category. The numeral value may correspond to the placement of the slider on the slider bar 444 or circular bar 484. For example, moving a slider along a linear slider bar 444 to the right may increase the numerical value, and moving the slider to the left may decrease the numerical value. The category value 446 may be provided in the same row or column as the linear slider bar and may be adjacent to the slider bar. In another example, moving a slider about a loop in a clockwise direction relative to a top position or other starting position in a circular bar 484 may increase the numerical value, and moving the slider value closer to the starting position may decrease the numerical value. The category value 486 may be positioned within the loop and/or may be circumscribed by the circular bar.

In one example, the numerical value for each category may fall between 0 and 100. The numerical value may be adjacent to the slider bar or within a circular bar. In one example, an entity, such as a company, may receive numerical scores for categories such as leadership, employee responsibility, anti-competitive behavior, business model, data security, data privacy, environment, corporate governance, human capital, marketing practices, political influence, product integrity, product innovation, social impact, supply chain, sustainable energy use, and sustainable energy production.

In some instances, the placement of the slider on the slider bar may also be associated with a color scheme, representing emotional attachment to the related category. For example, the color scheme may reach from red representing disagreement to green representing agreement. In some instances, red (or another selected color) may correspond to a lower numerical value while green (or another selected color) may correspond to a higher numerical value. A gradient of colors between the selected colors may be provided corresponding to slider position along the slider bar and/or numerical value scale.

In some instances, a default value may be provided on the gradient feedback tool 444, 484. For example, if the user does not provide any feedback, the value may default to midway on a slider bar or circular bar. The numerical category scores 446, 486 may correspondingly have a default value. For example, the numerical category score may default to 50 out of 100, or 5 out of 10, or any other value.

In some embodiments a feedback region 420, 460 may have an expanded form and a contracted form. For example, when the observer selects an option to provide feedback for the entity, the region may expand to display the various categories for which the observer may provide feedback. The feedback region may remain in the same user interface that simultaneously displays the information about the entity 410, 450.

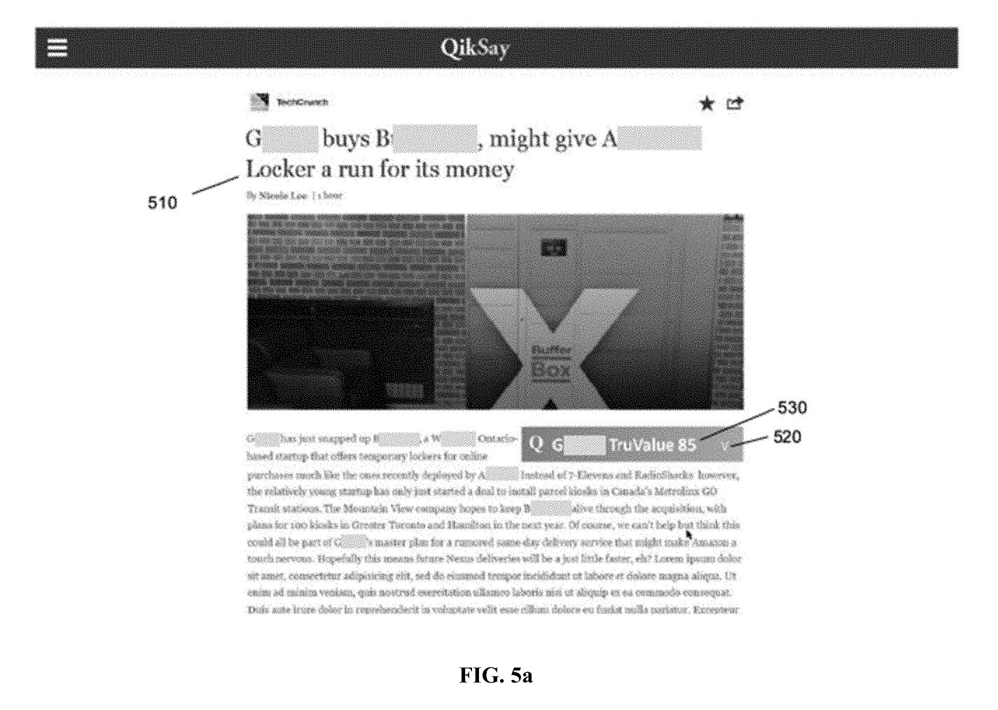

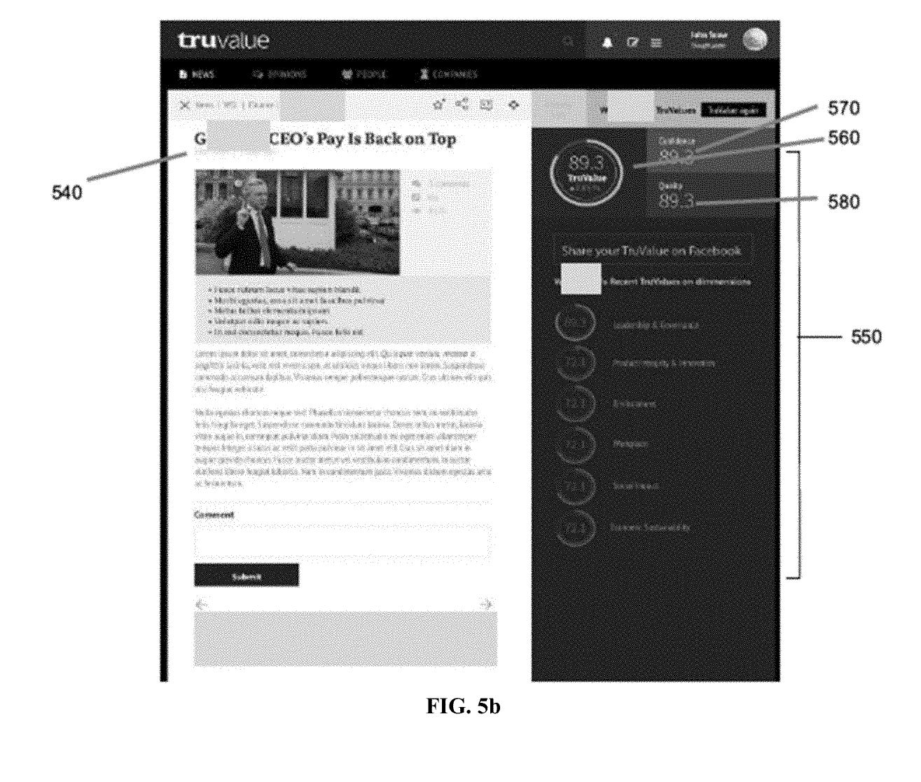

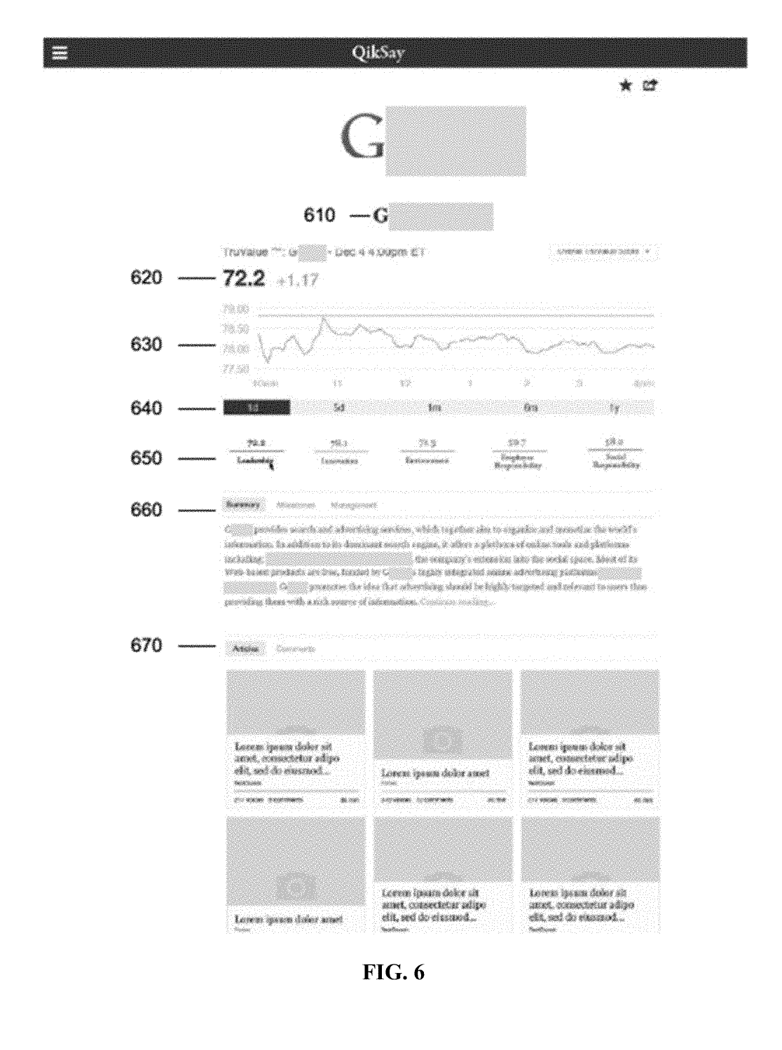

FIG. 5a and FIG. 5b show examples of user interfaces showing a score indicative of the value of the entity. The user interface may show information about the entity 510, 540 and a feedback region 520, 550. The feedback region may show the score, which may be a numerical score 530, 560 indicative of the overall value of the entity. As previously described, the value may relate to crowd-based sentiment, performance, financial value, or any other index. The score may be a crowd-based sentiment index for the entity overall. The score may reflect a ‘true value’ of the entity.

In some embodiments, the entity value score may be calculated using any of the systems and methods described elsewhere herein. In one example, the entity value score may incorporate category scores from one, two or more categories. For example, the entity value score may be calculated based on scores for: leadership, employee responsibility, anti-competitive behavior, business model, data security, data privacy, environment, corporate governance, human capital, marketing practices, political influence, product integrity, product innovation, social impact, supply chain, sustainable energy use, and sustainable energy production. The categories may be ESG categories. In some instances six or fewer, or five or fewer categories may be provided. In other instances, higher counts of categories may be provided. The overall entity value score may be an average of the various category scores.

In some implementations, the overall entity value score may be a weighted average of the various category scores. For example, category score A may have a weight of 5, category score B may have a weight of 2, category score C may have a weight of 2, and category score D may have a weight of 1. The overall entity value score may be 5×(average category score A)+2×(average category score B)+2×(average category score C)+(average category score D). The weights may be selected based on one or more different characteristics (e.g., sector, company focus, industry, current buzz, or other areas). For example, category A may be deemed to be more relevant in certain industries, and may receive a higher weight. In another example, category A may be deemed to relate to a topic that has been receiving a large amount of press attention recently, and may receive a higher weight. The weights may be determined by an observer, administrator, or may be automatically generated with aid of a processor. The weights may be established in accordance with an algorithm with aid of the processor.

The various category scores may include scores inputted by the observer that is viewing the overall entity value score. The various category scores may incorporate scores inputted by other observers than the observer viewing the entity value score. The category scores may be updated in real-time, or with a high level of frequency. The overall entity value score may also be updated in real-time or with a high level of frequency. For example, the various scores may be updated every millisecond, every few milliseconds, every second, every few seconds, every half minute, every minute, every few minutes, every half hour, or every hour. The scores may be reflective of crowd-based sentiment and may be gathered from multiple observers. Multiple observers may provide feedback via a feedback region of their respective user interfaces. In some instances, the feedback from each of the observers may be weighted equally. Alternatively, observers with different backgrounds or qualifications may have their feedback weighted differently. For example, observers who are experts in a particular field may have their feedback relating to that field weighted higher than observers who are not experts.

In some embodiments, in addition to the numerical score 530, 560, the feedback region may have additional visual indicators of the entity true value. For example, if the entity score is in the higher range, a particular color may be displayed. If the entity is in a lower range, a different color may be displayed. Such visual indicators may make it easy for an observer to determine with a glance the overall determined value for the entity.

In some embodiments, a confidence 570 and/or quality 580 of for the numerical score 560 may be provided. The confidence and/or quality may be calculated using any of the techniques described elsewhere herein. Factors, such as moving averages, trends, trend confidence, observer concentration, freshness, long term sentiment, and/or other factors may be considered. Temporal aspects may be considered in determining the confidence and/or quality of the numerical score. For examples, changes over time, or the recentness of data may be considered. A confidence value 570 may be indicative of a confidence that a trend will continue. A higher numerical confidence value may correlate to a greater confidence that the trend will continue. A quality value 580 may be indicative of a concentration and/or freshness of observer input. A higher numerical quality value may correlate to greater concentration and/or freshness of observer input.

FIG. 6 shows a display providing information about an entity's overall value score as well as scores for specific categories. In some instances, information about an entity's value may be displayed in a user interface. The user interface may show an entity summary page.

The entity name 610 may be presented on the user interface. The entity's overall value score 620 may be displayed as a numerical value. In some instances, a stock market index value 630 for the entity may be displayed.

Information about the entity may be displayed over a window of time. A time selection option 640 may be provided through which an observer may be able to select a window of time from a plurality of options. For example, the windows of time may include 1 day, five days, 1 month, 6 months, or a year. The value and/or index information may be updated to reflect the selected time window.

The displays may accommodate differing scales of heterogeneous quantities, which may enable an observer to visually correlate relationships. For example, a stock price may be displayed simultaneously with a total and/or category score.

The user interface may also display various category scores 650 for the entity. For example, numerical values for different categories, such as leadership, employee responsibility, anti-competitive behavior, business model, data security, data privacy, environment, corporate governance, human capital, marketing practices, political influence, product integrity, product innovation, social impact, supply chain, sustainable energy use, and sustainable energy production may be displayed. The various category scores may be used in calculating the entity's overall value score 620. In some instances, an observer may be able to select a category score to receive additional information about the category or the entity's performance within the category.

In some embodiments, an observer, administrator, or other user may be able to specify which categories to use to specify the overall value score. The overall value score may be personalized to an individual user's needs or desires. For example, if a user does not believe that an innovation score should be a factor of the overall value score, then the user can have the overall value score calculated without factoring in innovation. The user may select one or more categories from a predetermined list of categories. Alternatively, a user may be able to submit a category of the user's own. The categories may be dynamically updated or customized. The user may or may not specify any weighting of the categories in generating the overall value score.

Additional information 660 about the entity may be displayed on the user interface. The additional information may include a summary of the entity, milestones, or information about management of the entity.

In some instances, articles 670 about the entity or comments relating to the entity may be displayed. The articles may include visual information, a title of the article, the source of the article, and various feedback information.

### Browser Extension Tool

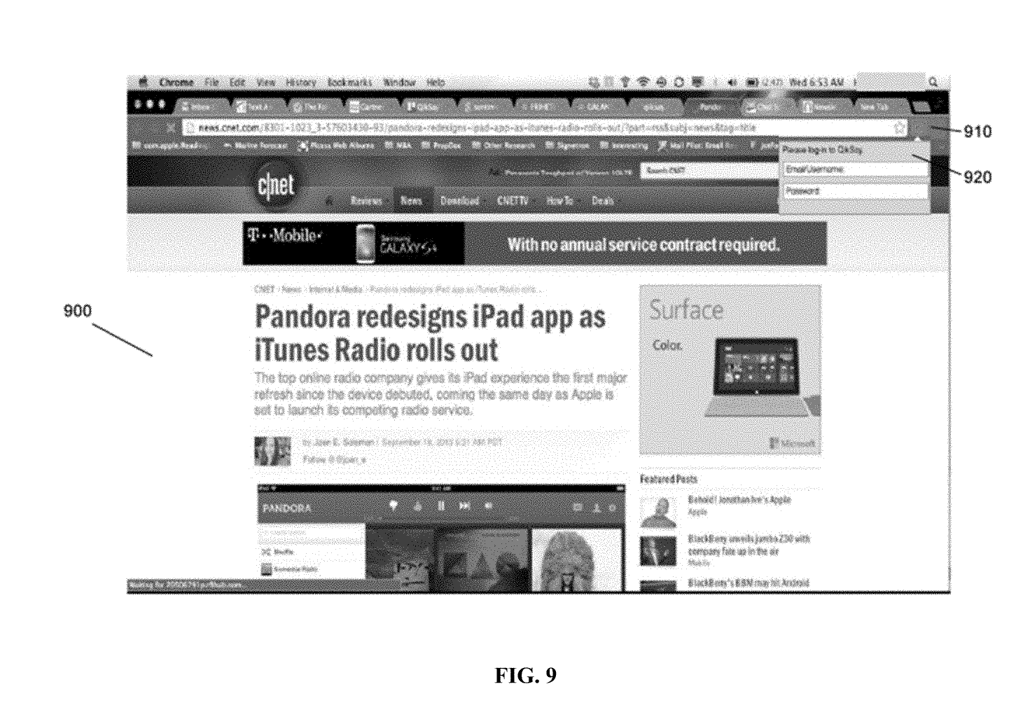

FIG. 9 shows an example of a browser extension tool that may be used to collect user feedback about a web site. The browser extension tool may provide feedback from any website. For instance, the website may be the website of an entity that provides crowd-based sentiment indices or may be a website of a different entity. The browser plug-in can be directly installed in the browser bar (e.g., Safari, Firefox, Explorer, Chrome) and can pull up a voting widget on a button press. This may permit a user to provide feedback anywhere on the Internet. The score, along with the content source of the website, may be submitted to an entity (and/or server thereof) that provides crowd-based sentiment indices. The feedback may be incorporated into an overall index for the source and/or content.

A website 900 may be displayed on a user interface with aid of a browser. A visual representation of the browser extension tool 910 may be provided on the browser environment. Selecting the browser extension tool may provide an option for a user to log in. An authentication interface 920 may be provided for a user to provide the user's identifier (e.g., email, username) and/or password. Alternatively, a user may be pre-logged in, or may not need to be authenticated to access to the browser extension tool.

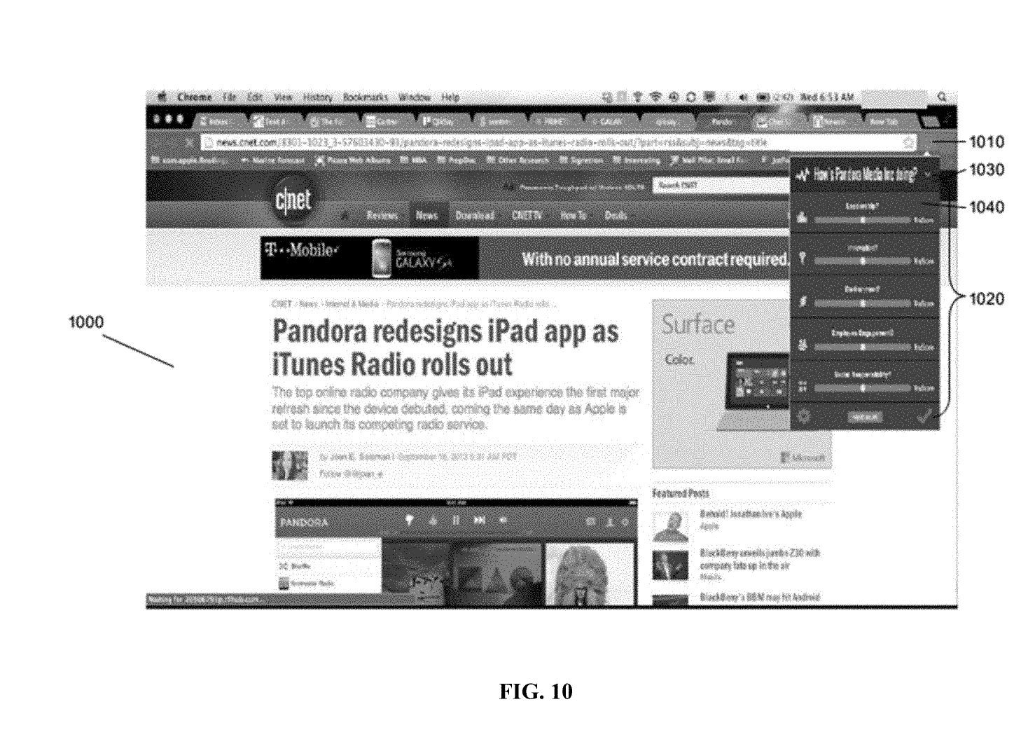

FIG. 10 shows an example of a feedback region implemented using a browser extension tool. Selecting a browser extension tool 1010 may result in a feedback region 1020 being displayed. The feedback region may have one or more characteristics described elsewhere herein. The feedback region may include a general query 1030 and/or one or more specific queries 1040. A user may be able to provide a feedback about the specific queries via the user interface.

In some instances, the feedback region 1020 may overlie a website 1000. In some instances, the website may provide content about an entity. The feedback region may include queries about the entity and/or entity performance. The queries in the feedback region may relate to the content of the website, which may be about the entity, or any other types of content as described elsewhere herein.

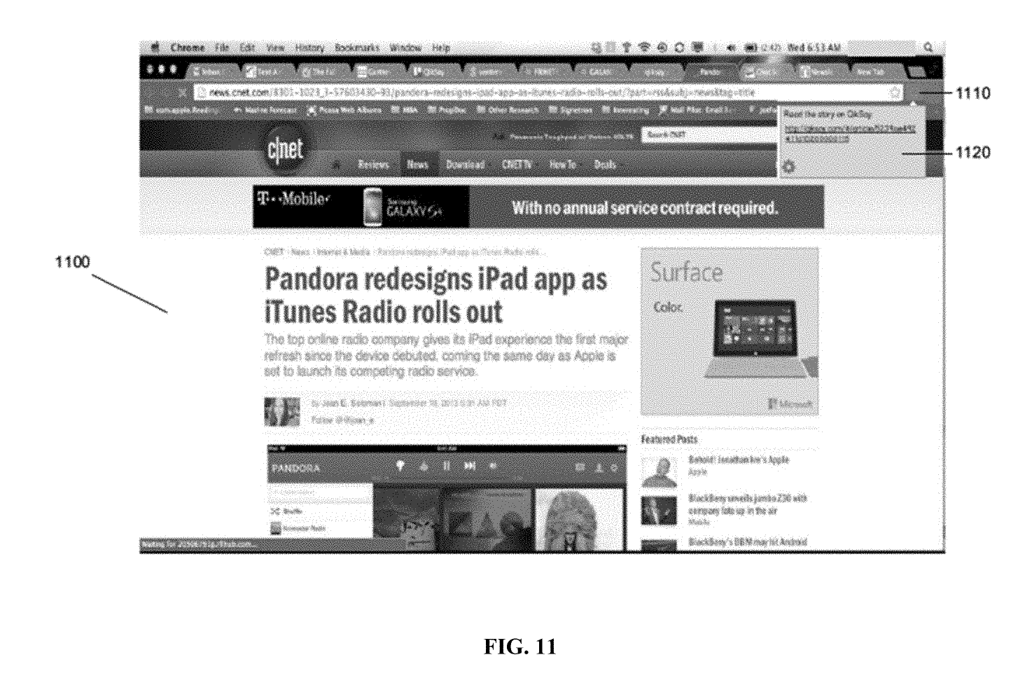

FIG. 11 shows an example of a browser extension tool providing a link to a website of a system for providing crowd-based sentiment indices. For example a website 1100 may be displayed in a browser. A browser extension tool 1110 may be provided through which a user may provide feedback relating to content of the website. In some instances, the browser extension tool may provide a link 1120 to another website through which a user may get more information relating to the content of the website. The other website may be a website of a party that calculates and/or provides crowd-based sentiment indices. If the content of the website 1100 relates to an entity, the other website may provide additional information about the entity, such as an overall value score of the entity, category scores for the entity, financial information relating to the entity, articles relating to the entity, or any other information, including information described elsewhere herein.

### Tools and Widgets

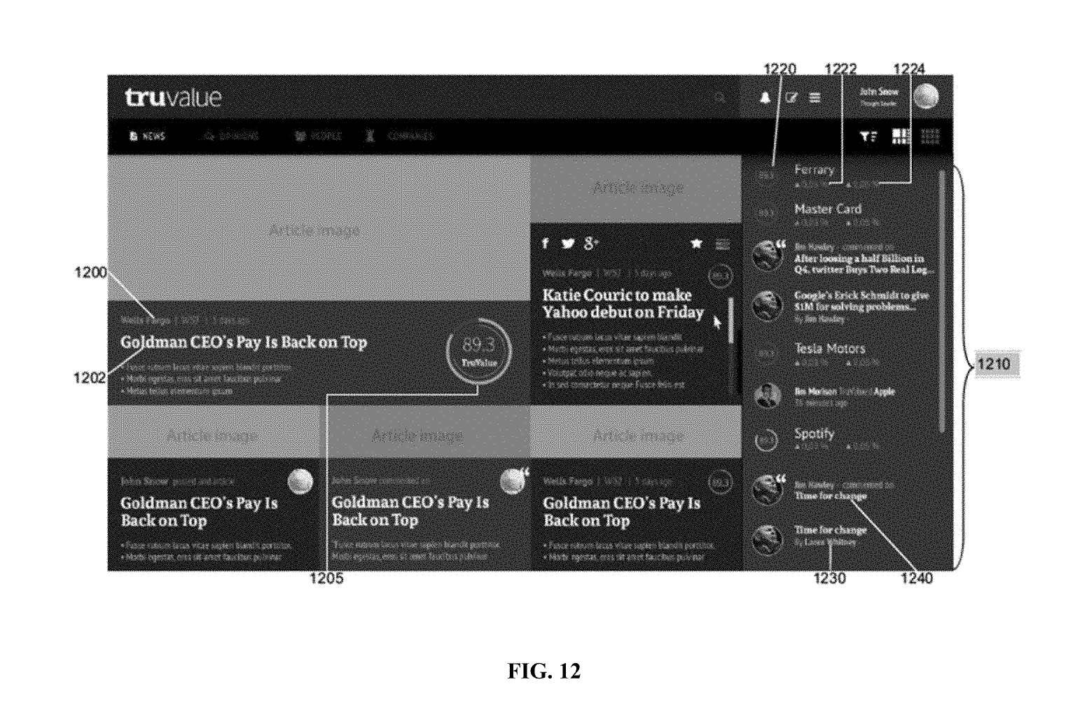

FIG. 12 shows an example of a user interface that displays live updates. General information and/or articles may be displayed 1200. In some instances, the articles may be about one or more companies 1202. The overall value score 1205 for the company may be displayed. In some instances, whenever an article names a company in its headline, an overall value score for the named company may be displayed. The overall value score may be reflective of scores given by multiple users. For example, the overall value score may be a crowd-based sentiment index. In other examples, the overall value score displayed may be reflective of a score provided by a user that is viewing the article.

A live update region 1210 may be displayed. The live update region may be on the left hand side, right hand side, top portion, or bottom portion of the user interface. The live update region may be updated periodically or in real time. The live updates may include information about various companies. For example, the overall value score 1220 of the company may be displayed. Changes to the overall value score of the company may be displayed. The changes may be displayed as numerical score changes 1222 and/or relative percent changes 1224. A visual indicator may be provided whether the changes are positive or negative. The information may scroll through and may be indicative of changes within a given period of time, such as those described elsewhere herein. The changes may reflect real-time changes and/or values.

Other information relating to the companies may be displayed. For example, the appearance of new articles 1230 may be provided. Comments 1240 by other users or individuals to the articles or relating to the company may also be provided. The appearance of the new information may be updated in real time.

The live update region 1210 may be provided so that newer information provided on top or in the front, and older information would scroll downwards or toward the back. As new information is provided, the new information may displace the older information, which may move further down or backwards.

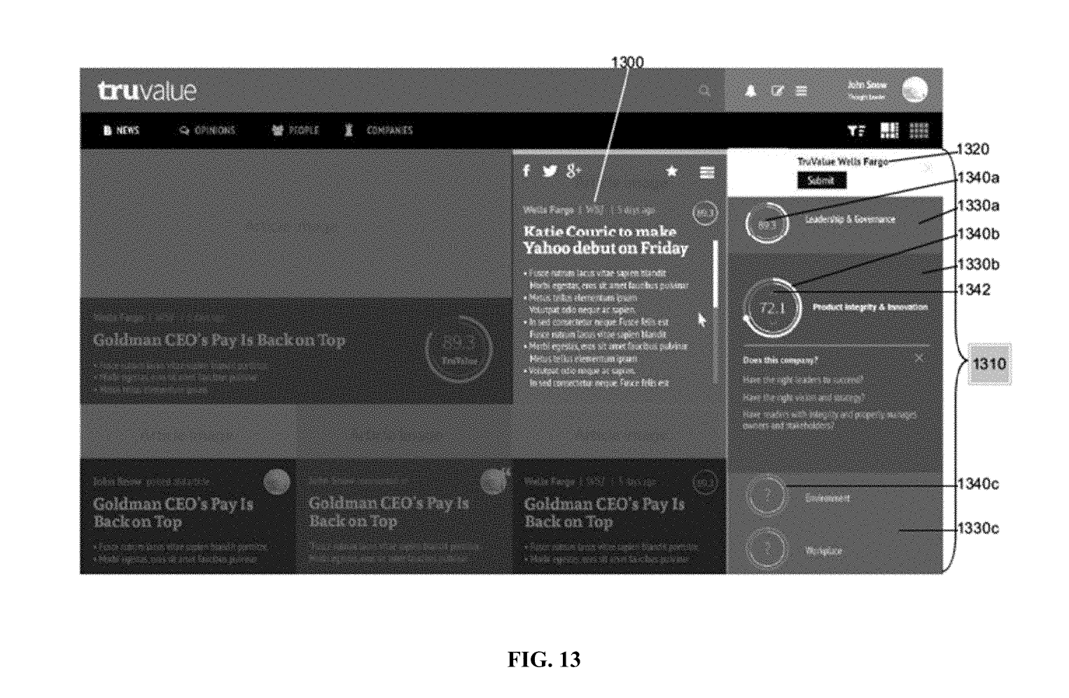

FIG. 13 shows an example of a voting widget. A selected article about a company 1300 or any other type of information relating to a company may be provided. Selecting a company (e.g., by selecting an article about the company) may cause a voting widget 1310 to be displayed. The voting widget may be displayed in any region of the user interface (e.g., left side, right side, top side, bottom side).

The voting widget 1310 may show the company name 1320. One or more categories 1330a, 1330b, 1330c for evaluation may be provided. Examples of such categories may include, but are not limited to, leadership, employee responsibility, anti-competitive behavior, business model, data security, data privacy, environment, corporate governance, human capital, marketing practices, political influence, product integrity, product innovation, social impact, supply chain, sustainable energy use, and sustainable energy production. When a user has already rated a company in a particular category 1330a the user's category score 1340a for the company may be displayed. When a user is in the process of rating a company in a particular category 1330b, the user's category score 1340b may be displayed once the user has entered a value. Optionally a default value may be provided. An expanded view may be provided which may include information or criteria for the user to consider when rating the company. When a user has not yet rated a company in a particular category 1330c, no category score 1340c may be presented. In some instances, a question mark or similar information indicating the category has not yet been rated may be provided.

When a user is rating a company category, a gradient tool, such as a circular bar 1340b may be provided. The user may slide a slider along the circular bar, or any other type of gradient tool. The numerical value may be updated to reflect the position of the slider along the gradient tool. In some examples, arrows 1342 or similar tools may be provided through which the user may manipulate the numerical value directly.

When the user has entered the user's feedback for the various categories, the overall score for the company provided by the user may be shown or displayed. This overall score may be considered in conjunction with overall scores provided by other users to provide a crowd-based sentiment index.

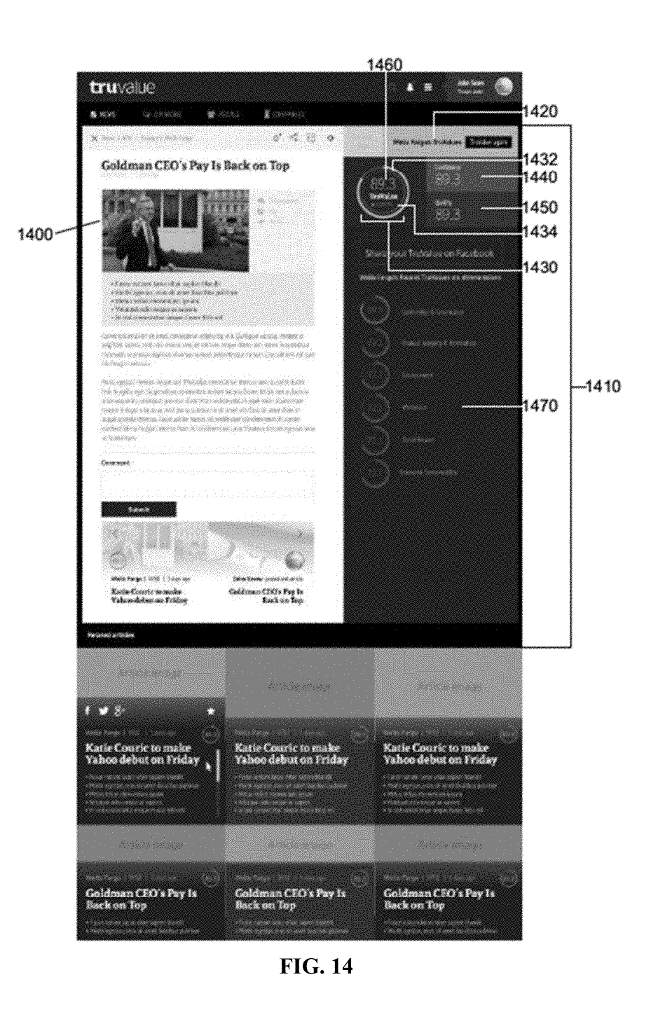

FIG. 14 shows another view of a voting widget 1410 in accordance with an embodiment of the invention. The voting widget may be tied to a company for which information may be displayed 1400. In some instances, the information may be an article about the company.

The voting widget may show the company name 1420. The voting widget may show an overall score for the company 1430. In some embodiments, a confidence 1440 and/or quality value 1450 may also be provided. The overall score may include a double gradient indicator. For example, a double ring voting circle may be shown. An outer ring 1432 may show a current score provided by the user and an inner ring 1434 may show an existing value (e.g., overall value from the combined feedback of other users), or vice versa. The numerical value 1460 displayed for the overall score may be reflective of the current score provided by the outer ring, or the existing value provided by the inner ring. Optionally, comparison value 1465, such as a percent change may be displayed. The percent change may be for the current score relative to the existing value.

The voting widget may show one or more categories 1470. Each of the categories may be representative of a dimension along which the company may be evaluated in determining the overall score. The dimensions may be ESG categories. The overall score may be an ESG rating for the company. The categories may show a score for each of the categories. In some embodiments, each of the category scores may be a double gradient indicator. For example, a double ring may be provided showing the current score for each category as compared to the existing score for the category. Numerical values may also be displayed, which may be reflective of the current category score or the existing category score. A user may be able to manipulate the ring that shows the current score without being able to manipulate the existing score. In some instances, a user may be able to manipulate a slider an on outer ring without being able to manipulate data on an inner ring. The double ring, or double gradient indicator may advantageously provide a simple visual interface through which a user may view how the user's scoring of the company compares to existing scores for the company.

### Ticker

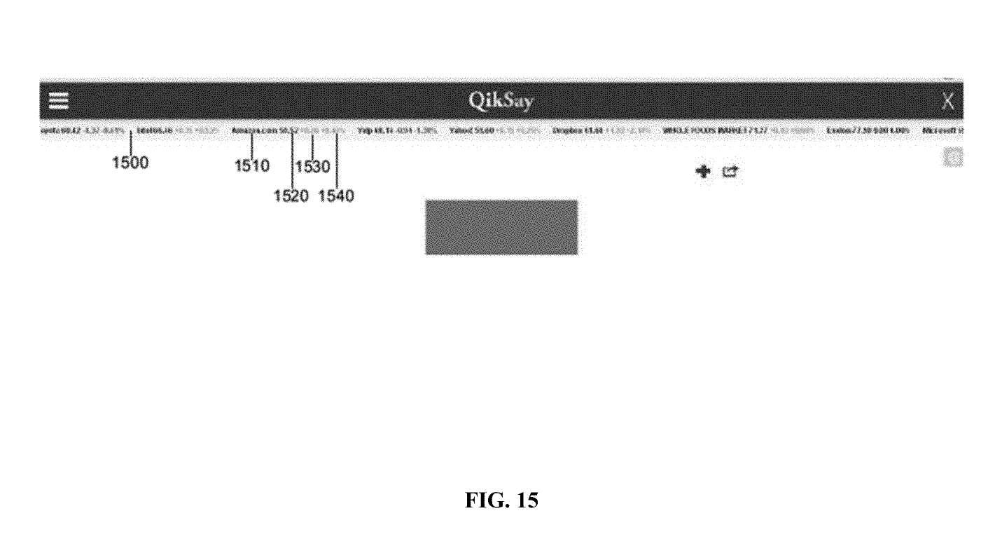

FIG. 15 shows an example of a ticker display 1500 in accordance with an embodiment of the invention. The ticker display may have a format similar to that as applied to stock and other financial data, and may be utilized for displaying real-time changes in sentiment indices.

In some embodiments, the ticker display may show a company name 1510, as well as an overall value score 1520 for the company. The overall value score may be a numerical value. In some instances, the numerical value may fall between 0 and 100 or between any other two numbers. Optionally, changes 1530 in the overall value score may be displayed. The changes in the overall value score may be a numerical change over a period of time. In some examples, the period of time may be since the previous day. Other examples of time periods may include years, 1 year, quarters, months, 1 month, weeks, 1 week, days, 1 day, hours, 1 hour, 30 minutes, 10 minutes, or 1 minute. The relative changes 1540 in the overall value score may also be displayed. The relative change may be displayed as a percentage value. The percentage change may be the difference between the current overall value and the previous overall value divided by the previous overall value (or alternatively divided by the current overall value). The previous overall value may be the overall value score at the previous period of time.

The changes 1530 and/or relative changes 1540 in the overall score may show whether a positive or negative value change has occurred.

The ticker display may be shown as part of a website or other environment. The ticker may include the company names and related information scrolling. The information may scroll across horizontally or vertically. For instance, an entity name and overall value score for multiple entities may scroll in a linear fashion.

### Technical Architecture Overview

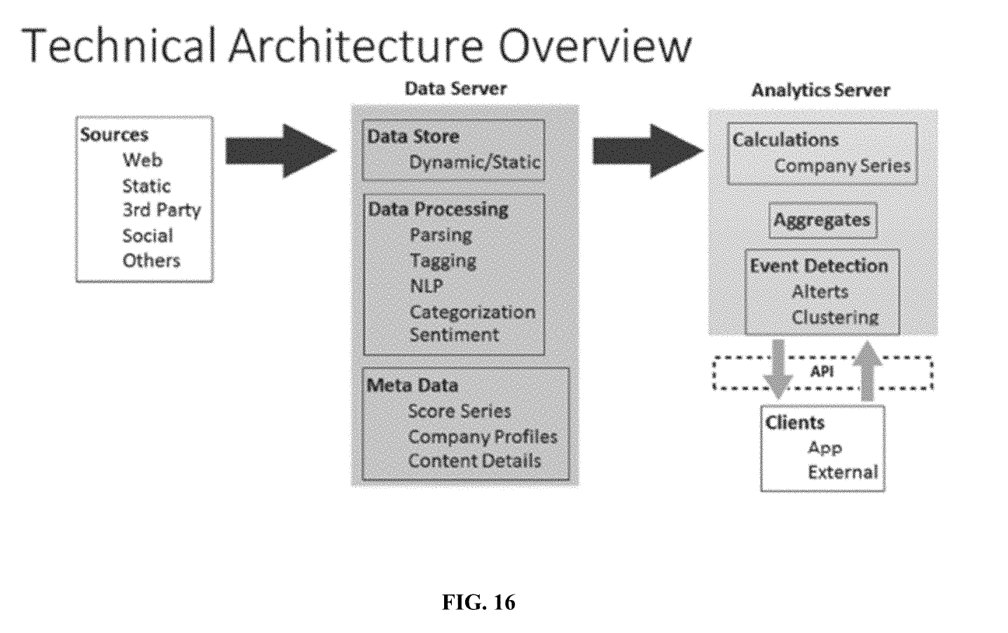

FIG. 16 provides a technical architecture overview in accordance with embodiments of the invention. As seen in FIG. 16, Sources are provided to a Data Server, which then provides information to an Analytics Server. The Analytics Server then interacts with a client through an API. The technical architecture overview as seen in FIG. 16 may be used to implement embodiments of the invention that augment human decision-making by enabling the extraction of meaningful sustainability signals from data sources and generating analytics in real-time.

In some examples, data is aggregated from one or more sources, such as Sources illustrated in FIG. 16. Examples of sources may include web-based sources (such as web pages), static sources, third-party sources, social media sources, organizationally (company) self-reported sources, auditor sources, insurance policy/payout sources, and legal settlement sources, among others. In examples, a wide variety of data sources may be aggregated to bring together a real-time stream of data. In some embodiments, the data may be particularly related to Environmental, Social, and Governance (ESG) topics. In some examples, the number of data sources may be scalable. In some examples, data sources may include both semantic and quantitative content. In some examples, the data may comprise news content, company-issued data, government agency data, and/or reports from industry associations, NGOs, and watchdog organizations.

Data may be provided to a Data Server, such as the Data Server seen in FIG. 16. The Data Store may include a Data Store. A Data Store may be used to store dynamic and/or static data. Additionally, the Data Server may include a Data Processing component. A Data Processing component may include parsing, tagging, natural language processing, categorization, and/or sentiment processes. Additionally, the Data Server may include a Meta Data component. The Meta Data component may include score series, company profiles, and/or content details, such as the definition of fields, timeframes covered, description of the source, potentially funders of the source, and the like.

Incoming data content may be identified and/or categorized based on data type. Additionally, each data point may be contextualized so as to identify, extract, and categorize relevant sustainability content. In examples, content may be classified according to one of a set number of categories. In some examples, data may overlap between two or more categories. In examples, analytics may be provided on particular topics identified as relevant to a particular user by creating custom categories.

Additionally, both structured and unstructured data points may be normalized within each category. In some examples, each data point may be naturally weighted within the system according to its timeliness, frequency, and intensity through a running sum-based average. In some examples, custom materiality lenses can be developed to weight data points to varying degrees according to sustainability topic, sector, and/or data source.

The Analytics Server of the technical architecture overview may include a Calculations component, an Aggregation component, and an Event Detection component. In some examples, sustainability performance analytics may be generated. In particular, a dynamic scorecard may be generated for each monitored company. The analytics may be updated in real-time so as to display sustainability trends. In examples, each data point may be scored independently. Additionally, each data point may provide the basis for trends that can be displayed either as an aggregated “overall” performance view and/or by a particular category chosen by a user. In some examples, data behind the analytics may be transparent. In some examples, users may have access to the underlying content used to inform a score in the generated analytics.

Once analytics have been performed, data may be augmented with additional platform tools. This is seen in FIG. 16 as data from the Analytics Server passes through an API to a Client. The data may be provided to the Client through a mobile application, a web-based application, and/or another external interface. Platform tools may include financial performance overlays, a research mode to provided quick access to underlying data, the ability to quickly compare the performance of different companies sectors, and benchmarks, and other tools. In some examples, company pages may be generated that provide quick access to relevant information. In further examples, a customizable alerts system may be provided to draw attention to particular sustainability performance changes. Additionally, a report creation tool may be used to create custom sustainability reports. In some examples, a direct data feed API may be available to quickly integrate data within existing systems.

### System for Providing Crowd-Based Sentiment Indices

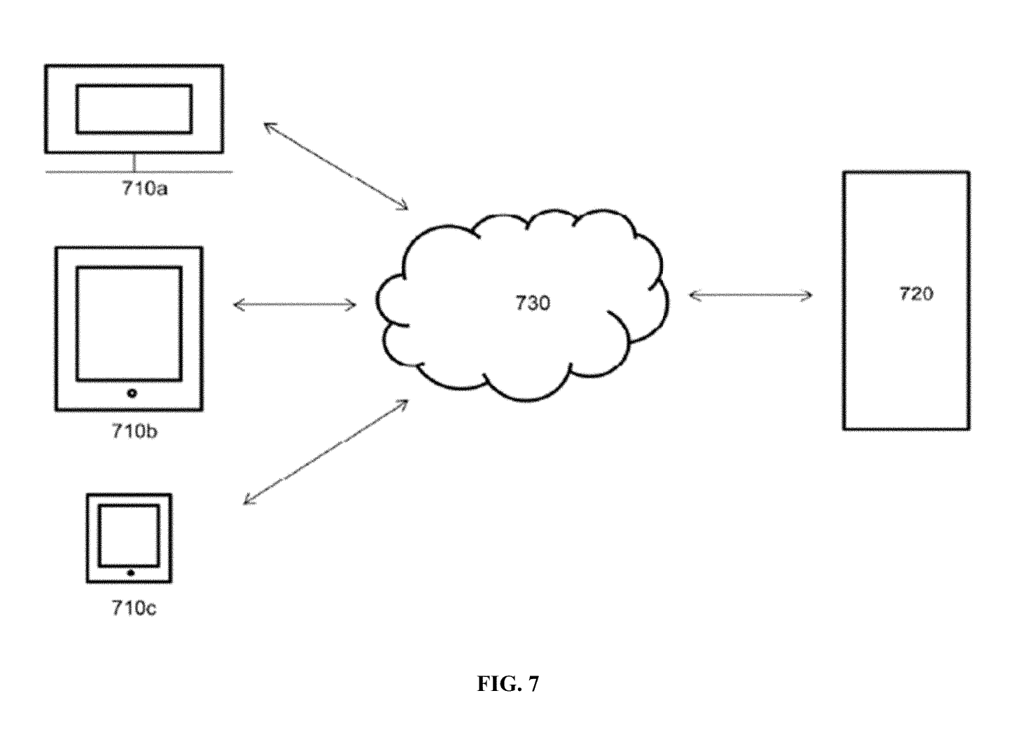

FIG. 7 shows a system for providing crowd-based sentiment indices in accordance with an embodiment of the invention.

One or more devices 710a, 710b, 710c may be in communication with one or more servers 720 of the system over a network 730.

One or more user may be capable of interacting with the system via a device 710a, 710b, 710c. In some embodiments, the user may be an observer or contributor that may provide feedback relating to an entity, such as a company. The user may be an individual viewing information about the entity, such as a value for the company. In some instances, the user may be an investor or broker.

The device may be a computer 710a, server, laptop, or mobile device (e.g., tablet 710c, smartphone 710b, cell phone, personal digital assistant) or any other type of device. The device may be desktop device, laptop device, or a handheld device. The device may be a networked device. Any combination of devices may communicate within the system. The device may have a memory, processor, and/or display. The memory may be capable of storing persistent and/or transient data. One or more databases may be employed. Persistent and/or transient data may be stored in the cloud. Non-transitory computer readable media containing code, logic, or instructions for one or more steps described herein may be stored in memory. The processor may be capable of carrying out one or more steps described herein. For example, the processor may be capable of carrying out one or more steps in accordance with the non-transitory computer readable media.

A display may show data and/or permit user interaction. For example, the display may include a screen, such as a touchscreen, through which the user may be able to view content, such as a user interface for providing information about an entity or soliciting feedback about the entity. The user may be able to view a browser or application on the display. The browser or application may provide access to information relating to an entity. The user may be able to view entity information via the display. The display may be capable of displaying images (e.g., still or video), or text. The display may be a visual display that shows the user interfaces as described elsewhere herein. The display may emit or reflect light. The device may be capable of providing audio content.

The device may receive user input via any user input device. Examples of user input devices may include, but are not limited to, mouse, keyboard, joystick, trackball, touchpad, touchscreen, microphone, camera, motion sensor, optical sensor, or infrared sensor. A user may provide an input via a tactile interface. For instance, the user may touch or move an object in order to provide input. In other instances, the user may provide input verbally (e.g., speaking or humming) or via gesture or facial recognition.

The device may include a clock or other time-keeping device on-board. The time-keeping device may be capable of detecting times at which user inputs are made. In some instances, the device may generate a timestamp associated with the user inputs that may be useful for calculating one or more score as described elsewhere herein. The timestamps may be associated with user feedback and useful for determining feedback to include in specified timeframes.

The device 710a, 710b, 710c may be capable of communicating with a server 720. The device may have a communication unit that may permit communications with external devices. Any description of a server may apply to one or more servers and/or databases which may store and/or access content and/or analysis of content. The server may be able to store and/or access crowd-based sentiment relating to one or more entities. The one or more servers may include a memory and/or programmable processor.

A plurality of devices may communicate with the one or more servers. Such communications may be serial and/or simultaneous. For examples, many individuals may participate in viewing information about an entity and/or providing feedback relating to an entity. The individuals may be able to interact with one another or may be isolated from one another. In some embodiments, a first individual on a first device 710a may provide feedback relating to an entity, which may affect the entity scores which may be viewed by the first individual and a second individual on a second device 710b. In some embodiments, both the first individual and the second individual may provide feedback about an entity which may be used as at least part of the basis of the entity score calculations which may be viewed by the first individual and/or second individual.

The server may store information about entities. For example, feedback received relating to various entities may be stored. Entity scores relating to various categories/metrics or overall entity scores may be stored in memory accessible by the server. Information about users may also be stored. For example, information such as the user's name, contact information (e.g., physical address, email address, telephone number, instant messaging handle), educational information, work information, experience or expertise in one or more category or areas of interest, or other information may be stored.

The programmable processor of the server may execute one or more steps as provided therein. Any actions or steps described herein may be performed with the aid of a programmable processor. Human intervention may not be required in automated steps. The programmable processor may be useful for calculating and/or updating entity scores. The server may also include memory comprising non-transitory computer readable media with code, logic, instructions for executing one or more of the steps provided herein. For example, the server(s) may be utilized to calculate scores for entities based on feedback provided by users. The server may permit a user to provide feedback via a user interface, such as a widget.

The device 710a, 710b, 710c may communicate with the server 720 via a network 730, such as a wide area network (e.g., the Internet), a local area network, or telecommunications network (e.g., cellular phone network or data network). Communication may also be intermediated by a third party.

In one example, a user may be interacting with the server via an application or website. For example, a browser may be displayed on the user's device. For example, the user may be viewing a user interface for entity information via the user's device.

Aspects of the systems and methods provided herein, such as the devices 710a, 710b, 710c or the server 720, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

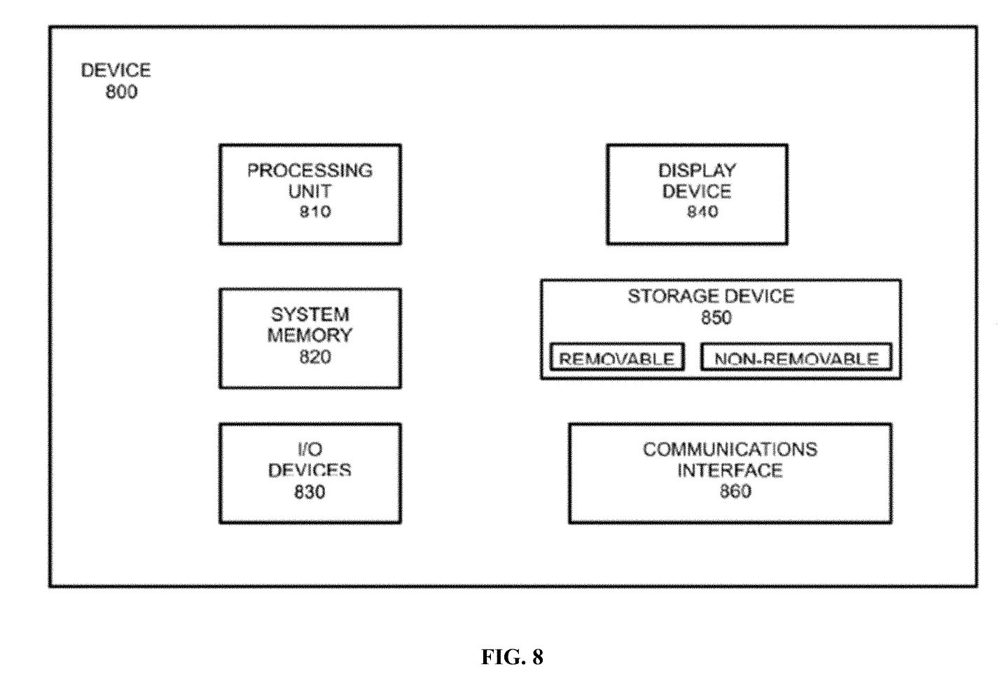

FIG. 8 shows an example of a computing device 800 in accordance with an embodiment of the invention. The device may have one or more processing unit 810 capable of executing one or more step described herein. The processing unit may be a programmable processor. The processor may execute computer readable instructions. A system memory 820 may also be provided. A storage device 850 may also be provided. The system memory and/or storage device may store data. In some instances the system memory and/or storage device may store non-transitory computer readable media. A storage device may include removable and/or non-removable memory.

An input/output device 830 may be provided. In one example, a user interactive device, such as those described elsewhere herein may be provided. A user may interact with the device via the input/output device. A user may be able to provide feedback about an entity using the user interactive device.

In some embodiments, the computing device may include a display 840. The display may include a screen. The screen may or may not be a touch-sensitive screen. In some instances, the display may be a capacitive or resistive touch display, or a head-mountable display. The display may show a user interface, such as a graphical user interface (GUI), such as those described elsewhere herein. A user may be able to view information about an entity, such as overall value score for the entity or category scores for the entity through the user interface. In some instances the user interface may be a web-based user interface. In some instances, the user interface may be implemented as a mobile application.

A communication interface 860 may also be provided for a device. For example, a device may communicate with another device. The device may communicate directly with another device or over a network. In some instances, the device may communicate with a server over a network. The communication device may permit the device to communicate with external devices.

As described above, FIGS. 1-16, 18, and 19 describe methods and systems of generating and indicating sentiment. Sentiment generated using methods as described in FIGS. 1-16, 18, and 19 may be assessed to provide long-term indicators of sentiment. Additionally, FIGS. 17 and 20-27 describe methods and systems of assessing and providing long-term indicators of sentiment.

### Calculation of Long-Term Indicators of Sentiment

The invention includes methods and systems for determining a particular long-term indicator metric that is intended to be accretive in nature. In some examples, the long-term indicator metric may be positively or negatively accretive in nature depending on the performance of a firm that is being evaluated. In some examples, metrics may be determined that are at least partially derivative based upon a continuous time series of sentiment scores.

The development of a long-term indicator metric may be used to show steady growth, or lack thereof, of a more rapidly varying, underlying sentiment function of time. The long-term indicator metric may be used to recognize value over longer terms in extra-financial areas, yet in a way that is different from conventional summary ratings. These longer-term indicators are based on underlying continuous series and are much more precise and consistent than other methods. For example, if we look at the accumulation of “value” over time (i.e. sustained better than a baseline score series), we can accumulate them into this “integral”-like index, called an aggregation of Incremental Sentiment Value. In some examples, an aggregation of Incremental Sentiment Value may be analogous to compounded annual growth with respect to financial aspects.

The aggregation of Incremental Sentiment Value may emulate compounded return on an asset (both positive and negative relative to a baseline). The calibration bounds are 100% “return” if an Incremental Sentiment Value of 100 is held for one year and proportionately negative if a Incremental Sentiment Value of 0 is held for a year. We can thus compute the maximum attainable daily return rate thusly:

### Given:

T≡measurement period=365 time units (days)
R≡highest objective cumulative return per measurement period=100%
r_{Max}≡unit time return rate needed to achieve R at the close of the measurement period

### Solve for r:

(1+rₘₐₓ)^{T}=1+R=>1+r_{Max}=(R+1)^{1/T}
=>r_{Max}=(R+1)^{1/T}−1=0.001900837677

The return rate is applied, positively or negatively, proportionately to the value of the Incremental Sentiment Value relative to a baseline. The rate is applied in a decreasing manner from the time of the score change until the next score change where the process repeats. The decreasing ramp is the same as the freshness function used in computing the underlying Incremental Sentiment Value. An analogy of this concept is the sustaining of a musical note, with the note initializing at the time of a scoring event and then tailing off over time until total quiet or until another not occurs. Thus:

f(Δt)≡e^{AΔt}≡freshness factor at time Δt following a scoring event
λ≡information currency half-life [default 14 days]
A≡information decay factor

$$[ for the 14 \text{-} day half \text{-} life ⇒ = \frac{ln ( \frac{1}{2} )}{λ} = \frac{ln ( \frac{1}{2} )}{14 days} ≅ - 0.05 / day ]$$

I_{Max}≡Maximum possible Incremental Sentiment Value=100
I₀(t)≡baseline Incremental Sentiment Value at time t (default constant neutral value of 50; otherwise a baseline benchmark series)
Iₘᵢₙ≡minimum possible Incremental Sentiment Value=0
tₙ≡time of the n^{th} scoring event
I(t)≡Incremental Sentiment Value at time t
Δt≡time unit increment=1 day
Δtₖ ≡k^{th} time unit (day) from most recent scoring event, with Δt₀=0
N(t₀,t)≡number of scoring events between times t₀, and t
K(tₙ,t)≡number of time units after scoring event time tₙ until the next scoring event or until time t
Δtₖ k^{th} time unit (day) from most recent scoring event=kΔt,k=0 . . . K(tₙ,t)

$$r ( {t}_{n} , Δ {t}_{k} ) ≡ \frac{I ( {t}_{n} ) - {I}_{0} ( {t}_{n} + Δ {t}_{k} )}{{I}_{Max} - {I}_{0} ( {t}_{n} + Δ {t}_{k} )} f ( Δ t ) {r}_{Max} ≡ return at time {t}_{n} + Δ {t}_{k} after the {n}^{th} scoring event at time {t}_{n}$$

C_{Max}≡Maximum possible aggregation of Incremental Sentiment Value per measurement period=100
c(t₀ t)=c_{Max}{Πₙ₌₁^{N(t}^{_{0,}}^{,t)} Πₖ₌₀^{K(t}^{ₙ}^{,t)}[1+r(tₙ,Δtₖ)]−1}≡aggregation of Incremental Sentiment Value at time t

When t advances by the increment Δt, the aggregation of Incremental Sentiment Value is updated recursively as follows:

$$C ( {t}_{0} , t + Δ t ) = \{ \begin{matrix}{C}_{Max} \{ [ 1 + \frac{C ( {t}_{0} , t )}{{C}_{Max}} ] [ 1 + r ( {t}_{n + 1} , Δ {t}_{0} ) ] - 1 \} , & \begin{matrix}if t + Δ t = {t}_{n + 1} \\ ( at next scoring event )\end{matrix} \\ \begin{matrix}otherwise \text{:} \\ {C}_{Max} \{ [ 1 + \frac{C ( {t}_{0} , t )}{{C}_{Max}} ] [ 1 + r ( {t}_{n} , Δ {t}_{k} ) ] - 1 \} ,\end{matrix} & \begin{matrix}as t + Δ t = {t}_{n} + Δ {t}_{k} \\ ( not yet at next scoring \\ event )\end{matrix}\end{matrix}$$

Of most interest will be the change in aggregation of Incremental Sentiment Value over a duration [tₛ,t]:

ΔC(tₛ,t)≡C(t_{0,},t)−C(t_{0,}, t_{s,})
which can be shown as a graph along the duration of points (t, ΔC(t_{s,}t)), ∀ t∈[tₛ,t_{f}]

### Relationship to Sentiment Momentum

Based on the aggregation of Incremental Sentiment Value, Sentiment Momentum characterizes sustained performance over an interval with a single number, with further property objectives of being intuitive in the financial domain.

For a given category or overall for a given company, the mathematical embodiment is as described below:

### Given:

{C(t_{0,},t)}ₜ₌ₜ_{₀}^{t}^{_{f}},≡series of aggregation of Incremental Sentiment Value points along an overall time interval [tₛ, t_{f}]≡computed for each item using the above aggregation of Incremental Sentiment Value calculation.

Least-squares fit the following line to the series:

C′(t)=mt+b, where m may be taken as the Sentiment Momentum.

Additionally, software implementation of the above can be straightforwardly performed using standard linear regression libraries.

### Illustrations of Calculations of Long-Term Indicators of Sentiment

FIGS. 17A-170 illustrate charts that depict successive levels of summary performance information. We start with the red signal, which is that of the high temporal resolution sentiment we call Incremental Sentiment Value. We then juxtapose the red signal with the orange signal having triangles, which is, at the same level of high resolution, a benchmark sentiment signal. In some examples, the orange signal is an aggregation of a set of red signals collected in a group with some commonality (e.g. a sector of companies). In some examples, the benchmark can default to a neutral constant (50 in our sentiment scale), but the general case is a nontrivial benchmark such as that shown. We then examine the relative performance between the subject sentiment (red) and the benchmark (orange with triangles). The relative performance may then contribute to a simulated interest rate that compounds daily, either positively or negatively, to produce the blue signal having stars we call the aggregation of Incremental Sentiment Value. This blue signal gives a smoother representation capturing accumulated value (positive or negative) over time, and leverages the precision of the underlying higher resolution signal. We can then fit a green line with circles to this blue signal. The slope of that green line may yield what we define as Sentiment Momentum. Sentiment Momentum, in turn, may be used to provide a single number characterizing the performance of the company, relative to its benchmark, over the interval. This number can then be used to stack rank companies in each category, again leveraging the precision of the underlying high-resolution input signals. Also, the numerology typically works out that the range of these Sentiment Momentum values bear resemblance to ranges of typical return ranges in the financial space, providing additional intuitive triggers for users in that space.

Additional preferred embodiments of long term sentiment scores and aggregates follow:

### Long Term Score

The Long Term Score is intended to be accretive in nature (either positive or negative, depending of course on sustained sentiment performance of the firm), similar to the Incremental Sentiment Value, and is a quantity built upon the continuous General Sentiment Score time series. Long Term Score is designed to show steady growth, or lack thereof, of a more rapidly varying, underlying sentiment functions of time. The general intent is the important recognition of value over longer terms in these extra-financial areas, yet in a way that is different from conventional summary ratings. Being based on underlying continuous series and are much more precise and consistent than other methods. For example, if we look at the accumulation of “value” over time (i.e. sustained better than a baseline score series), we can accumulate them into this “integral”-like index, called Long-Term Score, showing what is analogous to compounded annual growth on the financial side.

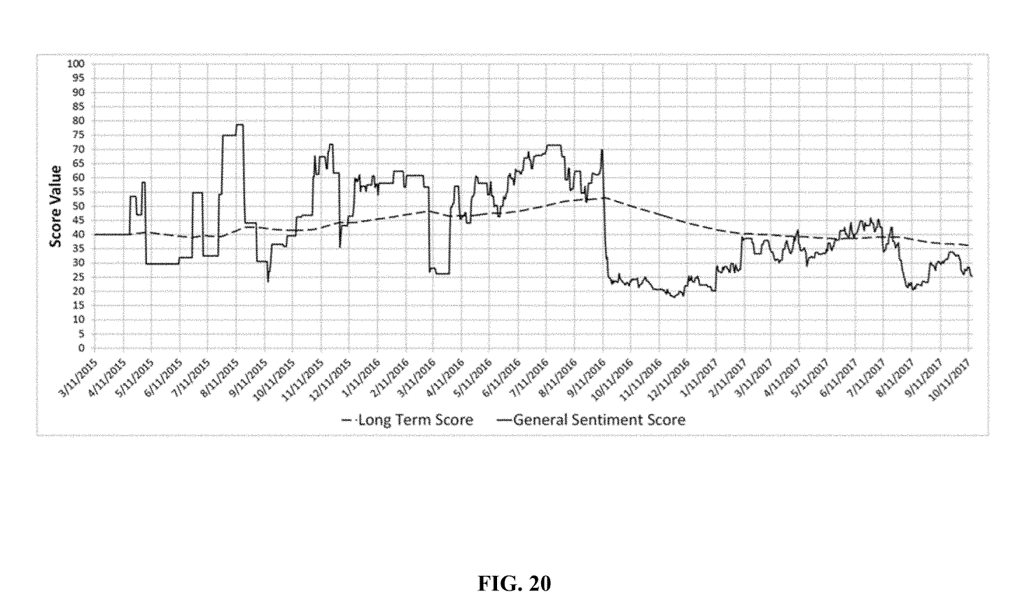

A visualization of Long Term Score series, relative to its more rapidly varying General Sentiment Score series is shown in FIG. 20. FIG. 20 illustrates a chart exemplifying the output of the Long Term Score generation process producing an indicator as a function of time related to the underlying General Sentiment Score. As seen in FIG. 20, the Long Term Score integrates sustained performance by applying the conventional financial technical analysis tool of an Exponentially-Weighted Moving Average (EWMA) to a fade-adjusted General Sentiment Score, which fades lingering General Sentiment Scores, those having not been updated day-by-day, towards neutrality. The mathematical formulation is detailed below, with rationale for the formulating structural and parametric choices mad, along with descriptive introductions to each mathematical line of text.

For each particular area of interest, such as a company, for each particular category, given inputs as described below:

The longer-range fade period for the Long Term Score is chosen to provide significance fading to half its impact over six months to provide sufficient movement in an annual period, yet diminishing more volatile effects in the signal. This model is sufficiently general, however, to accommodate a different choice of half-life:

T≡half-life period=182 time units (days)=6 months

The above equation establishes the symbol used to represent the half-life timing parameter used in the method below.

r≡unit time diminishing rate=1−(½)^{1/T}≈0.004

The above equation establishes the symbol, and the functional derivation based on T, defined above, used for the rate parameter in the exponential averaging process described below.

To mitigate the effect of General Sentiment Scores being updated with a lower frequency such that the effect of prior updates linger too long into the Long Term Score smoothing process, their effect is faded to neutrality while awaiting the next General Sentiment Score to appear in order to diminish the impact of “stale” scores in the computation. Also, to mitigate the effect of the first value of General Sentiment Score input to the Long Term Score calculation to have undue, disproportionate significance, a seasoning period is chosen in which the General Sentiment Scores are initially preprocessed and averaged to generate a seed value representative of the General Sentiment Score values having occurred during the seasoning period:

Δt≡seasoning period=14 time units (days)

The above equation establishes the symbol used to represent the time interval during which prior inputs are collected for setting an initial input to the averaging process for the method.

t₀ ≡time of first reported General Sentiment Score

P(t)≡General Sentiment Score at time t

L(t)≡Duration of time, measured in days, at time t that P(t) has not changed—“lingered” at its current value read at time t

Pₒ ≡neutral General Sentiment Score=50

A≡information decay factor≈−0.05/day as derived above in defining General Sentiment Score

The above equations establish symbols, as described therein, to be used in the computations for the method.

P′(t)≡fade-adjusted General Sentiment Score at time t=P₀e^{AL(t)} (P(t)−P₀)

The above equation establishes the symbol and functionally derives the fade adjustment for the General Sentiment Score to be input to the averaging process using an exponential decay with the parameters as described above. The Long-Term Score for that entity for that category is computed recursively as described below:

As discussed earlier, the Long Term Score is first seeded by an average of the fade-adjusted General Sentiment Scores collected during the seasoning period and then recursively updated per time increment (typically daily) forward after that point in time:

$$I ( {t}_{0} + Δ t ) ≡ seed Long \text{-} Term Score at time {t}_{0} + Δ t = \frac{{\sum }_{{t}_{0} \leq t \leq {t}_{0} + Δ t} {P}^{′} ( t )}{\vert {\{ {P}^{′} ( t ) \}}_{{t}_{0} \leq t \leq {t}_{0} + Δ t} \vert} = average of all fade \text{-} adjusted General Sentiment Scores in the time range [ {t}_{0} , {t}_{0} + Δ t ] ( seasoning interval )$$

The above equation establishes the symbol and functional derivation of the initial value used in the averaging process as the arithmetic average (sum divided by count) of the fade-adjusted scores within the seasoning period.

l(t)≡Long Term Score at time t>t₀+Δt=rP′(t)+(1−r)/(t−1)

The above equation computes the objective quantity of Long Term Score using exponentially-weighed moving averaging, expressed as a recursive function, seeded by the initial value defined immediately above and carried out by multiplying the rate r, defined above, by the fade-adjusted score at a time t, and adding to that one minus the rate multiplied by the value of the Long Term Score at the time increment prior, t−1. This process is repeated stepping through time increments.

In some examples, times may be measured in days. In some examples, times may be measured in hours. In some examples, times may be measured in weeks. In some examples, times may be measured in a number of time-based increments that are associated with sections, minutes, hours, days weeks, a fraction of a time-based increment, and/or a multiple of a time-based increment, in addition to other examples. Computation of the Long Term Score begins, as noted, be being offset by the seasoning period past the first newsworthy event in the category for the company. Prior to that point, if a representative Long Term Score is needed, then neutrality, such as 50 in a 0 to 100 scale, is set as the value.

### Volume-Modulated Long Term Score

The Volume-Modulated Long Term Score is a modification to the Long Term Score as described above wherein news event sentiment rating volume contemporaneous with a General Sentiment Score change is applied to highlight the change commensurate with the level of volume. The technique contemplates applying the averaging process in place multiple times proportional to the relative volume of General Sentiment Score triggering events occurring during the time increment.

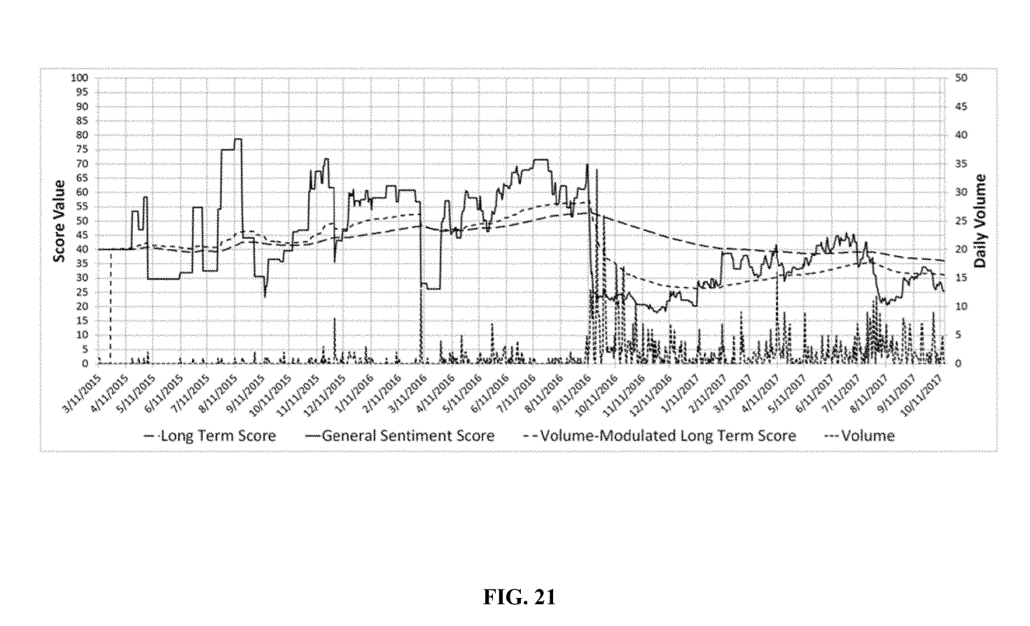

FIG. 21 illustrates a chart exemplifying the output of the Volume-Modulated Long Term Score generation process producing an indicator as a function of time related to the underlying General Sentiment Score, Volume of sentiment rating news events, and Long Term Score. In particular, a visualization of Volume-Modulated Long Term Score is shown in FIG. 21.

The Volume-Modulated Long Term Score applies the Exponentially-Weighted Moving Average (EWMA), as detailed above, repetitively at a point in time by a number of iterations relatively proportionate to the volume level at that point in time.

The mathematical description follows, along with descriptive introductions to each mathematical line of text. For each particular area of interest, such as a company, for each particular category, given inputs as described below:

The longer-range fade period for the Long Term Score is chosen to provide significance fading to half its impact over six months to provide sufficient movement in an annual period, yet diminishing more volatile effects in the signal. This model is sufficiently general, however, to accommodate a different choice of half-life:

T≡half-life period=182 time units (days)=6 months

r≡unit time diminishing rate=1−(½)^{1/T}≈0.004

Δt seasoning period=14 time units (days) t₀ ≡time of first reported General

### Sentiment Score

The above symbols and parameters are established identically to those established in the description of Long Term Score above.

The volume tracking parameters are derived here, to later be used in multiplicatively applying the averaging process in place to amplify the effect based on the volume in the time increment. Volume tracking is determined in a relativized way, setting the multiplier as a function of time determined by the level of relative volume over time:

V(t)≡Volume (count) of news events, each producing a sentiment rating, in the category at time (date) t

The above equation establishes the symbol for the volume of news events on the date, or, in general, time increment, denoted by t. The volume is the count of news events occurring in that denoted interval.

$$\overline{V} ( t ) ≡ \frac{1}{t - {t}_{0}} {\sum }_{τ = {t}_{0}}^{t} V ( τ ) ≡ Average Daily Volume of news events up to time ( date ) t$$

The above equation establishes the symbology and functional derivation of the average daily volume up to time t. It is computed by summing the volume over all time increments up to t and then dividing by the elapsed time from a set origin t₀ up to t.

$$S ( t ) ≡ \frac{V ( t )}{\overline{V} ( t )} ≡ Relative Volume Spike of news events at time ( date ) t$$

The above equation establishes the symbol and derivation for the time function representing the magnitude of volume, relative to the average per unit time known up to time t. This time-mapped quantity is defined as “Relative Volume Spike”.

Sₘₐₓ(t)≡max_{τ=t}_{₀}^{t}S(τ)≡Maximum Volume Spike of news events up to time (date) t

The above equation establishes the symbol and functional determination of the largest known Relative Volume Spike up to time tfrom a known time origin t₀.

u≡User-Selectable Attenuation Factor

The above equation sets the symbol for a factor that the user of the method can select to attenuate the volume-driven amplification of the Long-Term Score signal.

Kₘₐₓ≡Maximum EWMA Iteration Amplifier

The above equation sets the symbol for the maximum number of times the amplification repetitions can occur at any fixed time.

$$K ( t ) ≡ u min \{ ⌈ \frac{S ( t )}{{S}_{max} ( t )} ⌉ , {K}_{max} \} ≡ EWMA Iteration Amplifier ( ceiling integer of ratio of relative volume spike to maximum volume spike ) at time ( date ) t$$

The above equation sets the symbol and describes the functional derivation of the number of times the amplification repetitions that will be applied at time t. It is the minimum of the maximum allowable number of repetitions and the integer nearest above the ratio of the Relative Volume Spike divided by the Maximum Relative Volume Spike known at time t.

To also mitigate the effect of General Sentiment Scores being updated with a lower frequency such that the effect of prior updates linger too long into the Long Term Score smoothing process, their effect is faded to neutrality while awaiting the next General Sentiment Score to appear in order to diminish the impact of “stale” scores in the computation. Also, to mitigate the effect of the first value of General Sentiment Score input to the Long Term Score calculation to have undue, disproportionate significance, a seasoning period is chosen in which the General Sentiment Scores are initially preprocessed and averaged to generate a seed value representative of the General Sentiment Score values having occurred during the seasoning period:

Δt≡seasoning period=14 time units (days)P(t) General Sentiment Score at time t

L(t) Duration of time, measured in days, at time t that P(t) has not changed—“lingered” at its current value read at time t

P₀≡neutral General Sentiment Score, typically 50 in a 0 to 100 scale

A≡information decay factor≈−0.05/day as derived above in defining General Sentiment Score

P′(t)≡fade-adjusted General Sentiment Score at time t=P₀+e^{AL(t)} (P(t)−P₀)

The above equations set and derive parameters as described identically above for Long Term Score.

Compute the Volume-Modulated Long-Term Score for that entity for that category recursively as described below:

As discussed earlier, the Volume-Modulated Long Term Score is first seeded by an average of the fade-adjusted General Sentiment Scores collected during the seasoning period and then recursively updated per time increment (typically daily) forward after that point in time:

$$I ( {t}_{0} + Δt ) ≡ seed Long \text{-} Term Score score at time {t}_{0} + Δt = \frac{{\sum }_{{t}_{0} \leq t \leq {t}_{0} + Δ t} {P}^{′} ( t )}{\vert {\{ {P}^{′} ( t ) \}}_{{t}_{0} \leq t \leq {t}_{0} + Δ t} \vert} = average of all fade \text{-} adjusted General Sentiment Score scores in the time range [ {t}_{0} , {t}_{0} + Δt ] ( seasoning interval )$$

The above equation establishes the symbol and functional derivation of the initial value used in the averaging process as the arithmetic average (sum divided by count) of the fade-adjusted scores within the seasoning period.

To then compute the Volume-Modulated Long Term Score at a point in time following the seasoning period, the averaging process is iteratively applied in proportion to the relative volume signal set as above described as an additional function of time:

I′(t)≡Volume-Modulated Long-Term Score score at time t>t₀+Δt [symbol] _{I′=rP′(t)+(1-r)I′(t-1)}^{K(t)}[rP′(t)+(1−r)I′], where [symbol] is the Iteral operator.

The above equation computes the objective quantity of Volume-Modulated Long Term Score using exponentially-weighed moving averaging, expressed as a recursive function, seeded by the initial value defined immediately above and carried out by multiplying the rate r, defined above, by the fade-adjusted score at a time t, and adding to that one minus the rate multiplied by the value of the Long Term Score at the time increment prior, t−1. In addition, if, at time t, there is a call for amplification repetitions, K(t) to be carried out also at time t, then the repetitions are carried out before advancing to the next time increment. This process is repeated stepping through time increments.

Times is measured in days. Computation of the Volume-Modulated Long Term Score begins, as noted, offset by the seasoning period past the first newsworthy event in the category for the company. Prior to that point, if a representative Long Term Score is needed, then neutrality, such as 50 in a 0 to 100 scale, is set as the value.

### Relative Trend Score

Given any score series as described above, Relative Trend Score characterizes sustained performance over an interval with a single number. This representation complements the Long Term scores, which are function of time, as a compact single value representing a selected interval of time and characterizing the trend of the function of time over that selected interval. Relative Trend score computed thusly:

For a given score series for a given area of interest, such as a company, the mathematical embodiment is as described below, along with descriptive introductions to each mathematical line of text

Over the selected time interval, a number corresponding to the slope of the time function is computed, and relativized to the collection of slopes computed over a particular universe of other areas of interest (typically companies):

[tₛ, t_{f}]≡time interval of interest

The above equation establishes the symbols used to denote the time interval over which the method for deriving the Relative Trend Score is to be applied.

N≡number of areas of interest (such as companies) in the comparison universe

The above equation sets the symbol representing the number of areas of interest present in a comparative set or “universe”, the constituents of which a subject area of interest will be compared.

l(t)≡Score at time t

The above equation sets the symbol for a score at time t. The score can be any of the scores established as General Sentiment Score, Long-Term Score, or Volume-Modulated Long-Term Score. In addition, the method described herein for deriving Relative Trend Score can be applied to any score as a function of time in addition to those specified above.

s≡linear slope=[l(t_{f})−(tₛ)]/(t_{f} tₛ)

The above equation sets the symbol and functional derivation of the slope of the scoring function over the time interval of interest. This is accomplished by subtracting the earliest from the latest score value and dividing by the difference between from the latest back to the earliest time.

If s=0, then M[tₛ, t_{f}] Relative Trend Score for the interval, is assigned neutral, typically 50 in a 0 to 100 scale

Otherwise, continue the computation thusly:

S_{Max}≡max{|sᵢ|}ᵢ₋₁^{N}=maximum absolute value raw slope (“universal maximum slope”) over all areas of interest in the comparison universe for the given category (also known as the Universal Maximum Slope (UMS))

The above equation establishes the symbol for the largest slope found over the universe of areas of interest.

The Relative Trend Score is set to be within a 0 to 100 range, with 50 being neutral, and to mitigate the skewing effects of outliers, a logarithm is utilized, with appropriate perturbations to avoid the mathematically singular effects of the logarithm function:

$$a ≡ slope scaling amplifier = 1000 \\ ɛ ≡ small maximum slope perturbation = 0.0001$$

$$If {s}_{Max} < \frac{1}{a} then reset {s}_{Max} = \frac{1}{a} + ɛ$$

The above conditional equation and the definitional equations immediately above it perturbs the UMS found if it occurs below the threshold

$$\frac{1}{a} .$$

$$l ( s ) ≡ \{ \begin{matrix}1 if \vert as \vert < 1 \\ otherwise \text{:} \vert as \vert\end{matrix} = amplified linear slope$$

The above equation defines a conditional function that limits the amplified linear slope |as| to 1 or greater.

c_{Max}≡clip limit=log 10(l(s))

The above equation establishes the symbol and functional derivation for a clip limit used in deriving the Relative Trend Score. It is computed by using the base 10 logarithm of the amplified linear slope.

$${M}_{M ax} ≡ maximum possible Relative Trend Score , typically 100.$$

$$M [ {t}_{s} , {t}_{f} ] ≡ Relative Trend Score for the interval = [ \frac{sgn ( s ) log 10 ( l ( {s}_{Max} ) )}{{c}_{M ax}} + 1 ] {M}_{Max} / 2$$

The above equation computes the objective Relative Trend Score as the ratio of the base 10 logarithm of the amplified linear slope to the maximum of such logarithms over the universe. The sign of this ratio is then set based on the sign, sgn(s), of the linear slope. The result is then normalized into a scale ranging from 0 to M_{Max}, with zero mapped to the midpoint, M_{Max}/2.

If M[tₛ, t_{f}]>M_{Max} then reset M[tₛ, t_{f}]=M_{Max}

If M[tₛ, t_{f}]<0 then reset M[tₛ, t_{f}]=0

The above conditional equations limit the range of the resultant Relative Trend Score calculations to the scale bounds.

If Score data does not yet exist for the area of interest, Relative Trend Score is neutral, typically 50 in a 0 to 100 scale. For efficiency, if a set of Relative Trend Scores is desired over a common time interval, S_{Max} can be computed once and then re-used.

### Relative Trend Score Compass

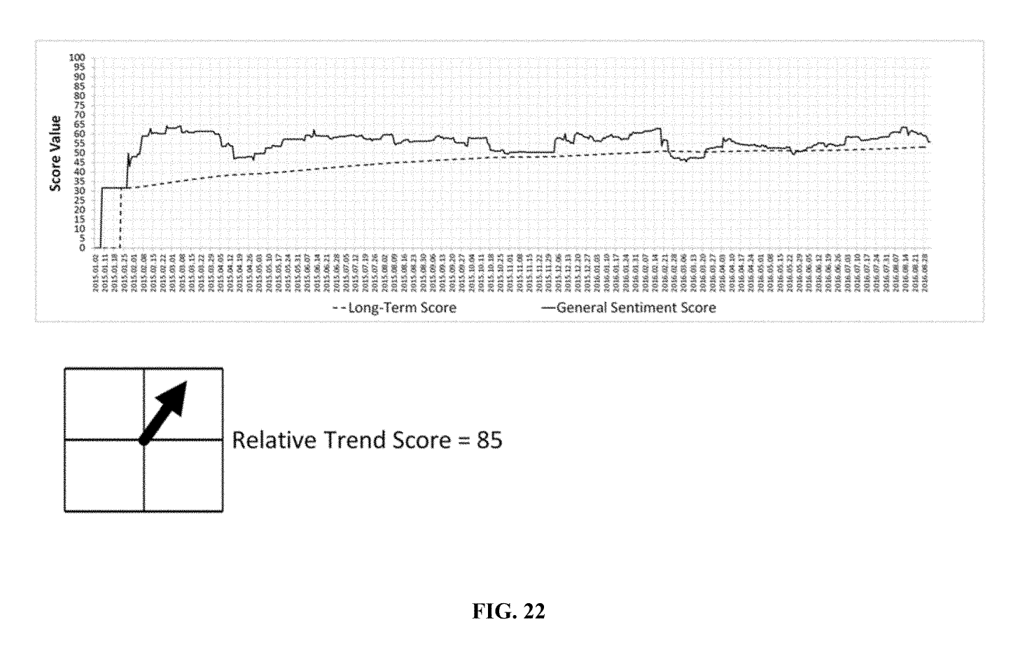

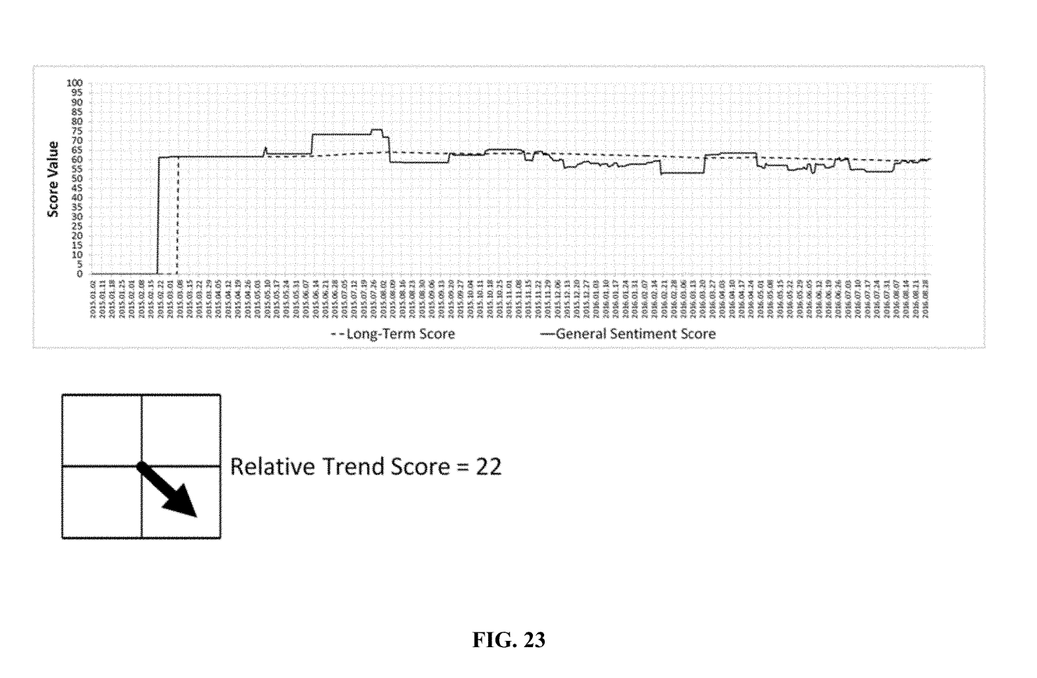

In addition to presenting Relative Trend Score as its numerical value alone, a visual depiction of its relative direction is further emphatic. Examples are shown in FIG. 22 and FIG. 23, along with the standard chart view with General Sentiment Score overlayed with Long Term Score. In particular, FIG. 22 illustrates an illustration of a favorable Relative Trend Score generated from the Long Term Score movement shown in the accompanying chart, relative to its generating General Sentiment Score. The rendering of the Relative Trend Score shows the output of the Relative Trend Score compass visualization generation, with the needle oriented upward indicating favorability. Additionally, FIG. 23 illustrates an illustration of an unfavorable Relative Trend Score generated from the Long Term Score movement shown in the accompanying chart, relative to its generating General Sentiment Score. The rendering of the Relative Trend Score shows the output of the Relative Trend Score compass visualization generation, with the needle oriented downward indicating unfavorability.

The additional visualization is in the form of a compass, indicating “at a glance” highs and lows of the Relative Trend Score. The technique contemplates fitting the range of the scores into a circular dial, using the appropriate trigonometric mapping as detailed below:

The mathematics for dynamically computing the visual elements of this “Relative Trend Score Compass” are detailed thusly, along with descriptive introductions to each mathematical line of text:

The Relative Trend Score Compass visual elements are computed as follows:

### Given:

m≡Relative Trend Score (as computed above) for a particular area of interest

M≡maximum Relative Trend Score over all areas of interest in a particular universe

L≡length of graphical needle as desired in the rendering E=perturbation from verticality (typically 0.1)

The above equations set the symbols for parameters, as described therein, to be used in setting the properties of the Relative Trend Score Compass as described below:

Set the origin of the compass arrow at (0,0), and set the tip at these coordinates:

$$x = \{ \begin{matrix}L cos ( \frac{m π}{2 ( 1 + ϵ ) M} ) , if \vert \frac{( 1 + ϵ ) M}{m} \vert < 2 \\ otherwise : L cos ( \frac{π}{4} )\end{matrix}$$

The above conditional equation sets the horizontal extent, x, of the needle on the compass dial. This is done using trigonometry and scaling by the needle length, L, such that the horizontal movement of the dial angle is fit proportionately, score relative to maximum, into the positive two quadrants of the compass, and is limited to the projection of 45 degrees

$$( \frac{π}{4} ) .$$

This keeps the intuitive sense communicated by the compass to be forward moving.

$$y = L sin ( \frac{m π}{2 ( 1 + ϵ ) M} )$$

The above equation sets the vertical extend, y, of the needle on the compass dial. This is done using trigonometry and scaling by the needle length, L, such that the vertical extent is within the two right quadrants and with the angle fit proportionately, score relative to maximum into the angular swing within those quadrants.

The two cases in the x coordinate cover the situation when the absolute angle from the horizontal is above 45 degrees, and we want behavior like a constant-length hand on a clock or compass needle. When the absolute angle from the horizontal is below 45 degrees, we wish to decrease the length of the arrow so that it never exceeds the projection of the 45-degree arrow onto the horizontal. The reason for this is to eliminate perceptions that, although the angle is lower, the length appears greater, erroneously suggesting better progress.

The ∈ is a small perturbation in the arrow angle to provide the effect of the arrow never going singularly vertical, which would be unintuitive, as time would be implied to be standing still with infinite progress.

Note also that only the maximum Relative Trend Score is used to scale the angle of the arrow, rather than the maximum absolute value. Should there be a negative Relative Trend Score with absolute value greater than the maximum positive Relative Trend Score, then the arrow depicting that case would point backwards, and that perception is acceptable and actually informative.

### Aggregate Scoring

With respect to aggregate scoring, an aggregate is any collection of areas of interest, such as in the case where areas of interest are companies, a benchmark, industry, sector, portfolio, or watchlist. For more intuitive understanding by the consumer, and ease of implementation, the score assigned to an aggregate, given the scores of its constituents, as computed above in any of the forms taught above, is defined, for a particular category (or overall), as the straight arithmetic average of the respective scores of the constituents. In cases where the constituents have not yet reported a score, due to no input news events having occurred, a neutral score, typically 50 in a 0 to 100 scale, is then used as the entry into the average.

### Single Category Aggregate Scoring

In mathematical terms for a particular category (or overall) considered within a particular aggregate, the aggregate score is computed by contemplating an average, described below, along with descriptive introductions to each mathematical line of text:

### Given:

J≡number of areas of interest, such as companies, in the aggregate

The above equation sets the symbol for the number of areas of interest in the aggregate of interest.

$${IS}_{j} ( t ) ≡ \{ \begin{matrix}Score for {j}^{th} area of interest ( for a particular category or overall ) at any time t \\ OR \text{:} neutrality if no news events prior to time t in the entire company data history\end{matrix} , \\ ∀ j ∈ \{ 1 … J \}$$

The above equation sets the symbol for each of the Jscores within the aggregate to be used to compute the score for the aggregate.

### Compute:

$$AS ( t ) ≡ \frac{{\sum }_{j = 1}^{J} {IS}_{j} ( t )}{J} ≡ Aggregate Score for the category ( or overall ) at time t$$

The above equation delivers the objective Aggregate Score for the category (or overall) by an arithmetic average (sum of scores divided by count of score) over the constituents of the aggregate.

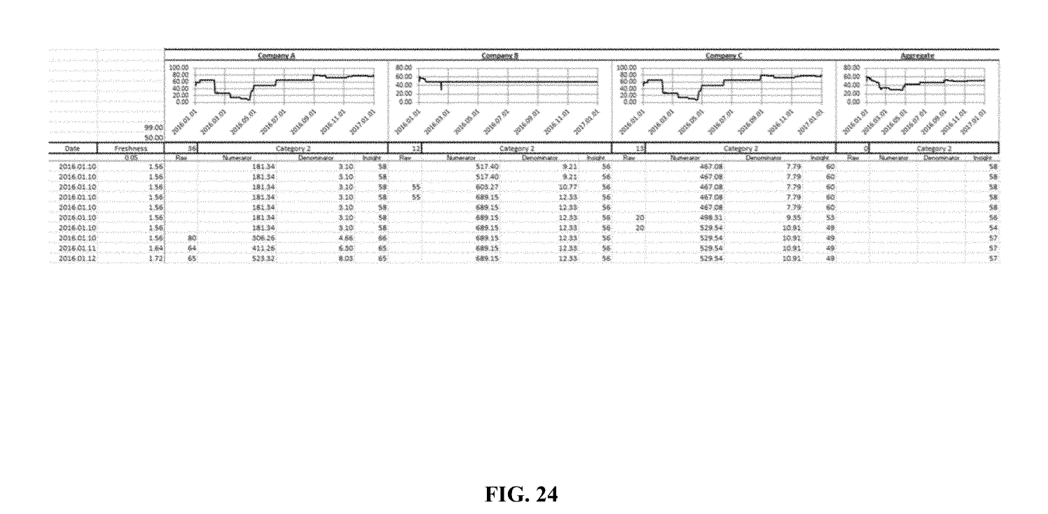

FIG. 24 illustrates a set of exemplifying charts and numbers illustrating the process for combining particular category scores for a set of areas of interest into an aggregate score over that combination of areas of interest. In the model shown in FIG. 24, the Aggregate Score for Category 2 is the simple arithmetic mean, at each date, of the respective per-area of interest scores. For example, the top row activity gives (58+56+60)/3=58.

In cases where an area of interest had not yet received any input sentiment values, that company would have had a neutral score set, typically 50 in a 0 to 100 scale, which would have then just naturally been averaged in as above.

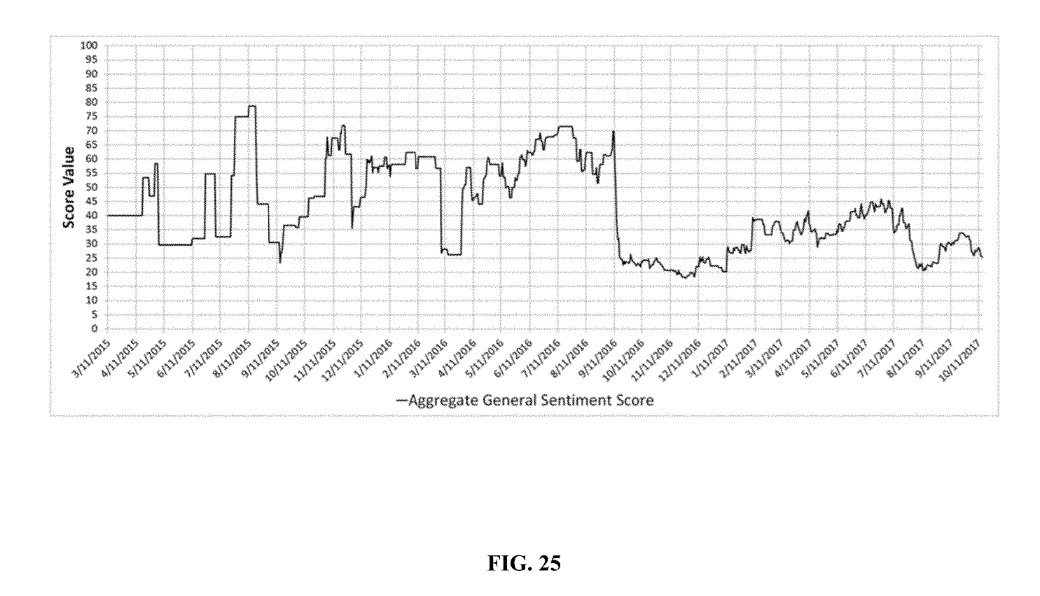

The Aggregate Score is presented as a current numerical value and as a historical graph over a user-selected timeline, as shown in FIG. 25. In particular, FIG. 25 illustrates a chart exemplifying the output of the Aggregate General Sentiment Score generation process producing an indicator as a function of time representing combined indications across a collection of areas of interest in a particular category. Graphs commence only following a first scorable news event over the collection of areas of interest within the aggregate. For multi-day timelines, the graph is presented at day-level resolution. For timelines within a day in the case of General Sentiment Score, the graph is presented at hour-level resolution.

### Custom Combined Category Aggregate Scoring

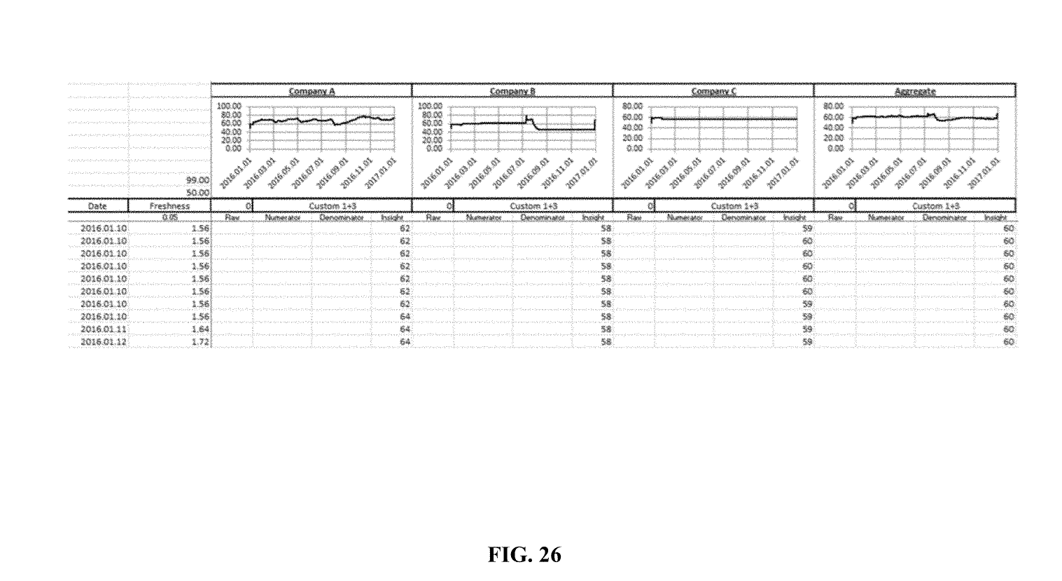

For custom combined category scores of aggregates, the approach is a straightforward arithmetic average as shown in FIG. 26. In particular, FIG. 26 illustrates a set of exemplifying charts and numbers illustrating the process for combining custom category scores for a set of areas of interest into an aggregate score over that combination of areas of interest. The approach is also illustrated numerically in the top row as (62+58+59)/3=60

Formalizing mathematically, along with descriptive introductions to each mathematical line of text:

$${AS}_{C} ( t ) ≡ \frac{{\sum }_{j = 1}^{J} {IS}_{j , C} ( t )}{J} ≡ Aggregate Custom Category Score at time t$$

The above equation computes the Aggregate score for a collection of custom categories in a manner identical, using arithmetic average (score sum divided by score count) as with the per category case described above, and using the parameters defined by the equations below:

### Given:

C≡number of categories selected

J≡number of areas of interest, such as companies, in the aggregate

IS_{j,c}(t)≡Custom Category Score at time t for the subset C of categories selected for the j^{th} area of interest, such as a company

Score Rankings within Aggregates

Within aggregates, it is useful to present the relative performance of the entities (companies). Often of interest is the ability to stack rank and identify relative performance bands. These stratifications are computed as described below, along with descriptive introductions to each mathematical line of text:

### Given:

For a particular category (or overall):

for a particular aggregate:

nₘ≡number of score data points for the m^{th} area of interest, such as a company, in the aggregate

N≡number of areas of interest in the aggregate with nₘ>0

for a particular selected time range:

ISₘ≡score nearest the end of the time range, for the m^{th} area of interest in the aggregate

The above equations set the symbology and definitions of the various parameters as described to be used in computing rankings and percentiles as described below:

### Compute:

kₘ^{(<)} ≡stack parameter below=number of areas of interest, over the N companies in the aggregate, with scores less than that of the m^{th} area of interest in the aggregate

kₘ⁽⁼⁾≡stack parameter equal=number of areas of interest, over the N companies in the aggregate, with scores equal to that of the m^{th} area of interest in the aggregate

Rₘ≡N−kₘ^{(<)} ≡ranking, over the N areas of interest in the aggregate, of the m^{th} area of interest within it

$${Q}_{m} ≡ 99 ( \frac{{k}_{m}^{( < )} + \frac{1}{2} {k}_{m}^{( = )}}{N} ) ≡ percentile ,$$

within the N areas of interest in the aggregate, of the m^{th} area of interest

The above equation maps the percentile into a zero to 99 range by proportionalizing the stack parameter below into the total number of countable areas of interest and adjusting that by half the stack parameter equal. This ratio is then applied to the percentile range of 99. This equation is articulated to adjust for the situation when all values in the aggregate are equal, yielding a 50th percentile for all, and adjusting for when there are few items in the aggregate so as not to falsely over-reward. In examples where nₘ=0, then Rₘ=Qₘ=N/A.

Rankings and percentiles are presented as single numbers pertaining to an area of interest, relative to the aggregate (such as the industry classification of a company). In addition, the areas of interest can be stack listed per their ranks or percentiles within the aggregate.

### Computer Control Systems

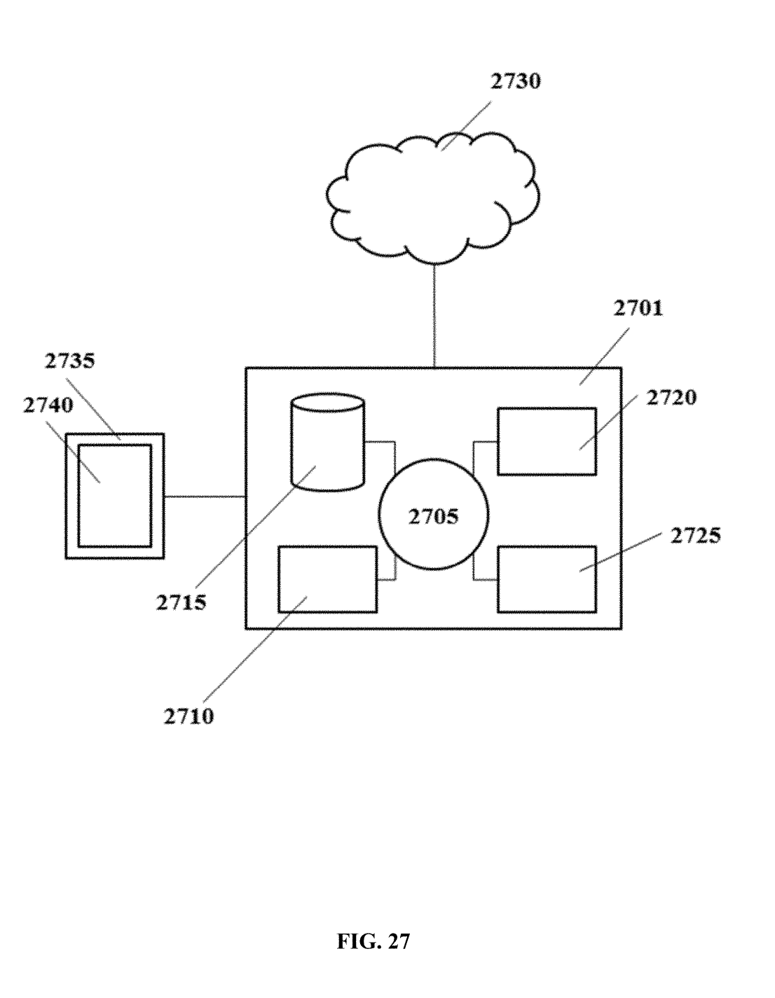

The present disclosure provides computer control systems that are programmed to implement methods of the disclosure. FIG. 27 shows a computer system 2701 that is programmed or otherwise configured to assess long-term indicators of sentiment. The computer system 2701 can regulate various aspects of calculating long-term indicators of sentiment of the present disclosure, such as, for example, calculating aggregations of Incremental Sentiment Value. The computer system 2701 can be an electronic device of a user or a computer system that is remotely located with respect to the electronic device. The electronic device can be a mobile electronic device.

The computer system 2701 includes a central processing unit (CPU, also “processor” and “computer processor” herein) 2705, which can be a single core or multi core processor, or a plurality of processors for parallel processing. The computer system 2701 also includes memory or memory location 2710 (e.g., random-access memory, read-only memory, flash memory), electronic storage unit 2715 (e.g., hard disk), communication interface 2720 (e.g., network adapter) for communicating with one or more other systems, and peripheral devices 2725, such as cache, other memory, data storage and/or electronic display adapters. The memory 2710, storage unit 2715, interface 2720 and peripheral devices 2725 are in communication with the CPU 2705 through a communication bus (solid lines), such as a motherboard. The storage unit 2715 can be a data storage unit (or data repository) for storing data. The computer system 2701 can be operatively coupled to a computer network (“network”) 2730 with the aid of the communication interface 2720. The network 2730 can be the Internet, an internet and/or extranet, or an intranet and/or extranet that is in communication with the Internet. The network 2730 in some cases is a telecommunication and/or data network. The network 2730 can include one or more computer servers, which can enable distributed computing, such as cloud computing. The network 2730, in some cases with the aid of the computer system 2701, can implement a peer-to-peer network, which may enable devices coupled to the computer system 2701 to behave as a client or a server.

The CPU 2705 can execute a sequence of machine-readable instructions, which can be embodied in a program or software. The instructions may be stored in a memory location, such as the memory 2710. The instructions can be directed to the CPU 2705, which can subsequently program or otherwise configure the CPU 2705 to implement methods of the present disclosure. Examples of operations performed by the CPU 2705 can include fetch, decode, execute, and writeback.

The CPU 2705 can be part of a circuit, such as an integrated circuit. One or more other components of the system 2701 can be included in the circuit. In some cases, the circuit is an application specific integrated circuit (ASIC).

The storage unit 2715 can store files, such as drivers, libraries and saved programs. The storage unit 2715 can store user data, e.g., user preferences and user programs. The computer system 2701 in some cases can include one or more additional data storage units that are external to the computer system 2701, such as located on a remote server that is in communication with the computer system 2701 through an intranet or the Internet.

The computer system 2701 can communicate with one or more remote computer systems through the network 2730. For instance, the computer system 2701 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2701 via the network 2730.

Methods as described herein can be implemented by way of machine (e.g., computer processor) executable code stored on an electronic storage location of the computer system 1801, such as, for example, on the memory 2710 or electronic storage unit 2715. The machine executable or machine readable code can be provided in the form of software. During use, the code can be executed by the processor 2705. In some cases, the code can be retrieved from the storage unit 2715 and stored on the memory 2710 for ready access by the processor 2705. In some situations, the electronic storage unit 2715 can be precluded, and machine-executable instructions are stored on memory 2710.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2701 can include or be in communication with an electronic display 2735 that comprises a user interface (UI) 2740 for providing, for example, charts that depict successive levels of summary performance information. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2705. The algorithm can, for example, assess long-term indicators of sentiment.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of assessing aggregate sentiment over a plurality of time increments of a time period, the method comprising:
assigning a maximum aggregation factor that is associated with a particular time period;
receiving a plurality of time increments over the time period, wherein each time increment has a characteristic baseline incremental sentiment value (BISV) and incremental sentiment value (ISV);
for each time increment, subtracting the BISV from the ISV to form a BISV/ISV difference value;
normalizing the BISV/ISV difference value by dividing by the maximum possible difference, thereby determining a modulator;
for each time increment, assigning a value to a recency of the particular time increment to a most recent incremental sentiment value update event, thereby determining a decay factor;
modulating the maximum aggregation factor associated with a particular time period by multiplying a determined modulator and a determined decay factor associated with each time increment within the evaluated time interval; and
applying the modulated maximum aggregation factor to aggregated sentiment values, thereby determining an aggregate sentiment value for each time increment over the time period.

2. The method of claim 1, wherein a most recent incremental sentiment value update event is selected from events that have previously occurred.

3. The method of claim 1, wherein each baseline incremental sentiment value of each of the plurality of time increments is the same across the time period.

4. The method of claim 1, wherein a baseline incremental sentiment value of any one time increment within the time period can differ from a baseline incremental sentiment value of a different time increment within the time period.

5. A method of assessing a momentum indicator of a time period, the method comprising:
receiving a plurality of aggregate sentiment values, wherein each aggregate sentiment value of the plurality of aggregate sentiment values is associated with a time increment within the time period;
calculating a curve that models a function of the plurality of aggregate sentiment values across the time period; and
determining a momentum indicator based upon characteristics of the curve that models a function of the plurality of aggregate sentiment values across the period of time.

6. The method of claim 5, wherein the curve is a linear fit, and the momentum indicator is the slope of the linear fit.

7. A method of assessing composite sentiment over a plurality of time increments of a time period, the method comprising:
assigning a half life parameter;
obtaining a diminishing rate from the half life parameter;
assigning a seasoning period;
obtaining a first reported general sentiment score;
obtaining a general sentiment score over a plurality of time increments over a time period;
identifying, for each general sentiment score, a number of time periods that the general sentiment score remains unchanged;
assigning a neutral general sentiment score;
assigning an information decay factor;
calculating a fade-adjusted general sentiment score at a given time based on (a) a general sentiment score at the given time, (b) a number of time periods that the general sentiment score has remained unchanged, (c) the assigned neutral general sentiment score, and (d) the assigned information decay factor;
obtaining a seed long-term score by combining the plurality of fade-adjusted general sentiment scores present within the seasoning period;
calculating a present long-term score by iteratively updating long-term scores associated with a time period between the time associated with the seed long-term score and the time associated with the most current long-term score, wherein said long-term scores are updated based on factors selected from the group consisting of a fade-adjusted general sentiment score, diminishing rate, a seed value of the long-term score, and the most recent previous long-term score.
